(19) United States
(12) Patent Application Publication
(10) Pub. No.: US 2016/0000081 A1
(43) Pub. Date: Jan. 7, 2016

(54) PEST CONTROLLING COMPOSITION AND USE THEREOF

(71) Applicant: SUMITOMO CHEMICAL COMPANY, LIMITED, Chuo-ku, Tokyo (JP)

(72) Inventors: Chie SHIMIZU, Tokyo (JP); Masashi KAMEZAKI, Takarazuka-shi (JP); Yoshihiko NOKURA, Takarazuka-shi (JP)

(73) Assignee: SUMITOMO CHEMICAL COMPANY, LIMITED, Tokyo (JP)

(21) Appl. No.: 14/767,226

(22) PCT Filed: Feb. 13, 2013
(86) PCT No.: PCT/JP2013/054058

§ 371 Date: Aug. 11, 2015

(51) Int. Cl. A01N 43/90; A01N 43/76; A01N 47/02; A01N 43/52; A01N 43/78

(52) U.S. Cl. CPC A01N 43/90; A01N 43/52; A01N 43/78; A01N 47/02; A01N 43/76

(57) ABSTRACT

The present invention provides a pest controlling composition containing a compound of the formula (1) wherein A¹, A², A³, R¹, R², R³, R⁴, R⁵, R⁶ and n are as defined in DESCRIPTION, or an N-oxide thereof; and one or more compounds selected from Group A to Group E: Group A; fungicides, Group B; insecticides, Group C; acaricides, Group D; chemical injury reducing agents, and Group E; plant growth regulators. The pest controlling composition of the present invention exhibits an excellent effect of controlling pests.

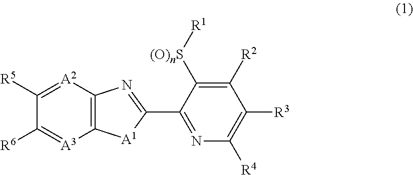

### TECHNICAL FIELD

The present invention relates to a pest controlling composition and a method for controlling pests.

### BACKGROUND ART

As active ingredients of pest controlling compositions, many compounds have hitherto been known (e.g., see Non-Patent Literature 1).

### CITATION LIST

### Patent Literature

PTL 1: International Publication WO 2013/018928

### Non-Patent Literature

NPL 1: The Pesticide Manual-15th edition (published by BCPC) ISBN 978-1-901396-18-8

### SUMMARY OF INVENTION

### Technical Problem

An object of the present invention is to provide a pest controlling composition having an excellent effect of controlling pests.

### Solution to Problem

As a result of research for finding a pest controlling composition having an excellent effect of controlling pests, the present inventors have found that a pest controlling composition comprising a compound of the following formula (1) has an excellent effect of controlling pests, leading to completion of the present invention.

That is, the present invention is as follows.

[1]A pest controlling composition comprises:
a fused heterocyclic compound represented by the formula (1):

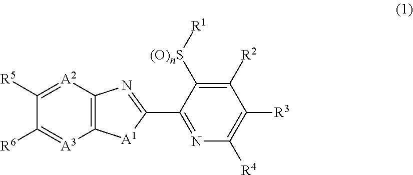

wherein
A¹ represents —NR⁷—, an oxygen atom or a sulfur atom,
A² represents a nitrogen atom or ═CR⁸—,
A³ represents a nitrogen atom or ═CR⁹—,
R¹ represents a C1-C6 chain hydrocarbon group optionally substituted by one or more atoms or groups selected from Group X or a C3-C6 alicyclic hydrocarbon group optionally substituted by one or more atoms or groups selected from Group Y,
R², R³ and R⁴ are the same or different and each represents a C1-C6 chain hydrocarbon group optionally substituted by one or more atoms or groups selected from Group X, a phenyl group optionally substituted by one or more atoms or groups selected from Group Z, a 5- or 6-membered heterocyclic group optionally substituted by one or more atoms or groups selected from Group Z, —OR¹⁰, —S(O)ₘR¹⁰, —S(O)₂NR¹⁰R¹¹R, —NR¹⁰R¹¹, —NR¹⁰CO₂R¹¹, —NR¹⁰C(O)R¹¹, —CO₂R¹⁰, —C(O)R¹⁰, —C(O)NR¹⁰R¹¹, —SF₅, a cyano group, a nitro group, a halogen atom or a hydrogen atom,
R⁵ and R⁶ are the same or different and each represents a C1-C6 chain hydrocarbon group optionally substituted by one or more atoms or groups selected from Group X, a phenyl group optionally substituted by one or more atoms or groups selected from Group Z, a 5- or 6-membered heterocyclic group optionally substituted by one or more atoms or groups selected from Group Z, —OR¹⁰, —S(O)ₘR¹⁰, —S(O)₂NR¹⁰R¹¹, —NR¹⁰R¹¹, —NR¹⁰CO₂R¹¹, —NR¹⁰C(O)R¹¹, —CO₂R¹⁰, —C(O)R¹⁰, —C(O)NR¹⁰R¹¹, —SF₅, a cyano group, a nitro group, a halogen atom or a hydrogen atom (wherein R⁵ and R⁶ do not represents a hydrogen atom at the same time),
R⁷ represents a C1-C6 chain hydrocarbon group optionally substituted by one or more atoms or groups selected from Group W, a C1-C6 chain hydrocarbon group substituted by one phenyl group (wherein the phenyl group is optionally substituted by one or more atoms or groups selected from Group Z), a C1-C6 chain hydrocarbon group substituted by one 5- or 6-membered heterocyclic group (wherein the 5- or 6-membered heterocyclic group is optionally substituted by one or more atoms or groups selected from Group Z), —CO₂R¹⁰, —C(O)R¹⁰, a C3-C6 alicyclic hydrocarbon group optionally substituted by one or more atoms or groups selected from Group Y or a hydrogen atom,
R⁸ and R⁹ are the same or different and each represents a C1-C6 chain hydrocarbon group optionally substituted by one or more halogen atoms, —OR¹⁰, —S(O)ₘR¹⁰, —NR¹⁰R¹¹, —CO₂R¹⁰, —C(O)R¹⁰, a cyano group, a nitro group, a halogen atom or a hydrogen atom,
R¹⁰ and R¹¹ are the same or different and each represents a C1-C6 chain hydrocarbon group optionally substituted by one or more atoms or groups selected from Group X, a phenyl group optionally substituted by one or more atoms or groups selected from Group Z or a hydrogen atom,
each m independently represents 0, 1 or 2, and
n represents 0, 1 or 2,
wherein the —S(O)ₘR¹⁰, R¹⁰ does not a hydrogen atom when m is 1 or 2,
Group X: the group consisting of a C1-C6 alkoxy group optionally substituted by one or more halogen atoms, a C2-C6 alkenyloxy group optionally substituted by one or more halogen atoms, a C2-C6 alkynyloxy group optionally substituted by one or more halogen atoms, a C1-C6 alkylsulfanyl group optionally substituted by one or more halogen atoms, a C1-C6 alkylsulfinyl group optionally substituted by one or more halogen atoms, a C1-C6 alkylsulfonyl group optionally substituted by one or more halogen atoms, a C2-C6 alkylcarbonyl group optionally substituted by one or more halogen atoms, a C2-C6 alkoxycarbonyl group optionally substituted by one or more halogen atoms, a C3-C6 cycloalkyl group optionally substituted by one or more halogen atoms or one or more C1-C3 alkyl groups, a cyano group, a hydroxy group and a halogen atom,
Group Y: the group consisting of a C1-C6 chain hydrocarbon group optionally substituted by one or more halogen atoms, a C1-C6 alkoxy group optionally substituted by one or more halogen atoms, a C2-C6 alkenyloxy group optionally substituted by one or more halogen atoms, a C2-C6 alkynyloxy group optionally substituted by one or more halogen atoms and a halogen atom,
Group Z: the group consisting of a C1-C6 chain hydrocarbon group optionally substituted by one or more halogen atoms, a C1-C6 alkoxy group optionally substituted by one or more halogen atoms, a C1-C6 alkylsulfanyl group optionally substituted by one or more halogen atoms, a C1-C6 alkylsulfinyl group optionally substituted by one or more halogen atoms, a C1-C6 alkylsulfonyl group optionally substituted by one or more halogen atoms, a C2-C6 alkylcarbonyl group optionally substituted by one or more halogen atoms, a C2-C6 alkoxycarbonyl group optionally substituted by one or more halogen atoms, a C1-C6 alkylamino group optionally substituted by one or more halogen atoms, a C2-C8 dialkylamino group optionally substituted by one or more halogen atoms, a halogen atom, a cyano group and a nitro group,
Group W: the group consisting of a C1-C6 alkoxy group optionally substituted by one or more halogen atoms, a C2-C6 alkenyloxy group optionally substituted by one or more halogen atoms, a C2-C6 alkynyloxy group optionally substituted by one or more halogen atoms, a C1-C6 alkylsulfanyl group optionally substituted by one or more halogen atoms, a C2-C6 alkylcarbonyl group optionally substituted by one or more halogen atoms, a C2-C6 alkoxycarbonyl group optionally substituted by one or more halogen atoms, a C3-C6 cycloalkyl group optionally substituted by one or more halogen atoms, a C1-C6 alkylsulfinyl group optionally substituted by one or more halogen atoms, a C1-C6 alkylsulfonyl group optionally substituted by one or more halogen atoms, hydroxy group, a halogen atom and a cyano group, or an N-oxide thereof; and

one or more compounds selected from Group A to Group E:

Group A; fungicides,

Group B; insecticides,

Group C; acaricides,

Group D; chemical injury reducing agents, and

Group E; plant growth regulators.

[2]A method of controlling pests which comprises applying the effective amount of the pest controlling composition of the above [1] to a plant or a soil where the plant is cultivated.
[2-a] The method of controlling pests according to the above [2], wherein the plaint is seed, bulb, or seedling.
[2-b] The method of controlling pests according to the above [2], wherein the plant is corn, soybean, cotton, wheat, sugar beet, rapeseed, or rice.
[3]A plant seed to which an effective amount of the pest controlling composition of the above [1] is attached.

### Advantageous Effects of Invention

By the present invention, pests can be controlled.

### DESCRIPTION OF EMBODIMENTS

A pest controlling composition of the present invention (hereinafter, referred to as inventive composition) includes:
a fused heterocyclic compound represented by the formula (1):

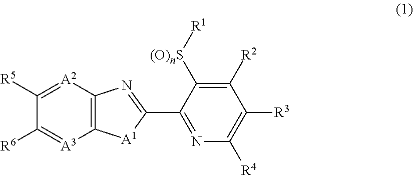

wherein
A¹ represents —NR⁷—, an oxygen atom or a sulfur atom,
A² represents a nitrogen atom or ═CR⁸—,
A³ represents a nitrogen atom or ═CR⁹—,
R¹ represents a C1-C6 chain hydrocarbon group optionally substituted by one or more atoms or groups selected from Group X or a C3-C6 alicyclic hydrocarbon group optionally substituted by one or more atoms or groups selected from Group Y,
R², R³ and R⁴ are the same or different and each represents a C1-C6 chain hydrocarbon group optionally substituted by one or more atoms or groups selected from Group X, a phenyl group optionally substituted by one or more atoms or groups selected from Group Z, a 5- or 6-membered heterocyclic group optionally substituted by one or more atoms or groups selected from Group Z, —OR¹⁰, —S(O)ₘR¹⁰, —S(O)₂NR¹⁰R¹¹, —NR¹⁰R¹¹, —NR¹⁰CO₂R¹¹, —NR¹⁰C(O) R¹¹, —CO₂R¹⁰, —C(O)R¹⁰, —C(O)NR¹⁰R¹¹, —SF₅, a cyano group, a nitro group, a halogen atom or a hydrogen atom,
R⁵ and R⁶ are the same or different and each represents a C1-C6 chain hydrocarbon group optionally substituted by one or more atoms or groups selected from Group X, a phenyl group optionally substituted by one or more atoms or groups selected from Group Z, a 5- or 6-membered heterocyclic group optionally substituted by one or more atoms or groups selected from Group Z, —OR¹⁰, —S(O)ₘR¹⁰, —S(O)₂NR¹⁰R¹¹, —NR¹⁰R¹¹, —NR¹⁰CO₂R¹¹, —NR¹⁰C(O)R¹¹, —CO₂R¹⁰, —C(O)R¹⁰, —C(O)NR¹⁰R¹¹, —SF₅, a cyano group, a nitro group, a halogen atom or a hydrogen atom (wherein R⁵ and R⁶ do not represents a hydrogen atom at the same time),
R⁷ represents a C1-C6 chain hydrocarbon group optionally substituted by one or more atoms or groups selected from Group W, a C1-C6 chain hydrocarbon group substituted by one phenyl group (wherein the phenyl group is optionally substituted by one or more atoms or groups selected from Group Z), a C1-C6 chain hydrocarbon group substituted by one 5- or 6-membered heterocyclic group (wherein the 5- or 6-membered heterocyclic group is optionally substituted by one or more atoms or groups selected from Group Z), —CO₂R¹⁰, —C(O)R¹⁰, a C3-C6 alicyclic hydrocarbon group optionally substituted by one or more atoms or groups selected from Group Y or a hydrogen atom,
R⁸ and R⁹ are the same or different and each represents a C1-C6 chain hydrocarbon group optionally substituted by one or more halogen atoms, —OR¹⁰, —S(O)ₘR¹⁰, —NR¹⁰R¹¹, —CO₂R¹⁰, —C(O)R¹⁰, a cyano group, a nitro group, a halogen atom or a hydrogen atom, R¹⁰ and R¹¹ are the same or different and each represents a C1-C6 chain hydrocarbon group optionally substituted by one or more atoms or groups selected from Group X, a phenyl group optionally substituted by one or more atoms or groups selected from Group Z or a hydrogen atom,
each m independently represents 0, 1 or 2, and
n represents 0, 1 or 2,
wherein the —S(O)ₘR¹⁰, R¹⁰ does not a hydrogen atom when m is 1 or 2,
Group X: the group consisting of a C1-C6 alkoxy group optionally substituted by one or more halogen atoms, a C2-C6 alkenyloxy group optionally substituted by one or more halogen atoms, a C2-C6 alkynyloxy group optionally substituted by one or more halogen atoms, a C1-C6 alkylsulfanyl group optionally substituted by one or more halogen atoms, a C1-C6 alkylsulfinyl group optionally substituted by one or more halogen atoms, a C1-C6 alkylsulfonyl group optionally substituted by one or more halogen atoms, a C2-C6 alkylcarbonyl group optionally substituted by one or more halogen atoms, a C2-C6 alkoxycarbonyl group optionally substituted by one or more halogen atoms, a C3-C6 cycloalkyl group optionally substituted by one or more halogen atoms or one or more C1-C3 alkyl groups, a cyano group, a hydroxy group and a halogen atom,
Group Y: the group consisting of a C1-C6 chain hydrocarbon group optionally substituted by one or more halogen atoms, a C1-C6 alkoxy group optionally substituted by one or more halogen atoms, a C2-C6 alkenyloxy group optionally substituted by one or more halogen atoms, a C2-C6 alkynyloxy group optionally substituted by one or more halogen atoms and a halogen atom,
Group Z: the group consisting of a C1-C6 chain hydrocarbon group optionally substituted by one or more halogen atoms, a C1-C6 alkoxy group optionally substituted by one or more halogen atoms, a C1-C6 alkylsulfanyl group optionally substituted by one or more halogen atoms, a C1-C6 alkylsulfinyl group optionally substituted by one or more halogen atoms, a C1-C6 alkylsulfonyl group optionally substituted by one or more halogen atoms, a C2-C6 alkylcarbonyl group optionally substituted by one or more halogen atoms, a C2-C6 alkoxycarbonyl group optionally substituted by one or more halogen atoms, a C1-C6 alkylamino group optionally substituted by one or more halogen atoms, a C2-C8 dialkylamino group optionally substituted by one or more halogen atoms, a halogen atom, a cyano group and a nitro group,
Group W: the group consisting of a C1-C6 alkoxy group optionally substituted by one or more halogen atoms, a C2-C6 alkenyloxy group, optionally substituted by one or more halogen atoms, a C2-C6 alkynyloxy group optionally substituted by one or more halogen atoms, a C1-C6 alkylsulfanyl group optionally substituted by one or more halogen atoms, a C2-C6 alkylcarbonyl group optionally substituted by one or more halogen atoms, a C2-C6 alkoxycarbonyl group optionally substituted by one or more halogen atoms, a C3-C6 cycloalkyl group optionally substituted by one or more halogen atoms, a C1-C6 alkylsulfinyl group optionally substituted by one or more halogen atoms, a C1-C6 alkylsulfonyl group optionally substituted by one or more halogen atoms, hydroxy group, a halogen atom and a cyano group, or an N-oxide thereof (hereinafter referred to as “the present compound”); and

one or more compounds selected from Group A to Group E:

Group A; fungicides,

Group B; insecticides,

Group C; acaricides,

Group D; chemical injury reducing agents, and

Group E; plant growth regulators.

Embodiments of the present compound include compounds of the formula (1) shown in Table 1, compounds of the formula (2) shown in Table 2, compounds of the formula (2A) shown in Table 3, compounds of the formula (2B) shown in Table 4 and compounds of the formula (2C) shown in Table 5. These compounds are the compounds disclosed in International Publication WO 2013/018928 and can be produced by the methods described in this publication.

A compound represented by the formula (1):

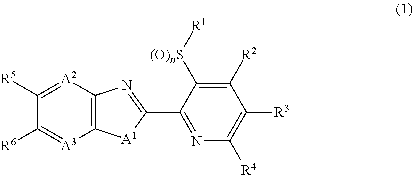

wherein R¹, R², R³, R⁴, R⁵, R⁶, A¹, A², A³ and n are any of the combinations as listed in [Table 1].

TABLE 1

| The present | | | | | | | | | | |
|---|---|---|---|---|---|---|---|---|---|---|
| compound | R¹ | R² | R³ | R⁴ | R⁵ | R⁶ | A¹ | A² | A³ | n |
| 1 | Et | H | H | H | CF₃ | H | NMe | CH | N | 0 |
| 2 | Et | H | H | H | CF₃ | H | NMe | CH | N | 1 |
| 3 | Et | H | H | H | CF₃ | H | NMe | CH | N | 2 |
| 4 | Et | H | CF₃ | H | CF₃ | H | NMe | CH | N | 0 |
| 5 | Et | H | CF₃ | H | CF₃ | H | NMe | CH | N | 2 |
| 6 | Et | H | H | H | CF₂CF₃ | H | NMe | CH | N | 0 |
| 7 | Et | H | H | H | CF₂CF₃ | H | NMe | CH | N | 1 |
| 8 | Et | H | H | H | CF₂CF₃ | H | NMe | CH | N | 2 |
| 9 | Et | H | H | H | I | H | NMe | CH | N | 0 |
| 10 | Et | H | CF₃ | H | CF₃ | H | S | CH | N | 0 |
| 11 | Et | H | CF₃ | H | CF₃ | H | S | CH | N | 2 |
| 12 | Et | H | H | H | CF₃ | H | S | CH | N | 2 |
| 13 | Et | H | H | H | SCF₃ | H | NMe | CH | N | 0 |
| 14 | Et | H | H | H | SCF₃ | H | NMe | CH | N | 1 |
| 15 | Et | H | H | H | SCF₃ | H | NMe | CH | N | 2 |
| 16 | Et | H | H | H | SO₂CF₃ | H | NMe | CH | N | 2 |
| 17 | Et | H | CF₃ | H | CF₂CF₃ | H | NMe | CH | N | 0 |
| 18 | Et | H | CF₃ | H | CF₂CF₃ | H | NMe | CH | N | 1 |
| 19 | Et | H | CF₃ | H | CF₂CF₃ | H | NMe | CH | N | 2 |
| 20 | Et | H | H | H | SOCF₃ | H | NMe | CH | N | 2 |
| 21 | Et | H | H | H | I | H | NMe | CH | CH | 0 |
| 22* | Et | H | H | H | CF₃ | H | S | CH | N | 2 |
| 23 | Et | H | H | H | SF₅ | H | NMe | CH | CH | 0 |
| 24 | Et | H | H | H | SF₅ | H | NMe | CH | CH | 2 |
| 25 | Et | H | CF₃ | H | SO₂CF₃ | H | NMe | CH | N | 2 |
| 26 | Et | H | H | H | CF₂CF₃ | H | NMe | CH | CH | 0 |
| 27 | Et | H | H | H | CF₂CF₃ | H | NMe | CH | CH | 2 |
| 28 | Et | H | CF₃ | H | SCF₃ | H | NMe | CH | N | 0 |
| 29 | Et | H | CF₃ | H | SCF₃ | H | NMe | CH | N | 1 |
| 30 | Et | H | H | H | CF₃ | H | NMe | CH | CH | 0 |
| 31 | Et | H | H | H | CF₃ | H | NMe | CH | CH | 1 |
| 32 | Et | H | H | H | CF₃ | H | NMe | CH | CH | 2 |
| 33 | Et | H | CF₃ | H | CF₃ | H | NMe | CH | CH | 0 |
| 34 | Et | H | CF₃ | H | CF₃ | H | NMe | CH | CH | 1 |
| 35 | Et | H | CF₃ | H | CF₃ | H | NMe | CH | CH | 2 |
| 36* | Et | H | H | H | CF₃ | H | NMe | CH | N | 2 |
| 37* | Et | H | H | H | CF₃ | H | NMe | CH | N | 2 |
| 38 | Et | H | CF₃ | H | CF₂CF₃ | H | NMe | CH | CH | 0 |
| 39 | Et | H | CF₃ | H | CF₂CF₃ | H | NMe | CH | CH | 1 |
| 40 | Et | H | CF₃ | H | CF₂CF₃ | H | NMe | CH | CH | 2 |
| 41 | Et | H | H | H | CF₃ | H | S | CH | N | 0 |
| 42 | Et | H | CF₃ | H | I | H | NMe | CH | N | 0 |
| 43 | Et | H | CF₃ | H | SH | H | NMe | CH | N | 0 |
| 44 | Et | H | CF₃ | H | SCF₃ | H | NMe | CH | N | 2 |
| 45 | Et | H | CF₃ | H | I | H | NMe | CH | CH | 0 |
| 46 | Et | H | H | H | CF₃ | H | NMe | CH | CBr | 2 |
| 47* | Et | H | H | H | CF₂CF₃ | H | NMe | CH | CH | 2 |
| 48* | Et | H | CF₃ | H | CF₃ | H | NMe | CH | N | 2 |
| 49 | Et | H | H | H | OCF₃ | H | NMe | CH | CH | 0 |
| 50 | Et | H | H | H | OCF₃ | H | NMe | CH | CH | 2 |
| 51* | Et | H | CF₃ | H | CF₃ | H | NMe | CH | N | 2 |
| 52 | Et | H | H | H | CF₃ | H | S | CH | CH | 0 |
| 53 | Et | H | H | H | CF₃ | H | S | CH | CH | 2 |
| 54 | Et | H | CF₃ | H | CF₃ | H | S | CH | CH | 0 |
| 55 | Et | H | CF₃ | H | CF₃ | H | S | CH | CH | 2 |
| 56 | Et | H | H | H | CF₃ | OMe | NMe | CH | CH | 2 |
| 57 | Et | H | H | H | C(OH)₂CF₃ | H | NMe | CH | N | 0 |
| 58 | Et | H | H | H | C(OH)₂CF₃ | H | NMe | CH | N | 2 |
| 59 | Et | H | CF₃ | H | CO₂Me | H | NMe | CH | N | 0 |
| 60 | Et | H | CF₃ | H | SOCF₃ | H | NMe | CH | N | 2 |
| 61 | Et | H | H | H | SCF₃ | H | NMe | CH | CH | 0 |
| 62 | Et | H | H | H | SCF₃ | H | NMe | CH | CH | 1 |
| 63 | Et | H | H | H | SCF₃ | H | NMe | CH | CH | 2 |
| 64 | Et | H | H | H | SO₂CF₃ | H | NMe | CH | CH | 2 |
| 65 | Et | H | H | H | CF₃ | H | NCH₂CF₃ | CH | N | 0 |
| 66 | Et | H | CF₃ | H | CF₃ | H | NCH₂CF₃ | CH | N | 0 |
| 67 | Et | H | H | H | CF₃ | H | NCH₂CF₃ | CH | N | 2 |
| 68 | Et | H | CF₃ | H | CF₃ | H | NCH₂CF₃ | CH | N | 2 |
| 69 | Et | H | CF₃ | H | CO₂Me | H | NMe | CH | N | 2 |
| 70* | Et | H | CF₃ | H | CO₂Me | H | NMe | CH | N | 2 |
| 71 | Et | H | CF₂CF₃ | H | CF₃ | H | NMe | CH | N | 0 |
| 72 | Et | H | CF₂CF₃ | H | CF₃ | H | NMe | CH | N | 2 |
| 73 | Et | H | CF₂CF₃ | H | CF₂CF₃ | H | NMe | CH | N | 0 |
| 74 | Et | H | CF₂CF₃ | H | CF₂CF₃ | H | NMe | CH | N | 2 |
| 75 | Et | H | H | H | CF₃ | H | NMe | CH | CBr | 0 |
| 76 | Et | H | H | H | CF₃ | H | NH | CH | N | 0 |
| 77 | Et | H | H | H | CF₃ | H | NH | CH | N | 2 |
| 78 | Et | H | CF₃ | H | CF₃ | H | NH | CH | N | 0 |
| 79 | Et | H | CF₃ | H | CF₃ | H | NH | CH | N | 2 |
| 80 | Et | H | H | H | CF₃ | H | O | CH | N | 0 |
| 81 | Et | H | H | H | CF₃ | H | O | CH | N | 2 |
| 82 | Et | H | CF₃ | H | CF₃ | H | O | CH | N | 0 |
| 83 | Et | H | CF₃ | H | CF₃ | H | O | CH | N | 2 |
| 84 | Et | H | H | H | CF₃ | H | O | CH | CH | 0 |
| 85 | Et | H | H | H | CF₃ | H | O | CH | CH | 2 |
| 86 | Et | H | CF₃ | H | CF₃ | H | O | CH | CH | 0 |
| 87 | Et | H | CF₃ | H | CF₃ | H | O | CH | CH | 2 |
| 88 | Et | H | H | H | CF₃ | Cl | NMe | CH | N | 2 |
| 89 | Et | H | CF₃ | H | CF₃ | Cl | NMe | CH | N | 2 |
| 90 | Et | H | H | H | CF₃ | SEt | NMe | CH | N | 2 |
| 91 | Et | H | CF₃ | H | CF₃ | SEt | NMe | CH | N | 2 |
| 92 | Et | H | H | H | CF₃ | OH | NMe | CH | N | 2 |
| 93 | Et | H | CF₃ | H | CF₃ | OH | NMe | CH | N | 2 |
| 94 | Et | H | H | H | CF₃ | OMe | NMe | CH | N | 2 |
| 95 | Et | H | CF₃ | H | CF₃ | OMe | NMe | CH | N | 2 |
| 96 | Et | H | H | H | CF₃ | SMe | NMe | CH | N | 2 |
| 97 | Et | H | CF₃ | H | CF₃ | SMe | NMe | CH | N | 2 |
| 98 | Et | H | H | H | CF₃ | NMe₂ | NMe | CH | N | 2 |
| 99 | Et | H | CF₃ | H | CF₃ | NMe₂ | NMe | CH | N | 2 |
| 100 | Et | H | H | H | CF₃ | Ph | NMe | CH | N | 2 |
| 101 | Et | H | CF₃ | H | CF₃ | Ph | NMe | CH | N | 2 |
| 102 | CH₂CycPr | H | H | H | CF₃ | H | NMe | CH | N | 2 |
| 103 | CH₂CycPr | H | CF₃ | H | CF₃ | H | NMe | CH | N | 2 |
| 104 | CF₃ | H | H | H | CF₃ | H | NMe | CH | N | 2 |
| 105 | CF₃ | H | CF₃ | H | CF₃ | H | NMe | CH | N | 2 |
| 106 | CH₂CF₃ | H | H | H | CF₃ | H | NMe | CH | N | 2 |
| 107 | CH₂CF₃ | H | CF₃ | H | CF₃ | H | NMe | CH | N | 2 |
| 108 | Et | Cl | H | H | CF₃ | H | NMe | CH | N | 2 |
| 109 | Et | H | Cl | H | CF₃ | H | NMe | CH | N | 2 |
| 110 | Et | H | H | Cl | CF₃ | H | NMe | CH | N | 2 |
| 111 | Et | H | 2-pyridyl | H | CF₃ | H | NMe | CH | N | 2 |
| 112 | Et | H | 2-pyrimidinyl | H | CF₃ | H | NMe | CH | N | 2 |
| 113 | Et | H | 3-chloro- | H | CF₃ | H | NMe | CH | N | 2 |
| | | | 2-pyridyl | | | | | | | |
| 114 | Et | H | 3-chloro- | H | CF₃ | H | NMe | CH | N | 2 |
| | | | 5-trifluoromethyl- | | | | | | | |
| | | | 2-pyridyl | | | | | | | |
| 115 | Et | H | OCF₃ | H | CF₃ | H | NMe | CH | N | 2 |
| 116 | Et | H | SCF₃ | H | CF₃ | H | NMe | CH | N | 2 |
| 117 | Et | H | SOCF₃ | H | CF₃ | H | NMe | CH | N | 2 |
| 118 | Et | H | SO₂CF₃ | H | CF₃ | H | NMe | CH | N | 2 |
| 119 | Et | H | CF(CF₃)₂CF₃ | H | CF₃ | H | NMe | CH | N | 2 |
| 120 | Et | H | CF₂CF₂CF₃ | H | CF₃ | H | NMe | CH | N | 2 |
| 121 | Et | H | Br | H | CF₃ | H | NMe | CH | N | 2 |
| 122 | Et | H | I | H | CF₃ | H | NMe | CH | N | 2 |
| 123 | Et | H | Me | H | CF₃ | H | NMe | CH | N | 2 |
| 124 | Et | H | OMe | H | CF₃ | H | NMe | CH | N | 2 |
| 125 | Et | H | H | H | CF(CF₃)₂ | H | NMe | CH | N | 2 |
| 126 | Et | H | CF₃ | H | CF(CF₃)₂ | H | NMe | CH | N | 2 |
| 127 | Et | H | CF₃ | H | SF₅ | H | NMe | CH | N | 2 |
| 128 | Et | H | H | H | CF₂CF₂CF₃ | H | NMe | CH | N | 2 |
| 129 | Et | H | CF₃ | H | CF₂CF₂CF₃ | H | NMe | CH | N | 2 |
| 130 | Et | H | H | H | SCF₂CF₃ | H | NMe | CH | N | 2 |
| 131 | Et | H | CF₃ | H | SCF₂CF₃ | H | NMe | CH | N | 2 |
| 132 | Et | H | H | H | SO₂CF₂CF₃ | H | NMe | CH | N | 2 |
| 133 | Et | H | CF₃ | H | SO₂CF₂CF₃ | H | NMe | CH | N | 2 |
| 134 | Et | H | H | H | CF₃ | H | NCH₂OMe | CH | N | 2 |
| 135 | Et | H | CF₃ | H | CF₃ | H | NCH₂OMe | CH | N | 2 |
| 136 | Et | H | H | H | CF₃ | H | NCH₂C≡CH | CH | N | 2 |
| 137 | Et | H | CF₃ | H | CF₃ | H | NCH₂C≡CH | CH | N | 2 |
| 138 | Et | H | H | H | CF₃ | H | NMe | CH | CCN | 2 |
| 139 | Et | H | CF₃ | H | CF₃ | H | NMe | CH | CCN | 2 |
| 140 | Et | H | H | H | CF₃ | H | NMe | CH | CF | 2 |
| 141 | Et | H | CF₃ | H | CF₃ | H | NMe | CH | CF | 2 |
| 142 | Et | H | H | H | CF₃ | H | NMe | CH | CMe | 2 |
| 143 | Et | H | CF₃ | H | CF₃ | H | NMe | CH | CMe | 2 |
| 144 | Et | H | H | H | CF₃ | H | NMe | CH | COMe | 2 |
| 145 | Et | H | CF₃ | H | CF₃ | H | NMe | CH | COMe | 2 |
| 146 | Et | H | H | H | CF₃ | H | NMe | CH | CSCH₂CH₃ | 2 |
| 147 | Et | H | CF₃ | H | CF₃ | H | NMe | CH | CSCH₂CH₃ | 2 |
| 148 | Et | H | H | H | CF₃ | H | NMe | CH | CSO₂CH₂CH₃ | 2 |
| 149 | Et | H | CF₃ | H | CF₃ | H | NMe | CH | CSO₂CH₂CH₃ | 2 |
| 150 | Me | H | H | H | CF₃ | H | NMe | CH | N | 0 |
| 151 | Me | H | H | H | CF₃ | H | NMe | CH | N | 1 |
| 152 | Me | H | H | H | CF₃ | H | NMe | CH | N | 2 |
| 153 | Pr | H | H | H | CF₃ | H | NMe | CH | N | 0 |
| 154 | Pr | H | H | H | CF₃ | H | NMe | CH | N | 1 |
| 155 | Pr | H | H | H | CF₃ | H | NMe | CH | N | 2 |
| 156 | CH₂CH═CH₂ | H | H | H | CF₃ | H | NMe | CH | N | 0 |
| 157 | CH₂CH═CH₂ | H | H | H | CF₃ | H | NMe | CH | N | 2 |
| 158 | iPr | H | H | H | CF₃ | H | NMe | CH | N | 0 |
| 159 | iPr | H | H | H | CF₃ | H | NMe | CH | N | 1 |
| 160 | iPr | H | H | H | CF₃ | H | NMe | CH | N | 2 |
| 161 | tBu | H | H | H | CF₃ | H | NMe | CH | N | 0 |
| 162 | tBu | H | H | H | CF₃ | H | NMe | CH | N | 1 |
| 163 | tBu | H | H | H | CF₃ | H | NMe | CH | N | 2 |
| 164 | CF₃ | H | H | H | CF₃ | H | NMe | CH | N | 0 |
| 165 | CF₃ | H | H | H | CF₃ | H | NMe | CH | N | 1 |
| 166 | Et | H | H | H | CF₃ | H | NEt | CH | N | 0 |
| 167 | Et | H | H | H | CF₃ | H | NEt | CH | N | 1 |
| 168 | Et | H | H | H | CF₃ | H | NEt | CH | N | 2 |
| 169 | Et | H | H | H | CF₃ | H | NPr | CH | N | 0 |
| 170 | Et | H | H | H | CF₃ | H | NPr | CH | N | 1 |
| 171 | Et | H | H | H | CF₃ | H | NPr | CH | N | 2 |
| 172 | Et | H | H | H | CF₃ | H | NiPr | CH | N | 0 |
| 173 | Et | H | H | H | CF₃ | H | NiPr | CH | N | 1 |
| 174 | Et | H | H | H | CF₃ | H | NiPr | CH | N | 2 |
| 175 | Et | H | H | H | CF₃ | H | NCycPr | CH | N | 0 |
| 176 | Et | H | H | H | CF₃ | H | NCycPr | CH | N | 1 |
| 177 | Et | H | H | H | CF₃ | H | NCycPr | CH | N | 2 |
| 178 | Et | H | H | H | CF₃ | H | NCH₂OEt | CH | N | 0 |
| 179 | Et | H | H | H | H | CF₃ | NCH₂OEt | N | CH | 0 |
| 180 | Et | H | H | H | CF₃ | H | NCH₂OEt | CH | N | 1 |
| 181 | Et | H | H | H | CF₃ | H | NCH₂OEt | CH | N | 2 |
| 182 | Et | H | H | H | CF₃ | H | NCH₂OMe | CH | N | 0 |
| 183 | Et | H | H | H | Me | H | NMe | CH | N | 0 |
| 184 | Et | H | H | H | Me | H | NMe | CH | N | 1 |
| 185 | Et | H | H | H | Me | H | NMe | CH | N | 2 |
| 186 | Et | H | H | H | Br | H | NMe | CH | N | 0 |
| 187 | Et | H | H | H | Br | H | NMe | CH | N | 1 |
| 188 | Et | H | H | H | Br | H | NMe | CH | N | 2 |
| 189 | Et | H | H | H | I | H | NMe | CH | N | 1 |
| 190 | Et | H | H | H | I | H | NMe | CH | N | 2 |
| 191 | Et | H | H | H | CN | H | NMe | CH | N | 0 |
| 192 | Et | H | H | H | CN | H | NMe | CH | N | 1 |
| 193 | Et | H | H | H | CN | H | NMe | CH | N | 2 |
| 194 | Et | H | H | H | CHO | H | NMe | CH | N | 0 |
| 195 | Et | H | H | H | CF₂H | H | NMe | CH | N | 0 |
| 196 | Et | H | H | H | CF₂H | H | NMe | CH | N | 1 |
| 197 | Et | H | H | H | CF₂H | H | NMe | CH | N | 2 |
| 198 | Et | H | H | H | Ph | H | NMe | CH | N | 0 |
| 199 | Et | H | H | H | Ph | H | NMe | CH | N | 2 |
| 200 | Et | H | H | H | 2-fluoro- | H | NMe | CH | N | 0 |
| | | | | | phenyl | | | | | |
| 201 | Et | H | H | H | 2-fluoro- | H | NMe | CH | N | 1 |
| | | | | | phenyl | | | | | |
| 202 | Et | H | H | H | 2-fluoro- | H | NMe | CH | N | 2 |
| | | | | | phenyl | | | | | |
| 203 | Et | H | H | H | 3-fluoro- | H | NMe | CH | N | 0 |
| | | | | | phenyl | | | | | |
| 204 | Et | H | H | H | 3-fluoro- | H | NMe | CH | N | 1 |
| | | | | | phenyl | | | | | |
| 205 | Et | H | H | H | 3-fluoro- | H | NMe | CH | N | 2 |
| | | | | | phenyl | | | | | |
| 206 | Et | H | H | H | 4-fluoro- | H | NMe | CH | N | 0 |
| | | | | | phenyl | | | | | |
| 207 | Et | H | H | H | 4-fluoro- | H | NMe | CH | N | 2 |
| | | | | | phenyl | | | | | |
| 208 | Et | H | H | H | H | CF₃ | NMe | N | CH | 0 |
| 209 | Me | H | H | H | CF₃ | H | NMe | CH | CH | 0 |
| 210 | Et | H | H | H | CF₃ | H | NMe | CH | CCl | 0 |
| 211 | Et | H | H | H | CF₃ | H | NMe | CH | CCl | 1 |
| 212 | Et | H | H | H | CF₃ | H | NMe | CH | CCl | 2 |
| 213 | Et | H | H | H | CF₃ | H | NMe | CH | CBr | 1 |
| 214 | Me | H | H | H | CF₃ | H | O | CH | CH | 0 |
| 215 | Et | H | H | H | CF₃ | H | O | CH | CH | 1 |
| 216 | Et | H | H | H | CF₃ | H | O | CH | N | 1 |
| 217 | Me | H | H | H | CF₃ | H | S | CH | CH | 0 |
| 218 | Et | H | H | H | CF₃ | H | S | CH | CH | 1 |
| 219 | Et | Cl | H | H | CF₃ | H | NMe | CH | N | 0 |
| 220 | Et | Cl | H | H | CF₃ | H | NMe | CH | N | 1 |
| 221 | Et | H | H | H | COCF₃ | H | NMe | CH | N | 0 |
| 222 | Et | H | H | H | Cl | H | NMe | CH | N | 0 |
| 223 | Et | H | H | H | Cl | H | NMe | CH | N | 1 |
| 224 | Et | H | H | H | Cl | H | NMe | CH | N | 2 |
| 225 | Et | H | H | H | Br | H | NMe | CCHO | N | 0 |
| 226 | Et | H | H | SEt | CF₃ | H | NMe | CH | N | 0 |
| 227 | Et | H | H | H | CF₃ | H | NCH₂OEt | CH | CH | 0 |
| 228 | Et | H | H | H | H | CF₃ | NCH₂OEt | N | CH | 0 |
| 229 | Et | H | H | H | CF₃ | H | NCH₂CO₂Me | CH | N | 0 |
| 230 | Et | H | H | H | CF₃ | H | NCH₂CO₂Et | CH | N | 0 |
| 231 | Et | H | H | H | CF₃ | H | N(CH₂)₂OMe | CH | N | 0 |
| 232 | Et | H | H | H | CF₃ | H | NCH₂SMe | CH | N | 0 |
| 233 | Et | H | H | H | CF₃ | H | N(CH₂)₂SMe | CH | N | 0 |
| 234 | Et | H | H | H | CF₃ | H | NBu | CH | N | 0 |
| 235 | Et | H | H | H | CF₃ | H | NCO₂tBu | CH | N | 0 |
| 236 | Et | H | H | H | CH(OH)CF₃ | H | NMe | CH | N | 0 |
| 237 | Et | H | H | H | CHFCF₃ | H | NMe | CH | N | 0 |
| 238 | Et | H | F | H | CF₃ | H | NMe | CH | N | 0 |
| 239 | Et | H | F | H | CF₃ | H | NMe | CH | N | 1 |
| 240 | Et | H | F | H | CF₃ | H | NMe | CH | N | 2 |
| 241 | Et | OMe | H | H | CF₃ | H | NMe | CH | N | 0 |
| 242 | Et | OMe | H | H | CF₃ | H | NMe | CH | N | 1 |
| 243 | Et | H | OMe | H | CF₃ | H | NMe | CH | N | 0 |
| 244 | Et | H | OMe | H | CF₃ | H | NMe | CH | N | 1 |
| 245 | Et | H | OH | H | CF₃ | H | NMe | CH | N | 0 |
| 246 | Et | H | H | H | NH₂ | H | NMe | CH | N | 0 |
| 247 | Et | H | H | H | CHFCF₃ | H | NMe | CH | N | 1 |
| 248 | Et | H | H | H | CHFCF₃ | H | NMe | CH | N | 2 |
| 249 | Et | H | H | H | CF₂CF₂CF₃ | H | NMe | CH | N | 0 |
| 250 | Et | H | H | H | CF₂CF₂CF₃ | H | NMe | CH | N | 1 |
| 251 | Et | Cl | H | H | CF₂CF₃ | H | NMe | CH | N | 1 |
| 252 | Et | Cl | H | H | CF₂CF₃ | H | NMe | CH | N | 2 |
| 253 | Et | H | Cl | H | CF₃ | H | NMe | CH | N | 0 |
| 254 | Et | H | Cl | H | CF₃ | H | NMe | CH | N | 1 |
| 255 | Et | H | Cl | H | CF₂CF₃ | H | NMe | CH | N | 1 |
| 256 | Et | H | H | Cl | CF₃ | H | NMe | CH | N | 0 |
| 257 | Et | H | H | Cl | CF₃ | H | NMe | CH | N | 1 |
| 258 | Et | H | H | OMe | CF₃ | H | NMe | CH | N | 0 |
| 259 | Et | H | H | OMe | CF₃ | H | NMe | CH | N | 1 |
| 260 | Et | H | H | OMe | CF₃ | H | NMe | CH | N | 2 |
| 261 | Et | H | H | H | SH | H | NMe | CH | N | 0 |
| 262 | Et | H | H | H | Et | H | NMe | CH | N | 0 |
| 263 | Et | H | H | H | iPr | H | NMe | CH | N | 0 |
| 264 | Et | H | H | H | NHEt | H | NMe | CH | N | 0 |
| 265 | Et | H | H | H | NEt₂ | H | NMe | CH | N | 0 |
| 266 | Et | H | H | H | tBu | H | NMe | CH | N | 0 |
| 267 | Et | H | H | H | H | CF₃ | NMe | CH | N | 0 |
| 268 | Et | F | H | H | CF₃ | H | NMe | CH | N | 0 |
| 269 | Et | F | H | H | CF₃ | H | NMe | CH | N | 1 |
| 270 | Et | F | H | H | CF₃ | H | NMe | CH | N | 2 |
| 271 | Et | H | H | H | H | CF₃ | NMe | CH | N | 1 |
| 272 | Et | H | H | H | H | CF₃ | NMe | CH | N | 2 |
| 273 | Et | H | H | H | NMe₂ | H | NMe | CH | N | 0 |
| 274 | Et | H | H | H | pyrrolidin- | H | NMe | CH | N | 0 |
| | | | | | 1-yl | | | | | |
| 275 | Et | H | H | H | NHCOMe | H | NMe | CH | N | 0 |
| 276 | Et | H | H | H | CH₂CF₃ | H | NMe | CH | N | 0 |
| 277 | Et | H | H | H | CF₃ | H | NMe | N | CH | 0 |
| 278 | Et | H | H | H | CF₃ | H | NMe | N | CH | 1 |
| 279 | Et | H | H | H | CF₃ | H | NMe | N | CH | 2 |
| 280 | Et | H | H | H | NMeCOMe | H | NMe | CH | N | 0 |
| 281 | Et | H | H | H | NH2 | H | NMe | CH | N | 1 |
| 282 | Et | H | CF₃ | H | CF₃ | H | NMe | CH | N | 1 |
| 283 | Et | H | H | H | NHCOCF₃ | H | NMe | CH | N | 0 |
| 284 | Et | H | H | H | NHCOCF₃ | H | NMe | CH | N | 1 |
| 285 | Et | H | H | H | NHCOCF₃ | H | NMe | CH | N | 2 |
| 286 | Et | H | H | H | 2-CF₃—Ph | H | NMe | CH | N | 0 |
| 287 | Et | H | H | H | 3-CF₃—Ph | H | NMe | CH | N | 0 |
| 288 | Et | H | H | H | 4-CF₃—Ph | H | NMe | CH | N | 0 |
| 289 | Et | H | H | H | CF₃ | H | S | CH | N | 1 |
| 290 | CH₂CF₃ | H | H | H | CF₃ | H | NMe | CH | N | 0 |
| 291 | CH₂CF₃ | H | H | H | CF₃ | H | NMe | CH | N | 1 |
| 292 | Et | Me | H | H | CF₃ | H | NMe | CH | N | 0 |
| 293 | Et | Me | H | H | CF₃ | H | NMe | CH | N | 1 |
| 294 | Et | Me | H | H | CF₃ | H | NMe | CH | N | 2 |
| 295 | Et | H | Me | H | CF₃ | H | NMe | CH | N | 0 |
| 296 | Et | H | Me | H | CF₃ | H | NMe | CH | N | 1 |
| 297 | Et | H | H | H | 2-CF₃—Ph | H | NMe | CH | N | 1 |
| 298 | Et | H | H | H | 2-CF₃—Ph | H | NMe | CH | N | 2 |
| 299 | Et | H | H | H | 3-CF₃—Ph | H | NMe | CH | N | 1 |
| 300 | Et | H | H | H | 3-CF₃—Ph | H | NMe | CH | N | 2 |
| 301 | Et | H | H | H | 4-CF₃—Ph | H | NMe | CH | N | 1 |
| 302 | Et | H | H | H | 4-CF₃—Ph | H | NMe | CH | N | 2 |
| 303 | Et | H | H | CF₃ | CF₃ | H | NMe | CH | N | 0 |
| 304 | Et | H | H | CF₃ | CF₃ | H | NMe | CH | N | 1 |
| 305 | Et | H | H | CF₃ | CF₃ | H | NMe | CH | N | 2 |
| 306 | Et | H | H | H | 2-chloro- | H | NMe | CH | N | 0 |
| | | | | | phenyl | | | | | |
| 307 | Et | H | H | H | 3-chloro- | H | NMe | CH | N | 0 |
| | | | | | phenyl | | | | | |
| 308 | Et | H | H | H | 4-chloro- | H | NMe | CH | N | 0 |
| | | | | | phenyl | | | | | |
| 309 | Et | H | H | H | 6-chloro-3- | H | NMe | CH | N | 0 |
| | | | | | pyridyl | | | | | |
| 310 | Et | H | H | H | 5-fluoro-3- | H | NMe | CH | N | 0 |
| | | | | | pyridyl | | | | | |
| 311 | Et | H | H | H | 3-pyridyl | H | NMe | CH | N | 0 |
| 312 | Et | H | H | H | 4-pyridyl | H | NMe | CH | N | 0 |
| 313 | Et | H | H | H | 4-chloro-1- | H | NMe | CH | N | 0 |
| | | | | | pyrazolyl | | | | | |
| 314 | Et | H | H | H | 2-chloro- | H | NMe | CH | N | 1 |
| | | | | | phenyl | | | | | |
| 315 | Et | H | H | H | 2-chloro- | H | NMe | CH | N | 2 |
| | | | | | phenyl | | | | | |
| 316 | Et | H | H | H | 3-chloro- | H | NMe | CH | N | 1 |
| | | | | | phenyl | | | | | |
| 317 | Et | H | H | H | 3-chloro- | H | NMe | CH | N | 2 |
| | | | | | phenyl | | | | | |
| 318 | Et | H | H | H | 4-chloro- | H | NMe | CH | N | 2 |
| | | | | | phenyl | | | | | |
| 319 | Et | H | H | H | 4-pyridyl | H | NMe | CH | N | 1 |
| 320 | Et | H | H | H | 4-pyridyl | H | NMe | CH | N | 2 |
| 321 | Et | H | H | H | 6-chloro-3- | H | NMe | CH | N | 2 |
| | | | | | pyridyl | | | | | |
| 322 | Et | H | H | H | 5-fluoro-3- | H | NMe | CH | N | 1 |
| | | | | | pyridyl | | | | | |
| 323 | Et | H | H | H | 5-fluoro-3- | H | NMe | CH | N | 2 |
| | | | | | pyridyl | | | | | |
| 324 | Et | H | H | H | 4-chloro-1- | H | NMe | CH | N | 2 |
| | | | | | pyrazolyl | | | | | |
| 325 | Et | H | H | H | 3-chloro-1- | H | NMe | CH | N | 0 |
| | | | | | triazolyl | | | | | |
| 326 | Et | H | H | H | 4-CF₃- | H | NMe | CH | N | 0 |
| | | | | | imidazole | | | | | |
| 327 | Et | H | H | H | 2-nitro-phenyl | H | NMe | CH | N | 0 |
| 328 | Et | H | H | H | 3-nitro-phenyl | H | NMe | CH | N | 0 |
| 329 | Et | H | H | H | 2-cyano-phenyl | H | NMe | CH | N | 0 |
| 330 | Et | H | H | H | 3-cyano-phenyl | H | NMe | CH | N | 0 |
| 331 | Et | H | H | H | 4-cyano-phenyl | H | NMe | CH | N | 0 |
| 332 | Et | H | H | H | 3-CF₃- | H | NMe | CH | N | 0 |
| | | | | | triazolyl | | | | | |
| 333 | Et | H | H | H | 3-CF₃-5-Me- | H | NMe | CH | N | 0 |
| | | | | | triazolyl | | | | | |
| 334 | Et | H | H | H | 3-chloro-1- | H | NMe | CH | N | 2 |
| | | | | | triazolyl | | | | | |
| 335 | Et | H | H | H | 4-CF₃- | H | NMe | CH | N | 1 |
| | | | | | imidazolyl | | | | | |
| 336 | Et | H | Br | H | CF₃ | H | NMe | CH | N | 0 |
| 337 | Et | H | Br | H | CF₃ | H | NMe | CH | N | 1 |
| 338 | Et | H | CN | H | CF₃ | H | NMe | CH | N | 0 |
| 339 | Et | H | CN | H | CF₃ | H | NMe | CH | N | 1 |
| 340 | Et | H | CN | H | CF₃ | H | NMe | CH | N | 2 |
| 341 | Et | H | CF₂CF₃ | H | CF₃ | H | NMe | CH | N | 1 |
| 342 | Et | H | CHO | H | CF₃ | H | NMe | CH | N | 0 |
| 343 | Et | H | Ph | H | CF₃ | H | NMe | CH | N | 0 |
| 344 | Et | H | H | H | SMe | H | NMe | CH | N | 0 |
| 345 | Et | H | H | H | SO₂Me | H | NMe | CH | N | 2 |
| 346 | Et | H | H | H | SEt | H | NMe | CH | N | 0 |
| 347 | Et | H | H | H | SO₂Et | H | NMe | CH | N | 2 |
| 348 | Et | H | H | H | SiPr | H | NMe | CH | N | 0 |
| 349 | Et | H | H | H | SO₂iPr | H | NMe | CH | N | 2 |
| 350 | Et | H | H | H | SCH₂CF₃ | H | NMe | CH | N | 0 |
| 351 | Et | H | H | H | SO₂CH₂CF₃ | H | NMe | CH | N | 2 |
| 352 | Et | H | H | H | SCH₂CH═CH₂ | H | NMe | CH | N | 0 |
| 353 | Et | H | H | H | SCF₂CF₃ | H | NMe | CH | N | 0 |
| 354 | Et | H | H | H | SCF₂CF₂CF₃ | H | NMe | CH | N | 0 |
| 355 | Et | H | H | H | SCF(CF₃)₂ | H | NMe | CH | N | 0 |
| 356 | Et | H | H | H | CH(OH)CF₃ | H | NMe | CH | N | 0 |
| 357 | Et | H | H | H | CH(Cl)CF₃ | H | NMe | CH | N | 0 |
| 358 | Et | H | H | H | OH | H | NMe | CH | N | 0 |
| 359 | Et | H | H | H | OH | H | NMe | CH | N | 2 |
| 360 | Et | H | H | H | OCF₂Br | H | NMe | CH | N | 2 |
| 361 | Et | H | H | H | OCF₃ | H | NMe | CH | N | 2 |
| 362 | Et | H | H | H | SCF₂CF₃ | H | NMe | CH | N | 1 |
| 363 | Et | H | H | H | SCF₂CF₂CF₃ | H | NMe | CH | N | 1 |
| 364 | Et | H | H | H | SCF₂CF₂CF₃ | H | NMe | CH | N | 2 |
| 365 | Et | H | H | H | StBu | H | NMe | CH | N | 0 |
| 366 | Et | H | H | H | SO₂tBu | H | NMe | CH | N | 2 |
| 367 | Et | H | CF₃ | H | Br | H | NMe | CH | N | 0 |
| 368 | Et | H | CF₃ | H | Br | H | NMe | CH | N | 1 |
| 369 | Et | H | CF₃ | H | Br | H | NMe | CH | N | 2 |
| 370 | Et | H | H | H | SCH═C═CH₂ | H | NMe | CH | N | 0 |
| 371 | Et | H | H | H | SO₂CH═C═CH₂ | H | NMe | CH | N | 2 |
| 372 | Et | H | H | H | SO₂CH₂CH═CH₂ | H | NMe | CH | N | 2 |
| 373 | Et | H | I | H | CF₂CF₃ | H | NMe | CH | N | 2 |
| 374 | Et | H | NO₂ | H | CF₃ | H | NMe | CH | N | 0 |
| 375 | Et | H | NO₂ | H | CF₃ | H | NMe | CH | N | 1 |
| 376 | Et | H | NO₂ | H | CF₃ | H | NMe | CH | N | 2 |
| 377 | Et | H | I | H | SCF₃ | H | NMe | CH | N | 2 |
| 378 | Et | H | I | H | SO₂CF₃ | H | NMe | CH | N | 2 |
| 379 | Et | H | Br | H | CF₂CF₃ | H | NMe | CH | N | 2 |
| 380 | Et | H | Cl | H | CF₃ | H | S | CH | N | 0 |
| 381 | Et | H | Cl | H | CF₃ | H | S | CH | N | 2 |
| 382 | Et | H | H | H | C(OH)(CF₃)₂ | H | NMe | CH | N | 0 |
| 383 | Et | H | H | H | C(Cl)(CF₃)₂ | H | NMe | CH | N | 0 |
| 384 | Et | H | H | H | C(Cl)(CF₃)₂ | H | NMe | CH | N | 1 |
| 385 | Et | H | H | H | C(Cl)(CF₃)₂ | H | NMe | CH | N | 2 |
| 386 | Et | H | Cl | H | CF₂CF₃ | H | NMe | CH | N | 2 |
| 387 | Et | H | H | H | H | CF(CF₃)₂ | NMe | CH | CH | 0 |
| 388 | Et | H | H | H | CF(CF₃)₂ | H | NMe | CH | CH | 0 |
| 389 | Et | H | CF₃ | H | I | H | NMe | CH | N | 2 |
| 390 | Et | H | H | H | CF₂CF₃ | H | NMe | CH | CH | 1 |
| 391 | Et | H | H | H | SF₅ | H | NMe | CH | CH | 1 |
| 392 | Et | H | CF₃ | H | SF₅ | H | NMe | CH | CH | 0 |
| 393 | Et | H | CF₃ | H | SF₅ | H | NMe | CH | CH | 1 |
| 394 | Et | H | Me | H | CF₂CF₃ | H | NMe | CH | N | 0 |
| 395 | Et | H | Me | H | CF₂CF₃ | H | NMe | CH | N | 1 |
| 396 | Et | H | Me | H | CF₂CF₃ | H | NMe | CH | N | 2 |
| 397 | Et | H | H | H | I | H | S | CH | N | 0 |
| 398 | Et | H | CF₃ | H | I | H | S | CH | N | 0 |
| 399 | Et | H | H | H | CF₂CF₃ | H | S | CH | N | 0 |
| 400 | Et | H | CF₃ | H | CF₂CF₃ | H | S | CH | N | 0 |
| 401 | Et | H | H | H | CF₂CF₃ | H | S | CH | N | 2 |
| 402 | Et | H | CF₃ | H | CF₂CF₃ | H | S | CH | N | 2 |
| 403 | Et | H | H | H | H | CF₃ | S | N | CH | 0 |
| 404 | Et | H | H | H | H | CF₃ | S | N | CH | 2 |
| 405 | Et | H | CH═CH₂ | H | CF₃ | H | NMe | CH | N | 2 |
| 406 | Et | H | Et | H | CF₃ | H | NMe | CH | N | 2 |
| 407 | Et | H | H | H | SO₂NMe₂ | H | NMe | CH | N | 1 |
| 408 | Et | H | H | H | SO₂NMe₂ | H | NMe | CH | N | 2 |
| 409 | Et | H | H | H | CF₃ | H | NMe | CH | CNH₂ | 0 |
| 410 | Et | H | Br | H | SCF₃ | H | NMe | CH | N | 2 |
| 411 | Et | H | H | H | CF₃ | H | NMe | CH | CNMe₂ | 0 |
| 412 | Et | H | CF₃ | H | CF₃ | H | NMe | CH | CNH₂ | 0 |
| 413 | Et | H | CF₃ | H | CF₃ | H | NMe | CH | CNMe₂ | 0 |
| 414 | Et | H | SF₅ | H | CF₃ | H | NMe | CH | N | 0 |
| 415 | Et | H | SF₅ | H | CF₃ | H | NMe | CH | N | 1 |
| 416 | Et | H | SF₅ | H | CF₃ | H | NMe | CH | N | 2 |
| 417 | Et | H | H | H | CF(CF₃)₂ | H | NH | CH | CH | 0 |
| 418 | Et | H | H | H | Br | H | NMe | CCF₂H | N | 0 |
| 419 | Et | H | H | H | Br | H | NMe | CCF₂H | N | 1 |
| 420 | Et | H | H | H | Br | H | NMe | CCF₂H | N | 2 |
| 421 | Et | H | H | H | Br | H | NMe | CiPr | N | 0 |
| 422 | Et | H | H | H | CF₃ | H | NH | CH | N | 1 |
| 423 | Et | H | H | H | CF₃ | H | NH | CH | CH | 0 |
| 424 | Et | H | CF₃ | H | CF₃ | H | NEt | CH | N | 2 |
| 425 | Et | H | CF₃ | H | CF₃ | H | NCH₂CH═CH₂ | CH | N | 2 |
| 426 | Et | H | CF₃ | H | CF₃ | H | NCH₂CN | CH | N | 2 |
| 427 | Et | H | CF₃ | H | H | CF₃ | NCH₂CN | N | CH | 2 |
| 428 | Et | H | CF₃ | H | CF₃ | H | NCH₂OEt | CH | N | 2 |
| 429 | Et | H | CF₃ | H | H | CF₃ | NCH₂OEt | N | CH | 2 |
| 430 | Et | H | CF₃ | H | CF₃ | H | NCH₂SMe | CH | N | 2 |
| 431 | Et | H | CF₃ | H | CF₃ | H | NPr | CH | N | 2 |
| 432 | Et | H | CF₃ | H | CF₃ | H | N(CH₂)₃CH₃ | CH | N | 2 |
| 433 | Et | H | CF₃ | H | CF₃ | H | NCH₂CO₂Me | CH | N | 2 |
| 434 | Et | H | CF₃ | H | H | CF₃ | NCH₂CO₂Me | N | CH | 2 |
| 435 | Et | H | CF₃ | H | CF₃ | H | NCH₂CH═CCl₂ | CH | N | 2 |
| 436 | Et | H | CF₃ | H | CF₃ | H | NCO₂tBu | CH | N | 2 |
| 437 | Et | H | CF₃ | H | CF₃ | H | NCO₂Me | CH | N | 2 |
| 438 | Et | H | CF₃ | H | CF₃ | H | NCOMe | CH | N | 2 |
| 439 | Et | H | OCF₃ | H | CF₃ | H | NMe | CH | N | 0 |
| 440 | Et | H | OCF₃ | H | CF₃ | H | NMe | CH | N | 1 |
| 441 | Et | H | CF₂CF₂CF₂CF₃ | H | CF₃ | H | NMe | CH | N | 2 |
| 442 | Et | H | NH₂ | H | CF₃ | H | NMe | CH | N | 2 |
| 443 | Et | H | NHCOCF₃ | H | CF₃ | H | NMe | CH | N | 2 |
| 444 | Et | H | iPr | H | CF₃ | H | NMe | CH | N | 2 |
| 445 | Et | H | CHO | H | CF₃ | H | NMe | CH | N | 2 |
| 446 | CH₂CH₂CH₂CH₃ | H | H | H | CF₃ | H | NMe | CH | N | 0 |
| 447 | CH₂CO₂Me | H | H | H | CF₃ | H | NMe | CH | N | 0 |
| 448 | CH₂CH═CCl₂ | H | H | H | CF₃ | H | NMe | CH | N | 0 |
| 449 | CH₂C≡CCH₃ | H | H | H | CF₃ | H | NMe | CH | N | 0 |
| 450 | CH₂CN | H | H | H | CF₃ | H | NMe | CH | N | 0 |
| 451 | CH₂tBu | H | H | H | CF₃ | H | NMe | CH | N | 0 |
| 452 | CH₂CH₂CN | H | H | H | CF₃ | H | NMe | CH | N | 0 |
| 453 | CH₂CycBu | H | H | H | CF₃ | H | NMe | CH | N | 0 |
| 454 | CF₂Br | H | H | H | CF₃ | H | NMe | CH | N | 0 |
| 455 | Et | H | CF₂H | H | CF₃ | H | NMe | CH | N | 2 |
| 456 | Et | H | CH₂OH | H | CF₃ | H | NMe | CH | N | 2 |
| 457 | (CH₂)₃CH₃ | H | H | H | CF₃ | H | NMe | CH | N | 2 |
| 458 | CH₂CO₂Me | H | H | H | CF₃ | H | NMe | CH | N | 2 |
| 459 | CH₂CH═CCl₂ | H | H | H | CF₃ | H | NMe | CH | N | 2 |
| 460 | CH₂C≡CCH₃ | H | H | H | CF₃ | H | NMe | CH | N | 2 |
| 461 | CH₂CN | H | H | H | CF₃ | H | NMe | CH | N | 2 |
| 462 | CH₂tBu | H | H | H | CF₃ | H | NMe | CH | N | 2 |
| 463 | CH₂CH₂CN | H | H | H | CF₃ | H | NMe | CH | N | 2 |
| 464 | CH₂CycBu | H | H | H | CF₃ | H | NMe | CH | N | 2 |
| 465 | CF₂Br | H | H | H | CF₃ | H | NMe | CH | N | 2 |
| 466 | Et | H | CH₂F | H | CF₃ | H | NMe | CH | N | 2 |
| 467 | CH═CH₂ | H | H | H | CF₃ | H | NMe | CH | N | 0 |
| 468 | CH═CH₂ | H | H | H | CF₃ | H | NMe | CH | N | 1 |
| 469 | CH═CH₂ | H | H | H | CF₃ | H | NMe | CH | N | 2 |
| 470 | Et | H | H | H | H | CF₃ | S | CH | N | 0 |
| 471 | Et | H | H | H | H | CF₃ | S | CH | N | 2 |
| 472 | Et | H | OCF₃ | H | CF₂CF₃ | H | NMe | CH | N | 0 |
| 473 | Et | H | OCF₃ | H | CF₂CF₃ | H | NMe | CH | N | 1 |
| 474 | Et | H | OCF₃ | H | CF₂CF₃ | H | NMe | CH | N | 2 |
| 475 | Et | H | CF₃ | H | CF₃ | H | NMe | CH | CMe | 0 |
| 476 | Et | H | CF₃ | H | CF₃ | H | NMe | CH | CMe | 1 |
| 477 | Et | H | CF₃ | H | CF₃ | H | NMe | CH | CF | 0 |
| 478 | Et | H | CF₃ | H | CF₃ | H | NMe | CH | CF | 1 |
| 479 | CH₂CycPr | H | H | H | CF₃ | H | NMe | CH | N | 0 |
| 480 | CH₂CycPr | H | H | H | CF₃ | H | NMe | CH | N | 1 |
| 481 | Et | H | CF₃ | H | CF₃ | H | NMe | CH | CBr | 0 |
| 482 | Et | H | CF₃ | H | CF₃ | H | NMe | CH | CSCH₂CH₃ | 0 |
| 483 | CH₂C≡CH | H | H | H | CF₃ | H | NMe | CH | N | 0 |
| 484 | CH₂C≡CH | H | H | H | CF₃ | H | NMe | CH | N | 2 |
| 485 | Et | H | C≡CH | H | CF₃ | H | NMe | CH | N | 2 |
| 486 | Et | H | 4-trifluoromethyl- | H | CF₃ | H | NMe | CH | N | 2 |
| | | | 2-pyridyl | | | | | | | |
| 487 | Et | H | OCF₃ | H | SCF₃ | H | NMe | CH | N | 0 |
| 488 | Et | H | OCF₃ | H | SCF₃ | H | NMe | CH | N | 1 |
| 489 | Et | H | OCF₃ | H | SCF₃ | H | NMe | CH | N | 2 |
| 490 | Et | H | CF₃ | H | CF₃ | H | NMe | CH | CBr | 1 |
| 491 | Et | H | CF₃ | H | CF₃ | H | NMe | CH | CBr | 2 |
| 492 | Et | H | H | H | 2-pyridyl | H | NMe | CH | N | 0 |
| 493 | Et | H | H | H | 2-pyridyl | H | NMe | CH | N | 2 |
| 494 | Et | H | H | H | 2-furyl | H | NMe | CH | N | 0 |
| 495 | Et | H | H | H | 2-furyl | H | NMe | CH | N | 2 |
| 496 | Et | H | H | H | 2-thienyl | H | NMe | CH | N | 0 |
| 497 | Et | H | H | H | 2-thienyl | H | NMe | CH | N | 2 |
| 498 | Et | H | H | H | CH═CH₂ | H | NMe | CH | N | 0 |
| 499 | Et | H | H | H | CH═CH₂ | H | NMe | CH | N | 2 |
| 500 | Et | H | H | H | COMe | H | NMe | CH | N | 0 |
| 501 | Et | H | H | H | COMe | H | NMe | CH | N | 2 |
| 502 | Et | H | H | H | CH₂CH═CH₂ | H | NMe | CH | N | 0 |
| 503 | Et | H | H | H | CF₃ | H | N-(6- | CH | N | 2 |
| | | | | | | | Chloro- | | | |
| | | | | | | | pyridin-3- | | | |
| | | | | | | | ylmethyl) | | | |
| 504 | Et | H | CF₃ | H | CF₃ | H | N-(6- | CH | N | 2 |
| | | | | | | | Chloro- | | | |
| | | | | | | | pyridin-3- | | | |
| | | | | | | | ylmethyl) | | | |
| 505 | Et | H | H | H | CF₃ | H | N-(2- | CH | N | 2 |
| | | | | | | | Chloro- | | | |
| | | | | | | | thiazol-5- | | | |
| | | | | | | | ylmethyl) | | | |
| 506 | Et | H | CF₃ | H | CF₃ | H | N-(2- | CH | N | 2 |
| | | | | | | | Chloro- | | | |
| | | | | | | | thiazol-5- | | | |
| | | | | | | | ylmethyl) | | | |
| 507 | Et | H | H | H | CF₃ | CN | NMe | CH | N | 2 |
| 508 | Et | H | CF₃ | H | CF₃ | CN | NMe | CH | N | 2 |
| 509 | Et | H | H | H | CF₃ | H | N-(2- | CH | N | 0 |
| | | | | | | | Chloro- | | | |
| | | | | | | | thiazol-5- | | | |
| | | | | | | | ylmethyl) | | | |
| 510 | Et | H | CF₃ | H | CF₃ | H | N-(2- | CH | N | 0 |
| | | | | | | | Chloro- | | | |
| | | | | | | | thiazol-5- | | | |
| | | | | | | | ylmethyl) | | | |
| 511* | Et | H | H | H | CF₃ | H | NMe | CH | N | 2 |
| 512* | Et | H | CF₃ | H | CF₃ | H | NMe | CH | N | 2 |
| 513 | Et | H | H | H | CF₃ | H | NMe | CH | COMe | 0 |
| 514 | Et | H | H | H | CF₃ | H | NMe | CH | CSMe | 0 |
| 515 | Et | H | H | H | CF₃ | H | NMe | CH | CSO₂Me | 2 |
| 516 | Et | H | H | H | CF₃ | H | NMe | CH | CSPh | 0 |
| 517 | Et | H | H | H | CF₃ | H | NMe | CH | CSO₂Ph | 2 |
| 518 | Et | H | H | H | CF₃ | H | NMe | CH | CSO₂CH₂CF₃ | 2 |
| 519 | Et | H | H | H | CF₃ | H | NMe | CH | CCN | 0 |
| 520 | Et | H | CF₃ | H | CF₃ | H | NMe | CNMe₂ | N | 2 |
| 521 | Et | H | CF₃ | H | CF₃ | CO₂H | NMe | CH | N | 2 |
| 522 | Et | H | CF₃ | H | CF₃ | CONH₂ | NMe | CH | N | 2 |
| 523* | Et | H | CF₃ | H | CF₂CF₃ | H | NMe | CH | N | 2 |
| 524* | Et | H | CF₃ | H | CF₂CF₃ | H | NMe | CH | N | 2 |
| 525 | Et | H | CF₃ | H | CO₂H | H | NMe | CH | N | 0 |
| 526 | Et | H | H | H | CF₃ | H | NMe | CH | CCN | 1 |
| 527 | Et | H | H | H | CF₃ | H | NH | CH | CCF₃ | 0 |
| 528 | Et | H | C(OMe)₃ | H | CF₂CF₃ | H | NMe | CH | N | 2 |
| 529 | Et | H | H | H | H | CF₃ | NMe | CCF₃ | CH | 0 |
| 530 | Et | H | H | H | H | CF₃ | NMe | CCF₃ | CH | 2 |
| 531 | Et | H | H | H | CF₃ | H | NMe | CH | CCF₃ | 2 |
| 532 | Me | H | CF₃ | H | CF₂CF₃ | H | NMe | CH | N | 0 |
| 533 | Me | H | CF₃ | H | CF₂CF₃ | H | NMe | CH | N | 2 |
| 534 | Pr | H | CF₃ | H | CF₂CF₃ | H | NMe | CH | N | 0 |
| 535 | Pr | H | CF₃ | H | CF₂CF₃ | H | NMe | CH | N | 2 |
| 536 | iPr | H | CF₃ | H | CF₂CF₃ | H | NMe | CH | N | 0 |
| 537 | iPr | H | CF₃ | H | CF₂CF₃ | H | NMe | CH | N | 2 |
| 538 | Bu | H | CF₃ | H | CF₂CF₃ | H | NMe | CH | N | 0 |
| 539 | Bu | H | CF₃ | H | CF₂CF₃ | H | NMe | CH | N | 2 |
| 540 | CH(CH₃)CH₂CH₃ | H | CF₃ | H | CF₂CF₃ | H | NMe | CH | N | 0 |
| 541 | CH(CH₃)CH₂CH₃ | H | CF₃ | H | CF₂CF₃ | H | NMe | CH | N | 2 |
| 542 | CH₂CH(CH₃)₂ | H | CF₃ | H | CF₂CF₃ | H | NMe | CH | N | 0 |
| 543 | CH₂CH(CH₃)₂ | H | CF₃ | H | CF₂CF₃ | H | NMe | CH | N | 2 |
| 544 | tBu | H | CF₃ | H | CF₂CF₃ | H | NMe | CH | N | 0 |
| 545 | tBu | H | CF₃ | H | CF₂CF₃ | H | NMe | CH | N | 2 |
| 546 | CycPen | H | CF₃ | H | CF₂CF₃ | H | NMe | CH | N | 0 |
| 547 | CycPen | H | CF₃ | H | CF₂CF₃ | H | NMe | CH | N | 2 |
| 548 | CycHex | H | CF₃ | H | CF₂CF₃ | H | NMe | CH | N | 0 |
| 549 | CycHex | H | CF₃ | H | CF₂CF₃ | H | NMe | CH | N | 2 |
| 550 | CH₂CF₃ | H | CF₃ | H | CF₂CF₃ | H | NMe | CH | N | 0 |
| 551 | CH₂CF₃ | H | CF₃ | H | CF₂CF₃ | H | NMe | CH | N | 2 |
| 552 | Et | H | CF₃ | H | CN | H | NMe | CH | N | 0 |
| 553 | Et | H | H | H | CF₃ | H | NMe | CH | CCF₃ | 0 |
| 554 | Et | H | CF₃ | H | CF₂CF₃ | H | N-(4- | CH | N | 0 |
| | | | | | | | methoxy- | | | |
| | | | | | | | benzyl) | | | |
| 555 | Et | H | CF₃ | H | H | CF₂CF₃ | N-(4- | N | CH | 0 |
| | | | | | | | methoxy- | | | |
| | | | | | | | benzyl) | | | |

In the above [Table 1], the symbol “*” in the present compound represents N-oxide. Specifically, the following compounds are mentioned.

### The Present Compound 22

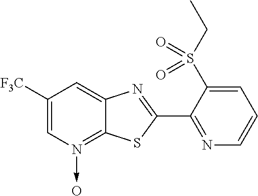

### The Present Compound 36

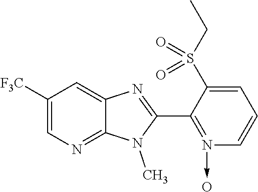

### The Present Compound 37

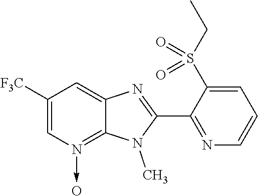

### The Present Compound 47

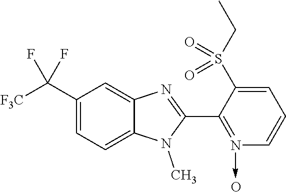

### The Present Compound 48

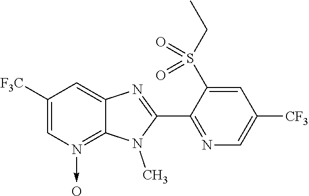

### The Present Compound 51

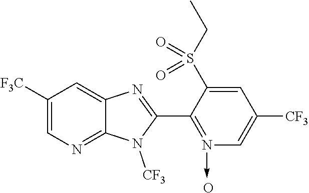

### The Present Compound 70

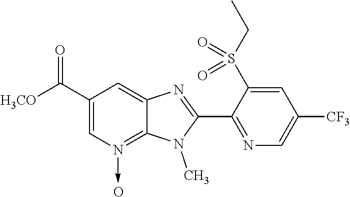

### The Present Compound 511

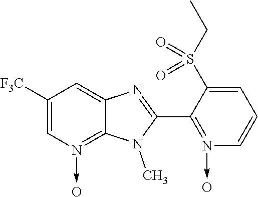

### The Present Compound 512

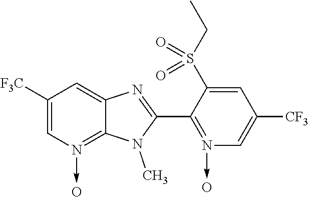

### The Present Compound 523

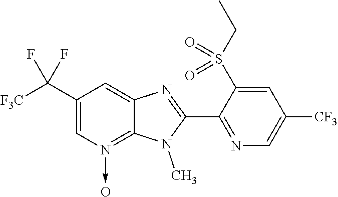

### The Present Compound 524

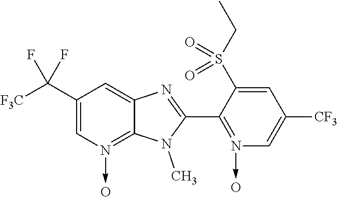

In the above [Table 1], “Me” represents a methyl group, “Et” represents an ethyl group, “Pr” represents a propyl group, “iPr” represents an isopropyl group, “Bu” represents a butyl group, “tBu” represents a tert-butyl group, “CycPr” represents a cyclopropyl group, “CycBu” represents a cyclobutyl group, “CycPen” represents a cyclopentyl group, “CycHex” represents a cyclohexyl group, “Ph” represents a phenyl group, “2-CF₃-Ph” represents a 2-trifluoromethylphenyl group, “3-CF₃-Ph” represents a 3-trifluoromethylphenyl group, “4-CF₃-Ph” represents a 4-trifluoromethylphenyl group, “3-CF₃-triazolyl” represents a 3-trifluoromethyl-(1H-1,2,4-triazol)-1-yl group, “3-CF₃-5-Me-triazolyl” represents a 3-trifluoromethyl-5-methyl-(1H-1,2,4-triazol)-1-yl group, and “4-CF₃-imidazolyl” represents a 4-trifluoromethylimidazole-1-yl group.

A compound represented by the formula (2):

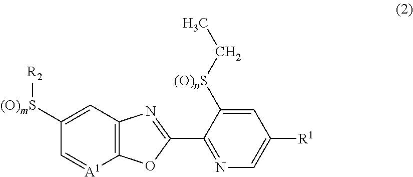

wherein A¹, R¹, R², n and m are any of the combinations as listed in [Table 2].

TABLE 2

| The | | | | | |
|---|---|---|---|---|---|
| present | | | | | |
| compound | A¹ | R¹ | R² | n | m |
| 556 | N | H | CF₃ | 0 | 0 |
| 557 | N | H | CF₃ | 1 | 0 |
| 558 | N | H | CF₃ | 2 | 0 |
| 559 | N | H | CF₃ | 2 | 1 |
| 560 | N | H | CF₃ | 2 | 2 |
| 561 | CH | H | CF₃ | 0 | 0 |
| 562 | CH | H | CF₃ | 1 | 0 |
| 563 | CH | H | CF₃ | 2 | 0 |
| 564 | CH | H | CF₃ | 2 | 1 |
| 565 | CH | H | CF₃ | 2 | 2 |
| 566 | N | CF₃ | CF₃ | 0 | 0 |
| 567 | N | CF₃ | CF₃ | 1 | 0 |
| 568 | N | CF₃ | CF₃ | 2 | 0 |
| 569 | N | CF₃ | CF₃ | 2 | 1 |
| 570 | N | CF₃ | CF₃ | 2 | 2 |
| 571 | CH | CF₃ | CF₃ | 0 | 0 |
| 572 | CH | CF₃ | CF₃ | 1 | 0 |
| 573 | CH | CF₃ | CF₃ | 2 | 0 |
| 574 | CH | CF₃ | CF₃ | 2 | 1 |
| 575 | CH | CF₃ | CF₃ | 2 | 2 |
| 576 | N | Cl | CF₃ | 0 | 0 |
| 577 | N | Cl | CF₃ | 1 | 0 |
| 578 | N | Cl | CF₃ | 2 | 0 |
| 579 | N | Cl | CF₃ | 2 | 1 |
| 580 | N | Cl | CF₃ | 2 | 2 |
| 581 | CH | Cl | CF₃ | 0 | 0 |
| 582 | CH | Cl | CF₃ | 1 | 0 |
| 583 | CH | Cl | CF₃ | 2 | 0 |
| 584 | CH | Cl | CF₃ | 2 | 1 |
| 585 | CH | Cl | CF₃ | 2 | 2 |
| 586 | N | Br | CF₃ | 0 | 0 |
| 587 | N | Br | CF₃ | 1 | 0 |
| 588 | N | Br | CF₃ | 2 | 0 |
| 589 | N | Br | CF₃ | 2 | 1 |
| 590 | N | Br | CF₃ | 2 | 2 |
| 591 | CH | Br | CF₃ | 0 | 0 |
| 592 | CH | Br | CF₃ | 1 | 0 |
| 593 | CH | Br | CF₃ | 2 | 0 |
| 594 | CH | Br | CF₃ | 2 | 1 |
| 595 | CH | Br | CF₃ | 2 | 2 |
| 596 | N | H | CF₂CF₃ | 0 | 0 |
| 597 | N | H | CF₂CF₃ | 1 | 0 |
| 598 | N | H | CF₂CF₃ | 2 | 0 |
| 599 | N | H | CF₂CF₃ | 2 | 1 |
| 600 | N | H | CF₂CF₃ | 2 | 2 |
| 601 | CH | H | CF₂CF₃ | 0 | 0 |
| 602 | CH | H | CF₂CF₃ | 1 | 0 |
| 603 | CH | H | CF₂CF₃ | 2 | 0 |
| 604 | CH | H | CF₂CF₃ | 2 | 1 |
| 605 | CH | H | CF₂CF₃ | 2 | 2 |
| 606 | N | CF₃ | CF₂CF₃ | 0 | 0 |
| 607 | N | CF₃ | CF₂CF₃ | 1 | 0 |
| 608 | N | CF₃ | CF₂CF₃ | 2 | 0 |
| 609 | N | CF₃ | CF₂CF₃ | 2 | 1 |
| 610 | N | CF₃ | CF₂CF₃ | 2 | 2 |
| 611 | CH | CF₃ | CF₂CF₃ | 0 | 0 |
| 612 | CH | CF₃ | CF₂CF₃ | 1 | 0 |
| 613 | CH | CF₃ | CF₂CF₃ | 2 | 0 |
| 614 | CH | CF₃ | CF₂CF₃ | 2 | 1 |
| 615 | CH | CF₃ | CF₂CF₃ | 2 | 2 |
| 616 | N | H | CF₃ | 0 | 1 |
| 617 | N | H | CF₃ | 0 | 2 |
| 618 | CH | H | CF₃ | 0 | 1 |
| 619 | CH | H | CF₃ | 0 | 2 |
| 620 | N | CF₃ | CF₃ | 0 | 1 |
| 621 | N | CF₃ | CF₃ | 0 | 2 |
| 622 | CH | CF₃ | CF₃ | 0 | 1 |
| 623 | CH | CF₃ | CF₃ | 0 | 2 |

A compound represented by the formula (2A):

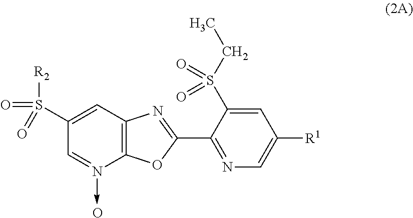

wherein R¹ and R² are any of the combinations as listed in [Table 3].

TABLE 3

| The | | |
|---|---|---|
| present | | |
| compound | R¹ | R² |
| 624 | H | CF₃ |
| 625 | CF₃ | CF₃ |
| 626 | Cl | CF₃ |
| 627 | Br | CF₃ |
| 628 | H | CF₂CF₃ |
| 629 | CF₃ | CF₂CF₃ |

A compound represented by the formula (2B):

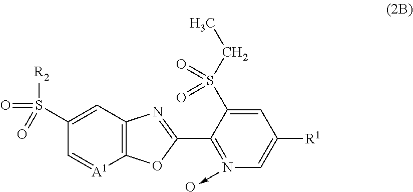

wherein A¹, R¹ and R² are any of the combinations as listed in [Table 4].

TABLE 4

| The | | | |
|---|---|---|---|
| present | | | |
| compound | A¹ | R¹ | R² |
| 630 | N | H | CF₃ |
| 631 | CH | H | CF₃ |
| 632 | N | CF₃ | CF₃ |
| 633 | CH | CF₃ | CF₃ |
| 634 | N | Cl | CF₃ |
| 635 | CH | Cl | CF₃ |
| 636 | N | Br | CF₃ |
| 637 | CH | Br | CF₃ |
| 638 | N | H | CF₂CF₃ |
| 639 | CH | H | CF₂CF₃ |
| 640 | N | CF₃ | CF₂CF₃ |
| 641 | CH | CF₃ | CF₂CF₃ |

A compound represented by the formula (2C):

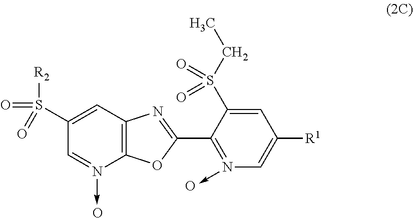

wherein R¹ and R² are any of the combinations as listed in [Table 5].

TABLE 5

| [symbol] | R¹ | R² |
|---|---|---|
| 642 | H | CF₃ |
| 643 | CF₃ | CF₃ |
| 644 | Cl | CF₃ |
| 645 | Br | CF₃ |
| 646 | H | CF₂CF₃ |
| 647 | CF₃ | CF₂CF₃ |

In the above Table 2 to Table 5, Me represents a methyl group, Et represents an ethyl group, Pr represents a propyl group, iPr represents an isopropyl group, tBu represents a tert-butyl group, CyPr represents a cyclopropyl group, CyBu represents a cyclobutyl group, 2-F-Ph represents a 2-fluorophenyl group, 3-F-Ph represents a 3-fluorophenyl group, 4-F-Ph represents a 4-fluorophenyl group, 2-CF₃-Ph represents a 2-trifluoromethylphenyl group, 3-CF₃-Ph represents a 3-trifluoromethylphenyl group, 4-CF₃-Ph represents a 4-trifluoromethylphenyl group, 2-Cl-Ph represents a 2-chlorophenyl group, 3-Cl-Ph represents a 3-chlorophenyl group, 4-Cl-Ph represents a 4-chlorophenyl group, 2-NO₂-Ph represents a 2-nitrophenyl group, 3-NO₂-Ph represents a 3-nitrophenyl group, 2-CN-Ph represents a 2-cyanophenyl group, 3-CN-Ph represents a 3-cyanophenyl group, 4-CN-Ph represents a 4-cyanophenyl group, 3-Py represents a pyridin-3-yl group, 4-Py represents a pyridin-4-yl group, 6-C1-3-Py represents a 6-chloropyridin-3-yl group, 5-F-3-Py represents a 5-fluoropyridin-3-yl group, 4-C1-pyrazole represents a 4-chloropyrazol-1-yl group, 3-C1-triazole represents a 3-chloro-(1H-1,2,4-triazole)-1-yl group, 3-CF₃-triazole represents a 3-trifluoromethyl-1H-1,2,4-triazol-1-yl group, 3-CF₃-5-Me-triazole represents a 3-trifluoromethyl-5-methyl-1H-1,2,4-triazol-1-yl group, 4-CF₃-imidazole represents a 4-trifluoromethylimidazol-1-yl group, and 4-CF₃-2-Py represents 4-trifluoromethylpyridin-2-yl.

The inventive composition may be obtained by simply mixing the present compound and one or more compounds selected from Group A to Group E; however, the inventive composition is generally obtained by mixing the present compound and one or more compounds selected from Group A to Group E, and adding to the resulting mixture a solid carrier, a liquid carrier, a gaseous carrier, a surfactant, or the like, as well as adjuvants for formulation such as a binder, a dispersant, and a stabilizer as necessary, and processing the mixture into formulations such as a wettable powder, a wettable granule, a flowable formulation, a granule, a dry flowable formulation, an emulsion, an aqueous liquid, an oil, a smoking agent, an aerosol, and a microcapsule. These formulations contain the present compound and one or more compounds selected from Group A to Group E in a total weight ratio of usually 0.1 to 99% and preferably 0.2 to 90%.

The content ratio of the present compound and the one or more compounds selected from Group A to Group E in the inventive composition is not particularly limited, but the amount of the one or more compounds selected from Group A to Group E is usually 1 to 100,000 parts by weight and preferably to 10,000 parts by weight per 1,000 parts by weight of the present compound. In other words, the content ratio of the present compound and the one or more compounds selected from Group A to Group E is usually 1000:1 to 1:100 and preferably 100:1 to 1:10 in weight ratio.

Examples of the solid carrier include fine powders and granules of clays (such as kaolin, diatomaceous earth, synthetic hydrated silicon oxide, Fubasami clay, bentonite, and acid clay), talcs, other inorganic minerals (such as sericite, quartz powder, sulfur powder, activated carbon, calcium carbonate, and hydrated silica), and the like. Examples of the liquid carrier include water, alcohols (such as methanol and ethanol), ketones (such as acetone and methyl ethyl ketone), aromatic hydrocarbons (such as benzene, toluene, xylene, ethylbenzene, and methylnaphthalene), aliphatic hydrocarbons (such as n-hexane, cyclohexanone, and kerosene), esters (such as ethyl acetate and butyl acetate), nitriles (such as acetonitrile and isobutylnitrile), ethers (such as dioxane and diisopropyl ether), acid amides (such as dimethylformamide and dimethylacetamide), and halogenated hydrocarbons (such as dichloroethane, trichloroethylene, and carbon tetrachloride).

Examples of the surfactant include alkyl sulfates, alkyl sulfonates, alkyl aryl sulfonates, alkyl aryl ethers and polyoxyethylenated substances thereof, polyoxyethylene glycol ethers, polyhydric alcohol esters, and sugar alcohol derivatives.

Examples of the other adjuvants for formulation include binders and dispersants, and particularly for example, casein, gelatin, polysaccharides (such as starch, gum arabic, cellulose derivatives, and alginic acid), lignin derivatives, bentonite, sugars, synthetic water-soluble polymers (such as polyvinyl alcohol, polyvinylpyrrolidone, and polyacrylic acids), PAP (acidic isopropyl phosphate), BHT (2,6-di-tert-butyl-4-methylphenol), BHA (a mixture of 2-tert-butyl-4-methoxyphenol and 3-tert-butyl-4-methoxyphenol), vegetable oils, mineral oils, and fatty acids or esters thereof.

By applying an effective amount of the inventive composition to a plant or soil where the plant is cultivated, pests can be controlled. The effective amount of the inventive composition may be each effective amount of the present compounds and one or more compounds selected from Group A to Group E.

Examples of pests on which the inventive composition has an effect include noxious insects and noxious acarines. Specific examples of such pests include the following.

Hemiptera: Delphacidae such as Laodelphax striatellus, Nilaparvata lugens, and Sogatella furcifera; Deltocephalidae such as Nephotettix cincticeps, Nephotettix virescens, and Empoasca onukii; Aphididae such as Aphis gossypii, Myzus persicae, Brevicoryne brassicae, Aphis spiraecola, Macrosiphum euphorbiae, Aulacorthum solani, Rhopalosiphum padi, Toxoptera citricidus, and Hyalopterus pruni; Pentatomidae such as Nezara antennata, Eysarcoris parvus, and Halyomorpha mista; Alydidae such as Riptortus clavetus and Leptocorisa chinensis; Miridae such as Trigonotylus caelestialium and Stenotus rubrovittatus; Aleyrodidae such as Trialeurodes vaporariorum, Bemisia tabaci, Dialeurodes citri, and Aleurocanthus spiniferus; Coccidae such as Aonidiella aurantii, Comstockaspis perniciosa, Unaspis citri, Ceroplastes rubens, Icerya purchasi, Planococcus kraunhiae, Pseudococcus longispinis, and Pseudaulacaspis pentagona; Psyllidae such as Diaphorina citri, Psylla pyrisuga, and Bactericerca cockerelli; Tingidae such as Stephanitis nasi; and Cimices such as Cimex lectularius.

Lepidoptera: Pyralidae such as Chilo suppressalis, Tryporyza incertulas, Cnaphalocrocis medinalis, Notarcha derogata, Plodia interpunctella, Ostrinia furnacalis, Hellula undalis, and Pediasia teterrellus; Noctuidae such as Spodoptera litura, Spodoptera exigua, Pseudaletia separata, Mamestra brassicae, Agrotis ipsilon, Plusia nigrisigna, Thoricoplusia spp., Heliothis spp., and Helicoverpa spp.; Pieridae such as Pieris rapae; Tortricidae such as Adoxophyes spp., Grapholita molesta, Leguminivora glycinivorella, Matsumuraeses azukivora, Adoxophyes orana fasciata, Adoxophyes honmai., Homona magnanima, Archips fuscocupreanus, and Cydia pomonella; Gracillariidae such as Caloptilia theivora and Phyllonorycter ringoneella; Carposinidae such as Carposina niponensis; Lyonetiidae such as Lyonetia spp.; Lymantriidae such as Lymantria spp. and Euproctis spp; Yponomeutidae such as Plutella xylostella; Gelechiidae such as Pectinophora gossypiella and Phthorimaea operculella; and Arctiidae such as Hyphantria cunea.

Thysanoptera: Thripidae such as Frankliniella occidentalis, Thrips parmi, Scirtothrips dorsalis, Thrips tabaci, and Frankliniella intonsa.

Diptera: Anthomyiidae such as Delia platura and Delia antiqua; Agromyzidae such as Agromyza oryzae, Hydrellia griseola, Liriomyza sativae, Liriomyza trifolii, and Chromatomyia horticola; Chloropidae such as Chlorops oryzae; Tephritidae such as Dacus cucurbitae and Ceratitis capitata; Drosophilidae; Phoridae such as Megaselia spiracularis; Psychodidae such as Clogmia albipunctata; and Sciaridae.

Coleoptera: Chrysomelidae such as Diabrotica virgifera virgifera, Diabrotica undecimpunctata howardi, Oulema oryzae, Aulacophora femoralis, Phyllotreta striolata, and Leptinotarsa decemlineata; Scarabaeidae such as Anomala cuprea, Anomala rufocuprea, and Popillia japonica; rice weevils such as Sitophilus zeamais, Echinocnemus squameus, Lissorhoptrus oryzophilus, and Sphenophorus venatus; weevils such as Anthonomus grandis; Epilachna such as Epilachna vigintioctopunctata; Scolytidae such as Lyctus brunneus and Tomicus piniperda; Bostrychidae; Ptinidae; Cerambycidae such as Anoplophora malasiaca; Agriotes spp. such as Agriotes ogurae fuscicollis; and Staphylinidae such as Paederus fuscipes.

Orthoptera: Locusta migratoria, Gryllotalpa africana, Oxya yezoensis, Oxya japonica, and Gryllidae.

Hymenoptera: Tenthredinidae such as Athalia rosae and Athalia japonica.

Nematoda: Aphelenchoides besseyi, Nothotylenchus acris, Meloidogyne incognita, Meloidogyne hapla, Meloidogyne javanica, Heterodera glycines, Globodera rostochiensis, Pratylenchus coffeae, Pratylenchus neglectus, etc.

Isoptera: Reticulitermes speratus, Coptotermes formosanus, Incisitermes minor, Cryptotermes domesticus, Odontotermes formosanus, Neotermes koshunensis, Glyptotermes satsumensis, Glyptotermes nakajimai, Glyptotermes fuscus, Glyptotermes kodamai, Glyptotermes kushimensis, Hodotermopsis japonica, Coptotermes guangzhoensis, Reticulitermes miyatakei, Reticulitermes flaviceps amamianus, Reticulitermes sp., Nasutitermes takasagoensis, Pericapritermes nitobei, Sinocapritermes mushae, etc.

Acarina: Tetranychidae such as Tetranychus urticae, Tetranychus kanzawai, Panonychus citri, Panonychus ulmi, and Oligonychus spp.; Eriophyidae such as Aculops pelekassi, Phyllocoptruta citri, Aculops lycopersici, Calacarus carinatus, Acaphylla theavagrans, Eriophyes chibaensis, and Aculus schlechtendali; Tarsonemidae such as Polyphagotarsonemus latus; Tenuipalpidae such as Brevipalpus phoenicis; Acaridae such as Tyrophagus putrescentiae and Tyrophagus similis; Epidermoptidae such as Dermatophagoides farinae and Dermatophagoides ptrenyssnus; etc.

Chilopoda: Thereuonema hilgendorfi, Scolopendra subspinipes, etc.

Diplopoda: Oxidus gracilis, Nedyopus tambanus, etc.

Isopoda: Armadillidium vulgare, etc.

Gastropoda: Limax marginatus, Limax flavus, etc.

When the inventive composition is effective for preventing a plant disease, it can also be used for protecting a plant from a plant disease.

Examples of the plant diseases on which the inventive composition has exerts a control effect include the following diseases.

Diseases of rice: blast (Magnaporthe grisea), brown spot (Cochliobolus miyabeanus), sheath blight (Rhizoctonia solani), and bakanae disease (Gibberella fujikuroi).

Diseases of wheat: powdery mildew (Erysiphe graminis), Fusarium blight (Fusarium graminearum, F. avenacerum, F. culmorum, Microdochium nivale), rust (Puccinia striiformis, P. graminis, P. recondita), Fusarium snow blight (Micronectriella nivale), Typhula snow blight (Typhula sp.), loose smut (Ustilago tritici), bunt (Tilletia caries), eye spot (Pseudocercosporella herpotrichoides), leaf blotch (Mycosphaerella graminicola), glume blotch (Stagonospora nodorum), and yellow spot (Pyrenophora tritici-repentis).

Diseases of barley: powdery mildew (Erysiphe graminis), Fusarium blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), stripe (Pyrenophora graminea), and Rhizoctonia damping-off (Rhizoctonia solani).

Diseases of corn: smut (Ustilago maydis), leaf spot (Cochliobolus heterostrophus), copper spot (Gloeocercospora sorghi), southern rust (Puccinia polysora), gray leaf spot (Cercospora zeae-maydis), and Rhizoctonia damping-off (Rhizoctonia solani).

Diseases of citrus: melanose (Diaporthe citri), scab (Elsinoe fawcetti), penicillium rot (Penicillium digitatum, P. italicum), and brown rot (Phytophthora parasitica, Phytophthora citrophthora).

Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), bitter rot (Colletotrichum acutatum), and crown rot (Phytophtora cactorum).

Diseases of pear: scab (Venturia nashicola, V. pirina), black spot (Alternaria alternata Japanese pear pathotype), rust (Gymnosporangium haraeanum), and phytophthora fruit rot (Phytophtora cactorum).

Diseases of peach: brown rot (Monilinia fructicola), scab (Cladosporium carpophilum), and phomopsis rot (Phomopsis sp.).

Diseases of grape: anthracnose (Elsinoe ampelina), ripe rot (Glomerella cingulata), powdery mildew (Uncinula necator), rust (Phakopsora ampelopsidis), black rot (Guignardia bidwellii), and downy mildew (Plasmopara viticola).

Diseases of Japanese persimmon: anthracnose (Gloeosporium kaki), and leaf spot (Cercospora kaki, Mycosphaerella nawae).

Diseases of gourd: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp.).

Diseases of tomato: early blight (Alternaria solani), leaf mold (Cladosporium fulvum), and late blight (Phytophthora infestans).

Diseases of eggplant: brown spot (Phomopsis vexans), and powdery mildew (Erysiphe cichoracearum).

Diseases of Cruciferae vegetables: Alternaria leaf spot (Alternaria japonica), white spot (Cercosporella brassicae), clubroot (Plasmodiophora brassicae), and downy mildew (Peronospora parasitica).

Diseases of Welsh onion: rust (Puccinia allii) and downy mildew (Peronospora destructor).

Diseases of soybean: purple stain (Cercospora kikuchii), sphaceloma scad (Elsinoe glycines), pod and stem blight (Diaporthe phaseolorum var. sojae), septoria brown spot (Septoria glycines), Cercospora leaf spot (Cercospora sojina), rust (Phakopsora pachyrhizi), Phytophthora rot (Phytophthora sojae), Rhizoctonia damping-off (Rhizoctonia solani), Target spot (Corynespora cassiicola), and Sclerotinia rot (Sclerotinia sclerotiorum).

Diseases of kidney bean: anthracnose (Colletotrichum lindemthianum).

Diseases of peanut: leaf spot (Cercospora personata), brown leaf spot (Cercospora arachidicola) and southern blight (Sclerotium rolfsii).

Diseases of garden pea: powdery mildew (Erysiphe pisi).

Diseases of potato: early blight (Alternaria solani), late blight (Phytophthora infestans), pink rot (Phytophthora erythroseptica), and powdery scab (Spongospora subterranean f. sp. subterranea).

Diseases of strawberry: powdery mildew (Sphaerotheca humuli) and anthracnose (Glomerella cingulata).

Diseases of tea: net blister blight (Exobasidium reticulatum), white scab (Elsinoe leucospila), gray blight (Pestalotiopsis sp.), and anthracnose (Colletotrichum theae-sinensis).

Diseases of tobacco: brown spot (Alternaria longipes), powdery mildew (Erysiphe cichoracearum), anthracnose (Colletotrichum tabacum), downy mildew (Peronospora tabacina), and black shank (Phytophthora nicotianae).

Diseases of rapeseed: sclerotinia rot (Scierotinia sclerotiorum) and Rhizoctonia damping-off (Rhizoctonia solani).

Diseases of cotton: Rhizoctonia damping-off (Rhizoctonia solani), frosty mildew (Mycosphaerella areola), and Thielaviopsis black root rot disease (Thielaviopsis basicola).

Diseases of coffee: rust (Hemileia vastatrix).

Diseases of sugar cane: rust (Puccinia melanocephela and Puccinia kuehnii), and smut (Ustilago scitaminea).

Diseases of sunflower: rust (Puccinia helianthi).

Diseases of sugar beat: Cercospora leaf spot (Cercospora beticola), leaf blight (Thanatephorus cucumeris), root rot (Thanatephorus cucumeris), and Aphanomyces root rot (Aphanomyces cochlioides).

Diseases of rose: black spot (Diplocarpon rosae), powdery mildew (Sphaerotheca pannosa), and downy mildew (Peronospora sparsa).

Diseases of chrysanthemum and Compositae vegetables: downy mildew (Bremia lactucae), leaf blight (Septoria chrysanthemi-indici), and white rust (Puccinia horiana).

Diseases of various crops: diseases caused by Pythium spp. (Pythium aphanidermatum, P. debarianum, P. graminicola, P. irregulare, P. ultimum), gray mold (Botrytis cinerea), and Sclerotinia rot (Sclerotinia sclerotiorum).

Diseases of Japanese radish: Alternaria leaf spot (Alternaria brassicicola).

Diseases of Zoysia: dollar spot (Sclerotinia homeocarpa) and brown patch and large patch (Rhizoctonia solani).

Diseases of banana: sigatoka (Mycosphaerella fijiensis and Mycosphaerella musicola).

Diseases of sunflower: downy mildew (Plasmopara halstedii).

Seed diseases or diseases in the early stages of the growth of various crops which are caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp., Diplodia spp., and the like.

Viral diseases of various crops transmitted by Polymixa spp., Olpidium spp., or the like.

The inventive composition can be used as it is, but usually the inventive composition is formulated and applied to pests or habitats of the pests by the same method as that of a hitherto-known pest controlling agent for causing the inventive composition to contact or be taken in by the emerging pests described above.

Examples of habitats of pests in the present invention include paddy fields, farmlands, tea fields, orchards, non-agricultural lands, nursery trays, nursery boxes, propagation medium, nursery mats, and hydroponic media in hydroponic farms.

When the inventive composition is applied to a plant, the application is conducted by application of an effective amount of the inventive composition to the plant or its cultivation area with

Specific examples of the method of the application of the inventive composition include application to foliage, floral organ, or panicle of plant such as foliage spraying, application to soil (cultivation land) before or after planting a plant, application to seed such as seed disinfection, seed immersion, and seed coating, application to seedling, application to bulb such as seed potato.

When applying to a plant or a cultivation area of the plant, application of the inventive composition is conducted once or a plurality of times. In the plant or the cultivation area of the plant to which the inventive composition is applied, pests may have already lived or may not have emerged yet.

Specific examples of the application of the inventive composition to foliage, floral organ, or panicle of plant include application to the surface of plant such as foliage spraying and tree-trunk spraying, also include application to floral organ or the entire plant during a period of flowering including before, during, and after blooming, and further include application to panicle or the entirety of a cereal crop or the like during a period of earing.

Examples of the application method include spraying treatment, soil treatment, seed treatment, and hydroponic medium treatment.

The spraying treatment in the present invention is specifically, for example, a method, such as foliage spraying or tree-trunk spraying, in which the inventive composition is applied to the surface of a plant body or onto pests themselves to exhibit an effect of controlling pests. The soil treatment in the present invention is, for example, a method in which an active ingredient is applied to the rhizosphere of a crop, which is to be protected from damage such as ingestion by pests, to directly control pests, or an active ingredient is made to permeate and transfer into a plant body through the root portion or the like to control pests. Specific examples of the soil treatment include planting hole treatment (planting hole spraying and planting hole-treated soil mixing), plant foot treatment (plant foot spraying, plant foot soil mixing, plant foot irrigation, and plant foot treatment in the latter part of a seedling-raising period), planting furrow treatment (planting furrow spraying and planting furrow soil mixing), planting row treatment (planting row spraying, planting row soil mixing, and planting row spraying in a growing period), planting row treatment at a sowing period (planting row spraying at a sowing period and planting row soil mixing at a sowing period), total treatment (total soil spraying and total soil mixing), side row treatment, water surface treatment (water surface application and water surface application after flooding), other soil spraying treatment (spraying of granules onto leaves during a growing period, spraying to below the tree crown or around the main stem, spraying onto the soil surface, soil surface mixing, spraying into sowing holes, spraying onto furrow surfaces, and spraying to between stocks), other irrigation treatment (soil irrigation, irrigation in a seedling-raising period, chemical solution injection treatment, irrigation to a soil-contacting portion of plant, chemical solution drip irrigation, and chemigation), nursery box treatment (spraying into a nursery box, irrigation of a nursery box, and flooding of a nursery box with a chemical solution), nursery tray treatment (spraying onto a nursery tray, irrigation of a nursery tray, and flooding of a nursery tray with a chemical solution), seedbed treatment (spraying onto a seedbed, irrigation of a seedbed, spraying one to a flooded nursery seedbed, and immersion of seedlings), seedbed soil mixing treatment (seedbed soil mixing, seedbed soil mixing before sowing, spraying before soil cover at a sowing period, spraying after soil cover at a sowing period, and soil cover mixing), and other treatment (soil mixing, plowing, surface soil mixing, mixing of a rain-dropping portion of soil, planting position treatment, spraying of granules onto flower clusters, and paste fertilizer mixing). The seed treatment in the present invention is, for example, a method in which an active ingredient is applied directly to seeds, bulbs, etc. of a crop, which is to be protected from damage such as ingestion by pests, or to the neighborhood thereof to exhibit an effect of controlling pests. Specific examples of the seed treatment include spraying treatment, smearing treatment, immersion treatment, impregnation treatment, application treatment, film coating treatment, and pellet coating treatment. The hydroponic medium treatment in the present invention is, for example, a method in which, in order for an active ingredient to permeate and transfer into the plant body of a crop, which is to be protected from damage such as ingestion by pests, through the root portion or the like, the active ingredient is applied to a hydroponic medium or the like to protect the crop from the damage caused by pests. Specific examples of the hydroponic medium treatment include hydroponic medium mixing and hydroponic medium incorporation.

Furthermore, a formulation obtained by incorporating the inventive composition into a support such as a sheet-like, rope-like, strip-like, or net-like resin, paper, or cloth by means of immersion, impregnation, application, kneading, or the like can be applied by a method such as winding around plants, stretching in the vicinity of plants, laying on the soil at the plant foot, and covering the cultivation area of crops.

When the inventive composition is used to control pests in the field of agriculture, the amount of application can be broadly altered depending on the application period, the application site, the application method, etc. In general, in the case of using the inventive composition, the amount of application is usually 1 to 10,000 g as the amount of the present compound per 10,000 m². When the inventive composition is formulated as an emulsion, a wettable powder, a flowable formulation, or the like, the inventive composition is diluted with water so as to have an active ingredient concentration of 0.01 to 10,000 ppm, and is applied. A granule, a powder, or the like is usually applied as it is.

These formulations and water-diluted solutions of the formulations may be sprayed directly to pests or a plant such as a crop to be protected from pests, or may be applied to the soil of the cultivated land to control the pests living in the soil.

The inventive composition can effectively control a wide range of targets in ordinary grain fields, vegetable fields, flower fields, and orchards where crops are cultivated with or without tilling, or in non-agricultural lands.

In addition, when the inventive composition is applied to rice, the inventive composition may be used in the nursery box treatment or may be used immediately after sowing in direct-sowing cultivation. When the inventive composition is used for paddy rice by direct-sowing cultivation, the inventive composition may be applied before or after direct sowing of paddy rice in a flooded paddy field, after direct sowing of paddy rice in a drained paddy field, or after transplanting paddy rice. The time at which the inventive composition is applied may be a time before sowing or transplanting paddy rice, may be a time immediately after sowing or transplanting paddy rice, may be at 21 days after sowing or transplanting paddy rice, may be at 3 days to 21 days after sowing or transplanting paddy rice, or may be at 5 days to 21 days after sowing or transplanting paddy rice. When the inventive composition is used, the soil surface of the paddy field may be in a dried state, or may be in a wet state without flooding (water depth: 0 cm), or the paddy field may be flooded at such a water depth that there is no problem for the application. In addition, the inventive composition can be used for System of Rice Intensification (SRI).

Examples of plants for which the inventive composition can be used include the following.

Agricultural crops: corn, rice, wheat, barley, rye, oat, sorghum, cotton, soybean, peanut, sarrazin, sugar beet, rapeseed (such as canola), sunflower, sugar cane, tobacco, etc.;

Vegetables: Solanaceae vegetables (such as eggplant, tomato, green pepper, hot pepper, and potato), Cucurbitaceae vegetables (such as cucumber, pumpkin, zucchini, watermelon, melon, and squash), Cruciferae vegetables (such as Japanese radish, turnip, horseradish, kohlrabi, Chinese cabbage, cabbage, brown mustard, broccoli, and cauliflower), Compositae vegetables (such as burdock, garland chrysanthemum, artichoke, and lettuce), Liliaceae vegetables (such as Welsh onion, onion, garlic, and asparagus), Umbelliferae vegetables (such as carrot, parsley, celery, and parsnip), Chenopodiaceae vegetables (such as spinach and Swiss chard), Labiatae vegetables (such as Japanese basil, mint, and basil), strawberry, sweat potato, yam, aroid, etc.;

Flowering plants;

Ornamental foliage plants;

Zoysia;

Fruit trees: pomaceous fruits (such as apple, common pear, Japanese pear, Chinese quince, and quince), stone fleshy fruits (such as peach, plum, nectarine, Japanese plum, cherry, apricot, and prune), citrus plants (such as Satsuma mandarin, orange, lemon, lime, and grapefruit), nuts (such as chestnut, walnut, hazel nut, almond, pistachio, cashew nut, and macadamia nut), berry fruits (such as blueberry, cranberry, blackberry, and raspberry), grape, Japanese persimmon, olive, loquat, banana, coffee, date, coconut palm, etc.; and

Trees other than fruit trees: tea, mulberry, blossoming trees, street trees (such as ash tree, birch, dogwood, eucalyptus, ginkgo, lilac, maple tree, oak, poplar, cercis, Chinese sweet gum, plane tree, zelkova, Japanese arborvitae, fir tree, Japanese hemlock, needle juniper, pine, spruce, and yew), etc.

The plants described above may be plants that are bred by a hybrid technology.

In other words, the plants that are bred by a hybrid technology are plants having a heterosis (in general, for example, it leads to enhancement of yield potential and improvement of resistance to biological and abiotic stress factors).

The plants described above may be plants having resistance imparted by a gene recombination technology.

For example, the “plants” described above also include plants having resistance to herbicides including HPPD inhibitors such as isoxaflutole, ALS inhibitors such as imazethapyr and thifensulfuron methyl, EPSP synthetase inhibitors, glutamine synthetase inhibitors, bromoxynil, dicamba, and the like, which resistance has been imparted by a classical breeding method or gene recombination technology.

Examples of the “plants” having resistance imparted by a classical breeding method include Clearfield (registered trademark) canola which is resistant to imidazolinone type herbicides such as imazethapyr; and STS soybean which is resistant to sulfonylurea ALS inhibition-type herbicides such as thifensulfuron methyl. Examples of the “plants” having resistance imparted by a gene recombination technology include corn, soybean, cotton, rapeseed varieties that are resistant to glyphosate and glufosinate, and have already been on the market as trade names such as RoundupReady (registered trademark), RoundupReady2 (registered trademark), and LibertyLink (registered trademark).

The “plants” described above include plants that have become capable of synthesizing selective toxins and the like, which are known, for example, in genus Bacillus, using a gene recombination technology.

Examples of the toxins produced by such genetically-engineered plants include insecticidal proteins derived from Bacillus cereus and Bacillus popilliae; δ-endotoxins derived from Bacillus thuringiensis, such as Cry1Ab, Cry1Ac, Cry1F, Cry1Fa2, Cry2Ab, Cry3A, Cry3Bbl, or Cry9C, and insecticidal proteins derived from Bacillus thuringiensis, such as VIP1, VIP2, VIP3, or VIP3A; insecticidal proteins derived from nematode; toxins produced by animals, such as scorpion toxin, spider toxin, bee toxin, or insect-specific neurotoxin; filamentous fungi toxins; plant lectin; agglutinin; protease inhibitors such as trypsin inhibitors, serine protease inhibitors, patatin, cystatin, and papain inhibitors; ribosome-inactivating proteins (RIP) such as ricin, corn-RIP, abrin, rufin, sapolin, and briodin; steroid metabolic enzymes such as 3-hydroxysteroid oxidase, ecdysteroid-UDP-glucosyltransferase, and cholesterol oxidase; ecdysone inhibitors; HMG-COA reductase; ion channel inhibitors such as sodium channel inhibitors and calcium channel inhibitors; juvenile hormone esterase; diuretic hormone receptors; stilbene synthetase; bibenzyl synthetase; chitinase; and glucanase.

The toxins produced by such genetically-engineered plants also include hybrid toxins, partially deficient toxins, and modified toxins of δ-endotoxin proteins such as Cry1Ab, Cry1Ac, Cry1F, Cry1Fa2, Cry2Ab, Cry3A, Cry3Bbl, or Cry9C and insecticidal proteins such as VIP1, VIP2, VIP3, or VIP3A. The hybrid toxins are produced by novel combinations of different domains of these proteins using a recombination technique. As a partially deficient toxin, Cry1Ab whose amino acid sequence is partially deficient is known. In a modified toxin, one or more amino acids of a natural toxin are substituted.

Examples of such toxins and genetically-engineered plants capable of synthesizing such toxins are disclosed in EP-A-0374753, WO 93/07278, WO 95/34656, EP-A-0427529, EP-A-0451878, WO 03/052073, etc.

The toxins contained in such genetically-engineered plants impart to the plants, resistance to, particularly, Coleoptera pests, Diptera pests, and Lepidoptera pests.

Genetically-engineered plants containing one or more insecticidal insect-resistant genes and producing one or more toxins have already been known, and some of them are commercially available. Examples of such genetically-engineered plants include YieldGard (registered trademark) (a corn variety producing Cry1Ab toxin), YieldGard Rootworm (registered trademark) (a corn variety producing Cry3Bbl toxin), YieldGard Plus (registered trademark) (a corn variety producing Cry1Ab and Cry3Bbl toxins), Herculex I (registered trademark) (a corn variety producing phosphinotrysin N-acetyltransferase (PAT) for imparting resistance to Cry1Fa2 toxin and glufosinate), NuCOTN33B (a cotton variety producing Cry1Ac toxin), Bollgard I (registered trademark) (a cotton variety producing Cry1Ac toxin), Bollgard II (registered trademark) (a cotton variety producing Cry1Ac and Cry2Ab toxins), VIPCOT (registered trademark) (a cotton variety producing VIP toxin), NewLeaf (registered trademark) (a potato variety producing Cry3A toxin), NatureGard (registered trademark), Agrisure (registered trademark), GT Advantage (GA21 glyphosate-resistant character), Agrisure (registered trademark), CB Advantage (Bt11 corn borer (CB) character), and Protecta (registered trademark).

The “plants” described above also include plants having an ability to produce an anti-pathogenic substance having a selective action which ability has been imparted by a gene recombination technology.

As examples of anti-pathogenic substances, PR proteins and the like are known (PRPs, EP-A-0392225). Such anti-pathogenic substances and genetically-engineered plants that produce such anti-pathogenic substances are disclosed in EP-A-0392225, WO 95/33818, EP-A-0353191, etc.

Examples of such anti-pathogenic substances produced by genetically-engineered plants include ion channel inhibitors such as sodium channel inhibitors and calcium channel inhibitors (for example, KP1, KP4, and KP6 toxins produced by viruses are known); stilbene synthase; bibenzyl synthase; chitinase; glucanase; PR proteins; and anti-pathogenic substances produced by microorganisms, such as peptide antibiotics, antibiotics having a heterocyclic ring, and protein factors associated with resistance to plant diseases (referred to as plant disease resistant genes and disclosed in WO 03/000906).

In addition, the “plants” described above also include lines having two or more types of characters related to herbicide resistance, pest resistance, disease resistance, and the like as described above, which characters are imparted using a classical breeding technology or gene recombination technology, and lines having two or more types of properties possessed by parent lines, which properties are imparted by crossing genetically-engineered plants having the same or different types of properties. Examples of such plants include Smart stax (registered trademark).

When the inventive composition and a certain type of herbicide are applied to a crop having herbicide resistance imparted by any method at the same time or at a different time, a superior “crop growth improving effect” can also be effectively obtained with less labor. Here, the “crop growth improving effect” means that pest damage, disease damage, or weed damage of a crop is controlled, leading to an increase in the yield of the crop.

Specifically, with regard to a crop provided with imidazolinone type herbicide resistance, for example, when the inventive composition and an imidazolinone type herbicide such as imazapyr are applied to Clearfield (registered trademark) canola at the same time or at a different time, the growth of Clearfield canola can be improved. In addition, with regard to a crop provided with glyphosate resistance, for example, when the inventive composition and glyphosate are applied to RoundupReady (registered trademark) cotton or RoundupReady2 soybean (registered trademark) at the same time or different times, the growth of RoundupReady cotton or RoundupReady2 soybean can be improved. Moreover, with regard to a crop provided with glufosinate resistance, for example, when the inventive composition and glufosinate are applied to LibertyLink (registered trademark) at the same time or different times, the growth of LibertyLink corn can be improved.

Depending on plant species, plant varieties, and their growing locations and growing conditions (soil, climate, growing period, and nutrient), application of the inventive composition may allow improvement of plant growth, improvement of resistance or tolerance to high temperature or low temperature, improvement of resistance to drought or salt contained in water or soil, improvement of blooming capability, improvement of ease of harvest, acceleration of maturation, increase in yield, increase in size of fruit, increase in height of plant, improvement of green color of leaves, earlier blooming, improvement of quality and/or increase in nutritional value of harvested products, increase in sugar content in fruit, enhancement of gluten strength, improvement of storage stability and/or improvement of processability of harvested products, and the like.

Examples of the fungicides included in Group A include:

(1) Azole type fungicides such as propiconazole, prothioconazole, triadimenol, prochloraz, penconazole, tebuconazole, flusilazole, diniconazole, diniconazole-M, bromuconazole, epoxiconazole, difenoconazole, cyproconazole, metconazole, triflumizole, tetraconazole, microbutanil, fenbuconazole, hexaconazole, fluquinconazole, triticonazole, bitertanol, imazalil, flutriafol, simeconazole, ipconazole, Triforine, Pyrifenox, Fenarimol, Nuarimol, Oxpoconazole Fumarate, Pefurazoate, Azaconazole, Imibenconazole, Myclobutanil, and Triadimefon;

(2) Amine type fungicides such as fenpropimorph, tridemorph, fenpropidin, and spiroxamine;

(3) Benzimidazole type fungicides such as carbendazim, benomyl, thiabendazole, thiophanate-Methyl, and thiophanate;

(4) Dicarboxyimide type fungicides such as procymidone, iprodione, and vinclozolin;

(5) Anilinopyrimidine type fungicides such as cyprodinil, pyrimethanil, and mepanipyrim;

(6) Phenylpyrrole type fungicides such as fenpiclonil and fludioxonil;

(7) Strobilurin type fungicides such as kresoxim-methyl, azoxystrobin, trifloxystrobin, fluoxastrobin, picoxystrobin, pyraclostrobin, dimoxystrobin, pyribencarb, metominostrobin, oryzastrobin, enestrobin, pyrametostrobin, pyraoxystrobin, enoxastrobin, coumoxystrobin, flufeoxystrobin, fenaminostrobin, triclopyricarb, and N-methyl-2-[2-(2,5-dimethylphenoxyl)methyl]phenyl-2-methoxy acetamide (hereinafter, referred to as α1. The α1 includes a racemic body or an enantiomer and a mixture of a R-enantiomer and a S-enantiomer in an arbitrary ratio.);

(8) Acylalanine type fungicides such as metalaxyl, metalaxyl-M or mefenoxam, benalaxyl, benalaxyl-M or kiralaxyl, furalaxyl, furalaxyl-M, ofurace, and oxadixyl;

(9) Carboxylic amide type fungicides such as dimethomorph, iprovalicarb, benthivalicarb-isopropyl, mandipropamid, valiphenal, and valifenalate;

(10) SDHI fungicides such as carboxin, oxycarboxin, mepronil, flutolanil, thifluzamide, furametpyr, boscalid, penthiopyrad, fluopyram, bixafen, penflufen, sedaxane, isopyrazam, fluxapyroxad, Binapacryl, Silthiofam, and a compound of the following formula (a); and

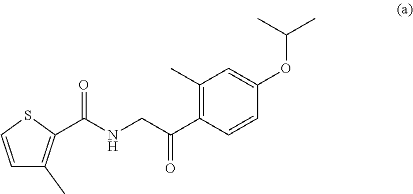 [SMILES: Cc1cc(OC(C)C)ccc1C(=O)CNC(=O)c1sccc1C]

(11) Other fungicides or plant disease controlling agents such as diethofencarb, thiram, fluazinam, mancozeb, chlorothalonil, captan, dichlofluanide, folpet, quinoxyfen, fenhexamid, famoxadone, fenamidone, zoxamide, ethaboxam, amisulbrom, cyazofamid, metrafenone, pyriofenone, cyflufenamid, Proquinazid, flusulfamide, fluopicolide, fosetyl, Cymoxanil, pencycuron, tolclofos-methyl, carpropamide, diclocymet, fenoxanil, tricyclazole, pyroquilone, probenazole, isotianil, tiadinil, tebufloquin, diclomezine, kasugamycin, ferimzone, phthalide, validamycin A, hydroxyisoxazole, hymexazol, triazoxide, iminoctadine triacetate, isoprothiolane, oxolinic acid, oxytetracycline, streptomycin, basic copper chloride, cupric hydroxide, basic copper sulfate, organic copper, Sulfur, ametoctradin, fenpyrazamine, dodine, acibenzolar-S-methyl, blasticidin-S, iprobenfos, edifenphos, isofetamid, Bacillus subtilis, 3-chloro-5-phenyl-6-methyl-4-(2,6-difluorophenyl)pyridazine (hereinafter, referred to as α2), 3-cyano-5-phenyl-6-methyl-4-(2,6-difluorophenyl)pyridazine (hereinafter, referred to as α3), N-(1,1,3-trimethylindan-4-yl)-1-methyl-3-difluoromethylpyrazole-4-carboxylic amide (hereinafter, referred to as α4. The α4 includes a racemic body or an enantiomer and a mixture of a R-enantiomer and a S-enantiomer in an arbitrary ratio.), a compound of the following formula (b);

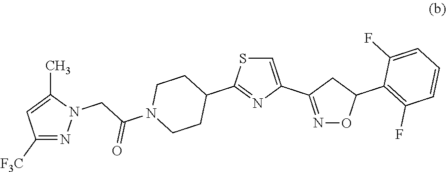 [SMILES: Cc1cc(C(F)(F)F)nn1CC(=O)N1CCC(c2nc(C3=NOC(c4c(F)cccc4F)C3)cs2)CC1]

a compound of the following formula (c);

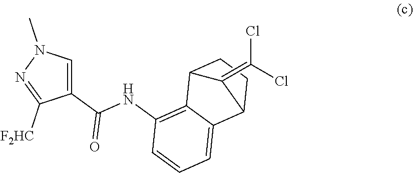 [SMILES: Cn1cc(C(=O)Nc2cccc3c2C2CCC3C2=C(Cl)Cl)c(C(F)F)n1]

a compound of the following formula (d); and

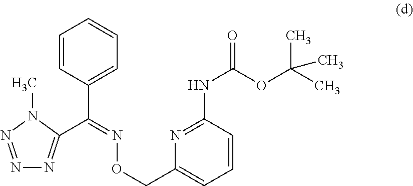 [SMILES: Cn1nnnc1/C(=N\OCc1cccc(NC(=O)OC(C)(C)C)n1)c1ccccc1]

a compound of the following formula (e).

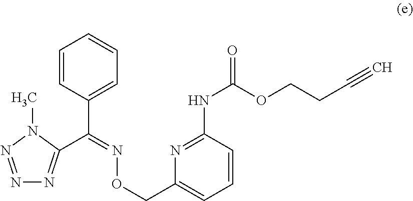 [SMILES: C#CCCOC(=O)Nc1cccc(CO/N=C(/c2ccccc2)c2nnnn2C)n1]

Examples of the insecticides included in Group B include:

(1) Organic phosphorus type compounds such as acephate, Aluminium phosphide, butathiofos, cadusafos, chlorethoxyfos, chlorfenvinphos, chlorpyrifos, chlorpyrifos-ethyl, cyanophos (CYAP), diazinon, DCIP (dichlorodiisopropyl ether), dichlofenthion (ECP), dichlorvos (DDVP), dimethoate, dimethylvinphos, disulfoton, EPN, ethion, ethoprophos, etrimfos, fenthion (MPP), fenitrothion (MEP), fosthiazate, formothion, Hydrogen phosphide, isofenphos, isoxathion, malathion, mesulfenfos, methidathion (DMTP), monocrotophos, naled (BRP), oxydeprofos (ESP), parathion, phosalone, phosmet (PMP), pirimiphos-methyl, pyridafenthion, quinalphos, phenthoate (PAP), profenofos, propaphos, prothiofos, pyraclorfos, salithion, sulprofos, tebupirimfos, temephos, tetrachlorvinphos, terbufos, thiometon, trichlorphon (DEP), vamidothion, phorate, fenamiphos, phoxim, dicrotophos, and fosthiazate;

(2) Carbamate type compounds such as alanycarb, bendiocarb, benfuracarb, fenbucarb, carbaryl, carbofuran, carbosulfan, cloethocarb, ethiofencarb, fenobucarb, fenothiocarb, fenoxycarb, furathiocarb, isoprocarb (MIPC), metolcarb, methomyl, methiocarb, NAC, oxamyl, pirimicarb, propoxur (PHC), XMC, thiodicarb, xylylcarb, aldicarb, and pirimicarb;

(3) Synthetic pyrethroid type compounds such as acrinathrin, allethrin, benfluthrin, beta-cyfluthrin, bifenthrin, cycloprothrin, cyfluthrin, cyhalothrin, cypermethrin, deltamethrin, esfenvalerate, ethofenprox, fenpropathrin, fenvalerate, flucythrinate, flufenoprox, flumethrin, fluvalinate, halfenprox, imiprothrin, permethrin, prallethrin, pyrethrins, resmethrin, silafluofen, tefluthrin, tralomethrin, transfluthrin, tetramethrin, phenothrin, cyphenothrin, alpha-cypermethrin, beta-cypermethrin, sigma-cypermethrin, zeta-cypermethrin, theta-cypermethrin, lambda-cyhalothrin, gamma-cyhalothrin, furamethrin, tau-fluvalinate, 2,3,5,6-tetrafluoro-4-(methoxymethyl)benzyl (EZ)-(1RS,3RS;1RS,3SR)-2,2-dimethyl-3-prop-1-enylcyclopropanecarboxylate, 2,3,5,6-tetrafluoro-4-methylbenzyl (EZ)-(1RS,3RS;1RS,3SR)-2,2-dimethyl-3-prop-1-enylcyclopropanecarboxylate, 2,3,5,6-tetrafluoro-4-(methoxymethyl)benzyl(1RS,3RS;1RS,3SR)-2,2-dimethyl-3-(2-methyl-1-propenyl)cyclopropanecarboxylate, protrifenbute, and halfenprox;

(4) Nereistoxin type compounds such as cartap chloride, bensultap, thiocyclam, monosultap, and bisultap;

(5) Neonicotinoid type compounds such as imidacloprid, nitenpyram, acetamiprid, thiamethoxam, thiacloprid, dinotefuran, and clothianidin;

(6) Benzoylurea type compounds such as chlorfluazuron, bistrifluron, diafenthiuron, diflubenzuron, fluazuron, flucycloxuron, flufenoxuron, hexaflumuron, lufenuron, novaluron, noviflumuron, teflubenzuron, triflumuron, and triazuron;

(7) Phenylpyrazole type compounds such as acetoprole, ethiprole, fipronil, vaniliprole, pyriprole, and pyrafluprole;

(8) Microbial materials such as live spores derived from and crystal toxins produced from Bacillus thuringiensis, var. aizawai, var. kurstaki, var. tenebriosis, Bacillus firmus (CNCM 1-1582 strain etc.), and Pasteuria penetrans, and mixtures thereof;

(9) Hydrazine type compounds such as chromafenozide, halofenozide, methoxyfenozide, and tebufenozide;

(10) Organic chlorine type compounds such as aldrin, dieldrin, dienochlor, endosulfan, and methoxychlor;

(11) Natural insecticides such as nicotine-sulfate and machine oil;

(12) Nematocides (nematocidal active ingredients) such as levamisol hydrochloride, methyisothiocyanate, morantel tartarate, imicyafos, and fluensulfone; and

(13) Other insecticides such as avermectin-B, bromopropylate, buprofezin, chlorphenapyr, cyromazine, D-D(1,3-Dichloropropene), emamectin, emamectin-benzoate, abamectin, milbemectin, doramectin, fenazaquin, flupyrazofos, pyrazofos, hydroprene, methoprene, indoxacarb, metoxadiazone, milbemycin-A, pymetrozine, pyridalyl, pyriproxyfen, sulfluramid, tolfenpyrad, triazamate, flubendiamide, lepimectin, Arsenic acid, benclothiaz, Calcium cyanamide, Calcium polysulfide, chlordane, DDT, DSP, flufenerim, flonicamid, flurimfen, formetanate, metam-ammonium, metam-sodium, Methyl bromide, Potassium oleate, Sulfur, metaflumizone, spirotetramat, pyrifluquinazone, chlorantraniliprole, cyantraniliprole, flometoquin, flupyradifurone, Sulfoxaflor, flupyradifurone, pyflubumide, imidaclothiz, cycloxaprid, a compound of the following formula (f) (hereinafter, referred to as α5);

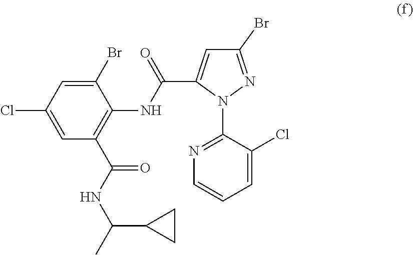 [SMILES: CC(NC(=O)c1cc(Cl)cc(Br)c1NC(=O)c1cc(Br)nn1-c1ncccc1Cl)C1CC1]

a compound of the following formula (g) (hereinafter, referred to as α6); and

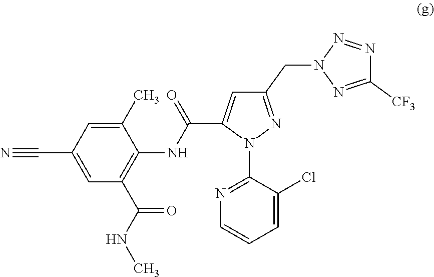 [SMILES: CNC(=O)c1cc(C#N)cc(C)c1NC(=O)c1cc(Cn2nnc(C(F)(F)F)n2)nn1-c1ncccc1Cl]

a compound of the following formula (h) (hereinafter, referred to as α7).

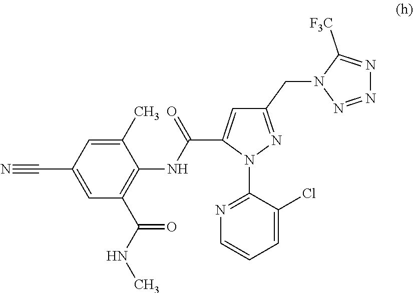 [SMILES: CNC(=O)c1cc(C#N)cc(C)c1NC(=O)c1cc(Cn2nnnc2C(F)(F)F)nn1-c1ncccc1Cl]

Examples of the acaricides (acaricidal active ingredients) included in Group C include acequinocyl, amitraz, benzoximate, bifenaate, bromopropylate, chinomethionat, chlorobenzilate, CPCBS (chlorfenson), clofentezine, cyflumetofen, kelthane (dicofol), etoxazole, fenbutatin oxide, fenothiocarb, fenpyroximate, fluacrypyrim, fluproxyfen, hexythiazox, propargite (BPPS), polynactins, pyridaben, Pyrimidifen, tebufenpyrad, tetradifon, spirodiclofen, spiromesifen, amidoflumet, cyenopyrafen, and pyflubumide.

Examples of the chemical injury reducing agents (chemical injury reduction active ingredients) included in Group D include 1,8-naphthalic anhydride, cyometrinil, oxabetrinil, fluxofenim, flurazole, benoxacor, dichlormid, furilazole, fenclorim, daimuron, cumyluron, dimepiperate, cloquintocet-mexyl, fenchlorazole-ethyl, mefenpyr-diethyl, and isoxadifen-ethyl.

Examples of the plant growth regulators (plant growth regulation active ingredients) included in Group E include ethephon, chlormequat-chloride, mepiquat-chloride, Gibberellin A represented by Gibberellin A3, and 4-oxo-4-(2-phenylethyl) aminobutyric acid (hereinafter, referred to as α8).

In addition, the inventive composition can further comprise a compound such as anthraquinone, which is used as a bird repellent.

The compounds listed in Table 6 among the compounds in Group A to Group E are abbreviate as “α9” to “α274” as shown in the table.

The above compounds included in Group A to Group E are publicly known compounds and are disclosed, for example, in “THE PESTICIDE MANUAL-15th EDITION (published by BCPC) ISBN 978-1-901396-18-8.” These compounds can be produced by the production methods described in the patent literature or non-patent literature cited or documents cited at second hand in “THE PESTICIDE MANUAL”, or can be obtained from commercially available formulations.

TABLE 6

| Abbreviation | Compound Name |
|---|---|
| α9 | Imidacloprid |
| α10 | Clothianidin |
| α11 | Thiamethoxam |
| α12 | Dinotefuran |
| α13 | Acetamiprid |
| α14 | Thiacloprid |
| α15 | Nitenpyram |
| α16 | Acrinathrin |
| α17 | Bifenthrin |
| α18 | Cycloprothrin |
| α19 | Cyfluthrin |
| α20 | Beta-cyfluthrin |
| α21 | Cyhalothrin |
| α22 | Lambda-cyhalothrin |
| α23 | Gamma-cyhalothrin |
| α24 | Cypermethrin |
| α25 | Alpha-cypermethrin |
| α26 | Beta-cypermethrin |
| α27 | Theta-cypermethrin |
| α28 | Zeta-cypermethrin |
| α29 | Deltamethrin |
| α30 | Ethofenprox |
| α31 | Fenpropathrin |
| α32 | Fenvalerate |
| α33 | Esfenvalerate |
| α34 | Flucythrinate |
| α35 | Fluvalinate |
| α36 | Tau-fluvalinate |
| α37 | Halfenprox |
| α38 | Permethrin |
| α39 | Silafluofen |
| α40 | Tefluthrin |
| α41 | Tralomethrin |
| α42 | Protrifenbute |
| α43 | Fipronil |
| α44 | Ethiprole |
| α45 | Acetoprole |
| α46 | Vaniliprole |
| α47 | Pyriprole |
| α48 | Pyrafluprole |
| α49 | Abamectin |
| α50 | Emamectin |
| α51 | Emamectin-benzoate |
| α52 | Milbemectin |
| α53 | Doramectin |
| α54 | Lepimectin |
| α55 | Flubendiamide |
| α56 | Chlorantraniliprole |
| α57 | Cyantraniliprole |
| α58 | Pymetrozine |
| α59 | Pyridalyl |
| α60 | Pyriproxyfen |
| α61 | Spirotetramat |
| α62 | Sulfoxaflor |
| α63 | Flupyradifurone |
| α64 | Acephate |
| α65 | Chlorpyrifos |
| α66 | Chlorpyrifos-ethyl |
| α67 | Cadusafos |
| α68 | Diazinon |
| α69 | Ethoprophos |
| α70 | Fenamiphos |
| α71 | Fosthiazate |
| α72 | Isofenphos |
| α73 | Imicyafos |
| α74 | Isoxathion |
| α75 | Fenitrothion |
| α76 | Phorate |
| α77 | Phosmet |
| α78 | Phoxim |
| α79 | Terbufos |
| α80 | Quinalphos |
| α81 | Pyraclorfos |
| α82 | Monocrotophos |
| α83 | Dicrotophos |
| α84 | Carbofuran |
| α85 | Carbosulfan |
| α86 | Aldicarb |
| α87 | Thiodicarb |
| α88 | Methiocarb |
| α89 | Oxamyl |
| α90 | Methomyl |
| α91 | Pirimicarb |
| α92 | Benfuracarb |
| α93 | Pyrethrins |
| α94 | Allethrin |
| α95 | Buprofezin |
| α96 | Tolfenpyrad |
| α97 | Thiocyclam |
| α98 | Cartap hydrochloride |
| α99 | Bensultap |
| α100 | Flonicamid |
| α101 | Indoxacarb |
| α102 | Metaflumizone |
| α103 | Chromafenozide |
| α104 | Methoxyfenozide |
| α105 | Halofenozide |
| α106 | Tebufenozide |
| α107 | Diflubenzuron |
| α108 | Teflubenzuron |
| α109 | Chlorfluazuron |
| α110 | Lufenuron |
| α111 | Novaluron |
| α112 | Flufenoxuron |
| α113 | Chlorphenapyr |
| α114 | Pyrifluquinazone |
| α115 | Cyromazine |
| α116 | Diafenthiuron |
| α117 | Etoxazole |
| α118 | Spirodiclofen |
| α119 | Spiromesifen |
| α120 | Fenpyroximate |
| α121 | Pyridaben |
| α122 | Pyrimidifen |
| α123 | Tebufenpyrad |
| α124 | Acequinocyl |
| α125 | Bifenazate |
| α126 | Fluacrypyrim |
| α127 | Cyenopyrafen |
| α128 | Cyflumetofen |
| α129 | Pyflubumide |
| α130 | Imidaclothiz |
| α131 | Cycloxaprid |
| α132 | Tebuconazole |
| α133 | Metconazole |
| α134 | Difenoconazole |
| α135 | Triticonazole |
| α136 | Imazalil |
| α137 | Triadimenol |
| α138 | Fluquinconazole |
| α139 | Prochloraz |
| α140 | Prothioconazole |
| α141 | Diniconazole |
| α142 | Diniconazole-M |
| α143 | Cyproconazole |
| α144 | Tetraconazole |
| α145 | Ipconazole |
| α146 | Triforine |
| α147 | Pyrifenox |
| α148 | Fenarimol |
| α149 | Nuarimol |
| α150 | Oxpoconazole Fumarate |
| α151 | Pefurazoate |
| α152 | Triflumizole |
| α153 | Azaconazole |
| α154 | Bitertanol |
| α155 | Bromuconazole |
| α156 | Epoxiconazole |
| α157 | Fenbuconazole |
| α158 | Flusilazole |
| α159 | Flutriafol |
| α160 | Hexaconazole |
| α161 | Imibenconazole |
| α162 | Myclobutanil |
| α163 | Penconazole |
| α164 | Propiconazole |
| α165 | Simeconazole |
| α166 | Triadimefon |
| α167 | Kresoxim-methyl |
| α168 | Azoxystrobin |
| α169 | Pyraclostrobin |
| α170 | Picoxystrobin |
| α171 | Enestrobin |
| α172 | Trifloxystrobin |
| α173 | Dimoxystrobin |
| α174 | Fluoxastrobin |
| α175 | Oryzastrobin |
| α176 | Famoxadone |
| α177 | Fenamidone |
| α178 | Metominostrobin |
| α179 | Metalaxyl |
| α180 | Metalaxyl-M |
| α181 | Furalaxyl |
| α182 | Furalaxyl-M |
| α183 | Benalaxyl |
| α184 | Benalaxyl-M |
| α185 | Ofurace |
| α186 | Oxadixyl |
| α187 | Probenazole |
| α188 | Tiadinil |
| α189 | Tricyclazole |
| α190 | Pyroquilone |
| α191 | Kasugamycin |
| α192 | Ferimzone |
| α193 | Isotianil |
| α194 | Phthalide |
| α195 | Tebufloquin |
| α196 | Pencycuron |
| α197 | Furametpyr |
| α198 | Validamycin A |
| α199 | Carboxin |
| α200 | Flutolanil |
| α201 | Penthiopyrad |
| α202 | Fluopyram |
| α203 | Penflufen |
| α204 | Sedaxane |
| α205 | Fluxapyroxad |
| α206 | Fludioxonil |
| α207 | Ethaboxam |
| α208 | Tolclofos-methyl |
| α209 | Captan |
| α210 | Benomyl |
| α211 | Carbendazim |
| α212 | Thiophanate |
| α213 | Thiophanate-methyl |
| α214 | Thiabendazole |
| α215 | Diethofencarb |
| α216 | Zoxamide |
| α217 | Fluopicolide |
| α218 | thifluzamide |
| α219 | Boscalid |
| α220 | Bixafen |
| α221 | Isopyrazam |
| α222 | enoxastrobin |
| α223 | Famoxadone |
| α224 | Pyribencarb |
| α225 | Pyraoxystrobin |
| α226 | Pyrametostrobin |
| α227 | Coumoxystrobin |
| α228 | Flufeoxystrobin |
| α229 | Triclopyricarb |
| α230 | Fenaminostrobin |
| α231 | Cyazofamid |
| α232 | Amisulbrom |
| α233 | Ametoctradin |
| α234 | Binapacryl |
| α235 | Fluazinam |
| α236 | Silthiofam |
| α237 | Pyrimethanil |
| α238 | Cyprodinil |
| α239 | Blasticidin-S |
| α240 | Procymidone |
| α241 | Iprodione |
| α242 | Quinoxyfen |
| α243 | Proquinazid |
| α244 | Fenpyrazamine |
| α245 | Isoprothiolane |
| α246 | Iprobenfos |
| α247 | Edinphos |
| α248 | Pyrazofos |
| α249 | Quintozene |
| α250 | Fenpropimorph |
| α251 | Fenpropidin |
| α252 | Spiroxamine |
| α253 | Fenhexamid |
| α254 | Dodine |
| α255 | Acibenzolar-S-methyl |
| α256 | Mancozeb |
| α257 | Folpet |
| α258 | Chlorothalonil |
| α259 | Thiram |
| α260 | Diclocymet |
| α261 | Carpropamide |
| α262 | Oxolinic acid |
| α263 | Isofetamid |
| α264 | Pasteuria penetrans |
| α265 | Bacillus subtilis |
| α266 | Bacillus thuringiensis var. aizawai |
| α267 | Bacillus thuringiensis var. kurstaki |
| α266 | Bacillus thuringiensis var. tenebriosis |
| α267 | Bacillus firmus |
| α268 | Oxycarboxin |
| α269 | Triazoxide |
| α270 | Anthraquinone |
| α271 | Hymexazol |
| α272 | Cymoxanil |
| α273 | Fluopicolide |
| α274 | Gibberellin A3 |

Zero to seven (e.g., 1, 2, 3, 4, 5, 6, 7) kinds of these other fungicides, insecticides, acaricides, nematocides, chemical injury reducing agents, plant growth regulators, and the like can be allowed to be contained in the inventive composition.

Examples of the method of controlling pests of the present invention (hereinafter, referred to as present controlling method) include application to a plant or soil where the plant is cultivated, with an effective amount of the present compound and one or more compounds selected from Group A to Group E. Examples of the plant include foliage of plant, seed of plant, bulb of plant, and seedling of plant. Here, the bulb means scaly bulb, corm, rhizome, tuber, tuberous root, and rhizophore, and includes also seed potato, seed sweet potato, seed cassava potato, seed yam potato, seed aroid potato.

In the present controlling method, the present compound and the one or more compounds selected from Group A to Group E may be separately applied during the same period to a plant or soil where the plant is cultivated, but are usually applied as the inventive composition in light of handiness at the application.

In the present controlling method, the mixture ratio (weight ratio) of the present compound and the one or more compounds selected from Group A to Group E depends on the type of a plant to be protected, the type and emerging frequency of pests to be controlled, the formulation form, the application time, the application method, the application site, the climate conditions, and the like. However, when applied to foliage or seeds of a plant or when applied to soil where the plant is cultivated, (the present compound)/(one or more compounds selected from Group A) is 1/100 to 10,000/1 for the compounds included in Group A, regardless of presence or absence of other ingredients; (the present compound)/(one or more compounds selected from Group B) is 1/100 to 100/1 for the compounds included in Group B, regardless of presence or absence of other ingredients; (the present compound)/(one or more compounds selected from Group C) is 1/100 to 100/1 for the compounds included in Group C, regardless of presence or absence of other ingredients; (the present compound)/(one or more compounds selected from Group D) is 1/100 to 100/1 for the compounds included in Group D, regardless of presence or absence of other ingredients; and (the present compound)/(one or more compounds selected from Group E) is 1/100 to 10,000/1 for the compounds included in Group E, regardless of presence or absence of other ingredients.

The inventive composition can be further mixed with a fungicide, an insecticide, an acaricide, a nematocide, a chemical injury reducing agent, a herbicide, a plant growth regulator, a fertilizer, or a soil conditioner other than one or more compounds selected from Group A to Group E, to be used, or can be used simultaneously with them without mixing.

The microbial materials which are the live spores derived from and the crystal toxins produced from Bacillus thuringiensis, Pasteuria penetrans, and the like and the mixtures thereof may be mixed with the inventive composition and applied to a plant, or the inventive composition may be applied to a plant simultaneously with them.

The seed of the present invention is a plant seed to which an effective amount of the inventive composition is attached. The inventive composition may be attached to the plant either directly or indirectly.

To attach the inventive composition to the plant seed, the inventive composition may completely or partially coat the seed, may be dispersed on the seed surface, and/or may exist inside of the seed.

Examples of embodiment of the inventive composition include the following.

(A) The inventive compositions of the following combinations of the present compound and one or more compounds selected from Group A to Group E:

A combination of any one of the present compounds 1 to 647 and “α64”
A combination of any one of the present compounds 1 to 647 and “α65”
A combination of any one of the present compounds 1 to 647 and “α66”
A combination of any one of the present compounds 1 to 647 and “α67”
A combination of any one of the present compounds 1 to 647 and “α68”
A combination of any one of the present compounds 1 to 647 and “α69”
A combination of any one of the present compounds 1 to 647 and “α70”
A combination of any one of the present compounds 1 to 647 and “α71”
A combination of any one of the present compounds 1 to 647 and “α72”
A combination of any one of the present compounds 1 to 647 and “α73”
A combination of any one of the present compounds 1 to 647 and “α74”
A combination of any one of the present compounds 1 to 647 and “α75”
A combination of any one of the present compounds 1 to 647 and “α76”
A combination of any one of the present compounds 1 to 647 and “α77”
A combination of any one of the present compounds 1 to 647 and “α78”
A combination of any one of the present compounds 1 to 647 and “α79”
A combination of any one of the present compounds 1 to 647 and “α80”
A combination of any one of the present compounds 1 to 647 and “α81”
A combination of any one of the present compounds 1 to 647 and “α82”
A combination of any one of the present compounds 1 to 647 and “α83”
A combination of any one of the present compounds 1 to 647 and “α84”
A combination of any one of the present compounds 1 to 647 and “α85”
A combination of any one of the present compounds 1 to 647 and “α8 6”
A combination of any one of the present compounds 1 to 647 and “α87”
A combination of any one of the present compounds 1 to 647 and “α88”
A combination of any one of the present compounds 1 to 647 and “α89”
A combination of any one of the present compounds 1 to 647 and “α90”
A combination of any one of the present compounds 1 to 647 and “α91”
A combination of any one of the present compounds 1 to 647 and “α92”
A combination of any one of the present compounds 1 to 647 and “α95”
A combination of any one of the present compounds 1 to 647 and “α96”
A combination of any one of the present compounds 1 to 647 and “α97”
A combination of any one of the present compounds 1 to 647 and “α98”

A combination of any one of the present compounds 1 to 647 and “α99”

A combination of any one of the present compounds 1 to 647 and “α100”
A combination of any one of the present compounds 1 to 647 and “α101”
A combination of any one of the present compounds 1 to 647 and “α102”
A combination of any one of the present compounds 1 to 647 and “α103”
A combination of any one of the present compounds 1 to 647 and “α104”
A combination of any one of the present compounds 1 to 647 and “α105”
A combination of any one of the present compounds 1 to 647 and “α106”
A combination of any one of the present compounds 1 to 647 and “α107”
A combination of any one of the present compounds 1 to 647 and “α108”
A combination of any one of the present compounds 1 to 647 and “α109”
A combination of any one of the present compounds 1 to 647 and “α110”
A combination of any one of the present compounds 1 to 647 and “α111”
A combination of any one of the present compounds 1 to 647 and “α112”
A combination of any one of the present compounds 1 to 647 and “α113”
A combination of any one of the present compounds 1 to 647 and “α114”
A combination of any one of the present compounds 1 to 647 and “α115”
A combination of any one of the present compounds 1 to 647 and “116”
A combination of any one of the present compounds 1 to 647 and “α117”
A combination of any one of the present compounds 1 to 647 and “α118”
A combination of any one of the present compounds 1 to 647 and “α119”
A combination of any one of the present compounds 1 to 647 and “α120”
A combination of any one of the present compounds 1 to 647 and “α121”
A combination of any one of the present compounds 1 to 647 and “α122”
A combination of any one of the present compounds 1 to 647 and “α123”
A combination of any one of the present compounds 1 to 647 and “α124”
A combination of any one of the present compounds 1 to 647 and “α125”
A combination of any one of the present compounds 1 to 647 and “α126”
A combination of any one of the present compounds 1 to 647 and “α127”
A combination of any one of the present compounds 1 to 647 and “α128”
A combination of any one of the present compounds 1 to 647 and “α129”
A combination of any one of the present compounds 1 to 647 and “α130”
A combination of any one of the present compounds 1 to 647 and “α131”
A combination of any one of the present compounds 1 to 647 and “α6”
A combination of any one of the present compounds 1 to 647 and “α7”
A combination of any one of the present compounds 1 to 647 and “α210”
A combination of any one of the present compounds 1 to 647 and “α211”
A combination of any one of the present compounds 1 to 647 and “α212”
A combination of any one of the present compounds 1 to 647 and “α213”
A combination of any one of the present compounds 1 to 647 and “α214”
A combination of any one of the present compounds 1 to 647 and “α215”
A combination of any one of the present compounds 1 to 647 and “α216”
A combination of any one of the present compounds 1 to 647 and “α217”
A combination of any one of the present compounds 1 to 647 and “α218”
A combination of any one of the present compounds 1 to 647 and “α220”
A combination of any one of the present compounds 1 to 647 and “α221”
A combination of any one of the present compounds 1 to 647 and “α222”
A combination of any one of the present compounds 1 to 647 and “α223”
A combination of any one of the present compounds 1 to 647 and “α224”
A combination of any one of the present compounds 1 to 647 and “α225”
A combination of any one of the present compounds 1 to 647 and “α226”
A combination of any one of the present compounds 1 to 647 and “α227”
A combination of any one of the present compounds 1 to 647 and “α228”
A combination of any one of the present compounds 1 to 647 and “α229”
A combination of any one of the present compounds 1 to 647 and “α230”
A combination of any one of the present compounds 1 to 647 and “α231”
A combination of any one of the present compounds 1 to 647 and “α232”
A combination of any one of the present compounds 1 to 647 and “α233”
A combination of any one of the present compounds 1 to 647 and “α234”
A combination of any one of the present compounds 1 to 647 and “α235”
A combination of any one of the present compounds 1 to 647 and “α236”
A combination of any one of the present compounds 1 to 647 and “α237”
A combination of any one of the present compounds 1 to 647 and “α238”
A combination of any one of the present compounds 1 to 647 and “α239”
A combination of any one of the present compounds 1 to 647 and “α240”
A combination of any one of the present compounds 1 to 647 and “α241”
A combination of any one of the present compounds 1 to 647 and “α242”
A combination of any one of the present compounds 1 to 647 and “α243”
A combination of any one of the present compounds 1 to 647 and “α244”
A combination of any one of the present compounds 1 to 647 and “α245”
A combination of any one of the present compounds 1 to 647 and “α246”
A combination of any one of the present compounds 1 to 647 and “α247”
A combination of any one of the present compounds 1 to 647 and “α248”
A combination of any one of the present compounds 1 to 647 and “α249”
A combination of any one of the present compounds 1 to 647 and “α250”
A combination of any one of the present compounds 1 to 647 and “α251”
A combination of any one of the present compounds 1 to 647 and “α252”
A combination of any one of the present compounds 1 to 647 and “α253”
A combination of any one of the present compounds 1 to 647 and “α254”
A combination of any one of the present compounds 1 to 647 and “α255”
A combination of any one of the present compounds 1 to 647 and “α257”
A combination of any one of the present compounds 1 to 647 and “α258”
A combination of any one of the present compounds 1 to 647 and “α260”
A combination of any one of the present compounds 1 to 647 and “α261”
A combination of any one of the present compounds 1 to 647 and “α262”
A combination of any one of the present compounds 1 to 647 and “α263”
A combination of any one of the present compounds 1 to 647 and “α264”
A combination of any one of the present compounds 1 to 647 and “α265”
A combination of any one of the present compounds 1 to 647 and “α266”
A combination of any one of the present compounds 1 to 647 and “α267”
A combination of any one of the present compounds 1 to 647 and “α274”

(B) The inventive compositions of the following combinations of the present compound and one or more compounds selected from Group A to Group E:

A combination of any one of the present compounds 1 to 647, “α10” and “α145”
A combination of any one of the present compounds 1 to 647, “α10” and “α133”
A combination of any one of the present compounds 1 to 647, “α10” and “α134”
A combination of any one of the present compounds 1 to 647, “α10” and “α132”
A combination of any one of the present compounds 1 to 647, “α10” and “α140”
A combination of any one of the present compounds 1 to 647, “α10” and “α138”
A combination of any one of the present compounds 1 to 647, “α10” and “α135”
A combination of any one of the present compounds 1 to 647, “α10” and “α136”
A combination of any one of the present compounds 1 to 647, “α10” and “α196”
A combination of any one of the present compounds 1 to 647, “α10” and “α139”
A combination of any one of the present compounds 1 to 647, “α10” and “α169”
A combination of any one of the present compounds 1 to 647, “α10” and “α168”
A combination of any one of the present compounds 1 to 647, “α10” and “α172”
A combination of any one of the present compounds 1 to 647, “α10” and “α179”
A combination of any one of the present compounds 1 to 647, “α10” and “α180”
A combination of any one of the present compounds 1 to 647, “α10” and “α206”
A combination of any one of the present compounds 1 to 647, “α10” and “α259”
A combination of any one of the present compounds 1 to 647, “α10” and “α256”
A combination of any one of the present compounds 1 to 647, “α10” and “α200”
A combination of any one of the present compounds 1 to 647, “α10” and “α204”
A combination of any one of the present compounds 1 to 647, “α10” and “α203”
A combination of any one of the present compounds 1 to 647, “α10” and “α205”
A combination of any one of the present compounds 1 to 647, “α10” and “α267”
A combination of any one of the present compounds 1 to 647, “α10” and “α264”
A combination of any one of the present compounds 1 to 647, “α10” and “α49”
A combination of any one of the present compounds 1 to 647, “α10” and “α87”
A combination of any one of the present compounds 1 to 647, “α10” and “α208”
A combination of any one of the present compounds 1 to 647, “α10” and “α207”
A combination of any one of the present compounds 1 to 647, “α10” and “α4”
A combination of any one of the present compounds 1 to 647, “α10” and “α2”
A combination of any one of the present compounds 1 to 647, “α10” and “α3”
A combination of any one of the present compounds 1 to 647, “α10” and “α1”
A combination of any one of the present compounds 1 to 647, “α10” and “α8”
A combination of any one of the present compounds 1 to 647, “α10” and “α180”
A combination of any one of the present compounds 1 to 647, “α10” and “α193”
A combination of any one of the present compounds 1 to 647, “α10” and “α187”
A combination of any one of the present compounds 1 to 647, “α10” and “α260”

A combination of any one of the present compounds 1 to 647, “α10” and “α197”

A combination of any one of the present compounds 1 to 647, “α9” and “α145”
A combination of any one of the present compounds 1 to 647, “α9” and “α133”
A combination of any one of the present compounds 1 to 647, “α9” and “α134”
A combination of any one of the present compounds 1 to 647, “α9” and “α132”
A combination of any one of the present compounds 1 to 647, “α9” and “α140”
A combination of any one of the present compounds 1 to 647, “α9” and “α138”
A combination of any one of the present compounds 1 to 647, “α9” and “α135”
A combination of any one of the present compounds 1 to 647, “α9” and “α136”
A combination of any one of the present compounds 1 to 647, “α9” and “α196”
A combination of any one of the present compounds 1 to 647, “α9” and “α139”
A combination of any one of the present compounds 1 to 647, “α9” and “α207”
A combination of any one of the present compounds 1 to 647, “α9” and “α168”
A combination of any one of the present compounds 1 to 647, “α9” and “α172”
A combination of any one of the present compounds 1 to 647, “α9” and “α179”
A combination of any one of the present compounds 1 to 647, “α9” and “α180”
A combination of any one of the present compounds 1 to 647, “α9” and “α206”
A combination of any one of the present compounds 1 to 647, “α9” and “α259”
A combination of any one of the present compounds 1 to 647, “α9” and “α256”
A combination of any one of the present compounds 1 to 647, “α9” and “α200”
A combination of any one of the present compounds 1 to 647, “α9” and “204”
A combination of any one of the present compounds 1 to 647, “α9” and “α203”
A combination of any one of the present compounds 1 to 647, “α9” and “α205”
A combination of any one of the present compounds 1 to 647, “α9” and “α267”
A combination of any one of the present compounds 1 to 647, “α9” and “α264”
A combination of any one of the present compounds 1 to 647, “α9” and “α49”
A combination of any one of the present compounds 1 to 647, “α9” and “α87”
A combination of any one of the present compounds 1 to 647, “α9” and “α208”
A combination of any one of the present compounds 1 to 647, “α9” and “α207”
A combination of any one of the present compounds 1 to 647, “α9” and “α4”
A combination of any one of the present compounds 1 to 647, “α9” and “α2”
A combination of any one of the present compounds 1 to 647, “α9” and “α3”
A combination of any one of the present compounds 1 to 647, “α9” and “α1”
A combination of any one of the present compounds 1 to 647, “α9” and “α8”
A combination of any one of the present compounds 1 to 647, “α9” and “α175”
A combination of any one of the present compounds 1 to 647, “α9” and “α193”
A combination of any one of the present compounds 1 to 647, “α9” and “α187”
A combination of any one of the present compounds 1 to 647, “α9” and “α260”
A combination of any one of the present compounds 1 to 647, “α9” and “α197”
A combination of any one of the present compounds 1 to 647, “α11” and “α145”
A combination of any one of the present compounds 1 to 647, “α11” and “α133”
A combination of any one of the present compounds 1 to 647, “α11” and “α134”
A combination of any one of the present compounds 1 to 647, “α11” and “α132”
A combination of any one of the present compounds 1 to 647, “α11” and “α140”
A combination of any one of the present compounds 1 to 647, “α11” and “α138”
A combination of any one of the present compounds 1 to 647, “α11” and “α135”
A combination of any one of the present compounds 1 to 647, “α11” and “α136”
A combination of any one of the present compounds 1 to 647, “α11” and “α196”
A combination of any one of the present compounds 1 to 647, “α11” and “α139”
A combination of any one of the present compounds 1 to 647, “α11” and “α169”
A combination of any one of the present compounds 1 to 647, “α11” and “α168”
A combination of any one of the present compounds 1 to 647, “α11” and “α172”
A combination of any one of the present compounds 1 to 647, “α11” and “α179”
A combination of any one of the present compounds 1 to 647, “α11” and “α180”
A combination of any one of the present compounds 1 to 647, “α11” and “α206”
A combination of any one of the present compounds 1 to 647, “α11” and “α259”
A combination of any one of the present compounds 1 to 647, “α11” and “α256”
A combination of any one of the present compounds 1 to 647, “α11” and “α200”
A combination of any one of the present compounds 1 to 647, “α11” and “α204”
A combination of any one of the present compounds 1 to 647, “α11” and “α203”
A combination of any one of the present compounds 1 to 647, “α11” and “α205”
A combination of any one of the present compounds 1 to 647, “α11” and “α267”
A combination of any one of the present compounds 1 to 647, “α11” and “α264”
A combination of any one of the present compounds 1 to 647, “α11” and “α49”
A combination of any one of the present compounds 1 to 647, “α11” and “α87”
A combination of any one of the present compounds 1 to 647, “α11” and “α208”
A combination of any one of the present compounds 1 to 647, “α11” and “α207”
A combination of any one of the present compounds 1 to 647, “α11” and “α4”
A combination of any one of the present compounds 1 to 647, “α11” and “α2”
A combination of any one of the present compounds 1 to 647, “α11” and “α3”
A combination of any one of the present compounds 1 to 647, “α11” and “α1”
A combination of any one of the present compounds 1 to 647, “α11” and “α8”
A combination of any one of the present compounds 1 to 647, “α11” and “α175”
A combination of any one of the present compounds 1 to 647, “α11” and “α193”
A combination of any one of the present compounds 1 to 647, “α11” and “α187”
A combination of any one of the present compounds 1 to 647, “α11” and “α260”
A combination of any one of the present compounds 1 to 647, “α11” and “α197”
A combination of any one of the present compounds 1 to 647, “α20” and “α145”
A combination of any one of the present compounds 1 to 647, “α20” and “α133”
A combination of any one of the present compounds 1 to 647, “α20” and “α134”
A combination of any one of the present compounds 1 to 647, “α20” and “α132”
A combination of any one of the present compounds 1 to 647, “α20” and “αα140”
A combination of any one of the present compounds 1 to 647, “α20” and “α138”
A combination of any one of the present compounds 1 to 647, “α20” and “α135”
A combination of any one of the present compounds 1 to 647, “α20” and “α136”
A combination of any one of the present compounds 1 to 647, “α20” and “α196”
A combination of any one of the present compounds 1 to 647, “α20” and “α139”
A combination of any one of the present compounds 1 to 647, “α20” and “α169”
A combination of any one of the present compounds 1 to 647, “α20” and “α168”
A combination of any one of the present compounds 1 to 647, “α20” and “α172”
A combination of any one of the present compounds 1 to 647, “α20” and “α179”
A combination of any one of the present compounds 1 to 647, “α20” and “α180”
A combination of any one of the present compounds 1 to 647, “α20” and “α206”
A combination of any one of the present compounds 1 to 647, “α20” and “α259”
A combination of any one of the present compounds 1 to 647, “α20” and “α256”
A combination of any one of the present compounds 1 to 647, “α20” and “α200”
A combination of any one of the present compounds 1 to 647, “α20” and “α204”
A combination of any one of the present compounds 1 to 647, “α20” and “α203”
A combination of any one of the present compounds 1 to 647, “α20” and “α205”
A combination of any one of the present compounds 1 to 647, “α20” and “α267”
A combination of any one of the present compounds 1 to 647, “α20” and “α264”
A combination of any one of the present compounds 1 to 647, “α20” and “α49”
A combination of any one of the present compounds 1 to 647, “α20” and “α87”
A combination of any one of the present compounds 1 to 647, “α20” and “α208”
A combination of any one of the present compounds 1 to 647, “α20” and “α207”
A combination of any one of the present compounds 1 to 647, “α20” and “α4”
A combination of any one of the present compounds 1 to 647, “α20” and “α2”
A combination of any one of the present compounds 1 to 647, “α20” and “α3”
A combination of any one of the present compounds 1 to 647, “α20” and “α1”
A combination of any one of the present compounds 1 to 647, “α20” and “α8”
A combination of any one of the present compounds 1 to 647, “α49” and “α145”
A combination of any one of the present compounds 1 to 647, “α49” and “α133”
A combination of any one of the present compounds 1 to 647, “α49” and “α134”
A combination of any one of the present compounds 1 to 647, “α49” and “α132”
A combination of any one of the present compounds 1 to 647, “α49” and “α140”
A combination of any one of the present compounds 1 to 647, “α49” and “α138”
A combination of any one of the present compounds 1 to 647, “α49” and “α135”
A combination of any one of the present compounds 1 to 647, “α49” and “α136”
A combination of any one of the present compounds 1 to 647, “α49” and “α196”
A combination of any one of the present compounds 1 to 647, “α49” and “α139”
A combination of any one of the present compounds 1 to 647, “α49” and “169”
A combination of any one of the present compounds 1 to 647, “α49” and “α168”
A combination of any one of the present compounds 1 to 647, “α49” and “α172”
A combination of any one of the present compounds 1 to 647, “α49” and “α179”
A combination of any one of the present compounds 1 to 647, “α49” and “α180”
A combination of any one of the present compounds 1 to 647, “α49” and “α206”
A combination of any one of the present compounds 1 to 647, “α49” and “α259”
A combination of any one of the present compounds 1 to 647, “α49” and “α256”
A combination of any one of the present compounds 1 to 647, “α49” and “α200”
A combination of any one of the present compounds 1 to 647, “α49” and “α204”
A combination of any one of the present compounds 1 to 647, “α49” and “α203”
A combination of any one of the present compounds 1 to 647, “α49” and “α205”
A combination of any one of the present compounds 1 to 647, “α49” and “α267”
A combination of any one of the present compounds 1 to 647, “α49” and “α264”
A combination of any one of the present compounds 1 to 647, “α49” and “α87”
A combination of any one of the present compounds 1 to 647, “α49” and “α208”
A combination of any one of the present compounds 1 to 647, “α49” and “α207”
A combination of any one of the present compounds 1 to 647, “α49” and “α4”
A combination of any one of the present compounds 1 to 647, “α49” and “α2”
A combination of any one of the present compounds 1 to 647, “α4 9” and “α3”
A combination of any one of the present compounds 1 to 647, “α49” and “α1”
A combination of any one of the present compounds 1 to 647, “α49” and “48”
A combination of any one of the present compounds 1 to 647, “α87” and “α145”
A combination of any one of the present compounds 1 to 647, “α87” and “α133”
A combination of any one of the present compounds 1 to 647, “α87” and “α134”
A combination of any one of the present compounds 1 to 647, “α87” and “α132”
A combination of any one of the present compounds 1 to 647, “α87” and “α140”
A combination of any one of the present compounds 1 to 647, “α87” and “α138”
A combination of any one of the present compounds 1 to 647, “α87” and “α135”
A combination of any one of the present compounds 1 to 647, “α87” and “α136”
A combination of any one of the present compounds 1 to 647, “α87” and “α196”
A combination of any one of the present compounds 1 to 647, “α87” and “α139”
A combination of any one of the present compounds 1 to 647, “α87” and “α169”
A combination of any one of the present compounds 1 to 647, “α87” and “α168”
A combination of any one of the present compounds 1 to 647, “α87” and “α172”
A combination of any one of the present compounds 1 to 647, “α87” and “α179”
A combination of any one of the present compounds 1 to 647, “α87” and “α180”
A combination of any one of the present compounds 1 to 647, “α87” and “α206”
A combination of any one of the present compounds 1 to 647, “α87” and “α259”
A combination of any one of the present compounds 1 to 647, “α87” and “α256”
A combination of any one of the present compounds 1 to 647, “α87” and “α200”
A combination of any one of the present compounds 1 to 647, “α87” and “α204”
A combination of any one of the present compounds 1 to 647, “α87” and “α203”
A combination of any one of the present compounds 1 to 647, “α87” and “α205”
A combination of any one of the present compounds 1 to 647, “α87” and “α267”
A combination of any one of the present compounds 1 to 647, “α87” and “α264”
A combination of any one of the present compounds 1 to 647, “α87” and “α208”
A combination of any one of the present compounds 1 to 647, “α87” and “α207”
A combination of any one of the present compounds 1 to 647, “α87” and “α4”
A combination of any one of the present compounds 1 to 647, “α87” and “α2”
A combination of any one of the present compounds 1 to 647, “α87” and “α3”
A combination of any one of the present compounds 1 to 647, “α87” and “dl”
A combination of any one of the present compounds 1 to 647, “α87” and “α8”
A combination of any one of the present, compounds 1 to 647, “α87” and “α197”
A combination of any one of the present compounds 1 to 647, “α179” and “α145”
A combination of any one of the present compounds 1 to 647, “α179” and “α133”
A combination of any one of the present compounds 1 to 647, “α179” and “α134”
A combination of any one of the present compounds 1 to 647, “α179” and “α132”
A combination of any one of the present compounds 1 to 647, “α179” and “α140”
A combination of any one of the present compounds 1 to 647, “α179” and “α138”
A combination of any one of the present compounds 1 to 647, “α179” and “α135”
A combination of any one of the present compounds 1 to 647, “α179” and “α136”
A combination of any one of the present compounds 1 to 647, “α179” and “α196”
A combination of any one of the present compounds 1 to 647, “α179” and “α139”
A combination of any one of the present compounds 1 to 647, “α179” and “α169”
A combination of any one of the present compounds 1 to 647, “α179” and “α168”
A combination of any one of the present compounds 1 to 647, “α179” and “α172”
A combination of any one of the present compounds 1 to 647, “α179” and “α206”
A combination of any one of the present compounds 1 to 647, “α179” and “α259”
A combination of any one of the present compounds 1 to 647, “α179” and “α200”
A combination of any one of the present compounds 1 to 647, “α179” and “α204”
A combination of any one of the present compounds 1 to 647, “α179” and “α203”
A combination of any one of the present compounds 1 to 647, “α179” and “α205”
A combination of any one of the present compounds 1 to 647, “α179” and “α267”
A combination of any one of the present compounds 1 to 647, “α179” and “α264”
A combination of any one of the present compounds 1 to 647, “α179” and “α208”
A combination of any one of the present compounds 1 to 647, “α179” and “α207”
A combination of any one of the present compounds 1 to 647, “α179” and “α4”
A combination of any one of the present compounds 1 to 647, “α179” and “α2”
A combination of any one of the present compounds 1 to 647, “α179” and “α3”
A combination of any one of the present compounds 1 to 647, “α179” and “α1”
A combination of any one of the present compounds 1 to 647, “α179” and “α8”
A combination of any one of the present compounds 1 to 647, “α179” and “α197”
A combination of any one of the present compounds 1 to 647, “α180” and “α145”
A combination of any one of the present compounds 1 to 647, “α180” and “α133”
A combination of any one of the present compounds 1 to 647, “α180” and “α134”
A combination of any one of the present compounds 1 to 647, “α180” and “α132”
A combination of any one of the present compounds 1 to 647, “α180” and “α140”
A combination of any one of the present compounds 1 to 647, “α180” and “α138”
A combination of any one of the present compounds 1 to 647, “α180” and “α135”
A combination of any one of the present compounds 1 to 647, “α180” and “α136”
A combination of any one of the present compounds 1 to 647, “α180” and “α196”
A combination of any one of the present compounds 1 to 647, “α180” and “α139”
A combination of any one of the present compounds 1 to 647, “α180” and “α169”
A combination of any one of the present compounds 1 to 647, “α180” and “α168”
A combination of any one of the present compounds 1 to 647, “α180” and “α172”
A combination of any one of the present compounds 1 to 647, “α180” and “α206”
A combination of any one of the present compounds 1 to 647, “α180” and “α259”
A combination of any one of the present compounds 1 to 647, “α180” and “α200”
A combination of any one of the present compounds 1 to 647, “α180” and “α204”
A combination of any one of the present compounds 1 to 647, “α180” and “α203”
A combination of any one of the present compounds 1 to 647, “α180” and “α205”
A combination of any one of the present compounds 1 to 647, “α180” and “α267”
A combination of any one of the present compounds 1 to 647, “α180” and “α264”
A combination of any one of the present compounds 1 to 647, “α180” and “α208”
A combination of any one of the present compounds 1 to 647, “α180” and “α207”
A combination of any one of the present compounds 1 to 647, “α180” and “α4”
A combination of any one of the present compounds 1 to 647, “α180” and “α2”
A combination of any one of the present compounds 1 to 647, “α180” and “α3”
A combination of any one of the present compounds 1 to 647, “α180” and “α1”
A combination of any one of the present compounds 1 to 647, “α180” and “α8”
A combination of any one of the present compounds 1 to 647, “α180” and “α197”
A combination of any one of the present compounds 1 to 647, “α206” and “α145”
A combination of any one of the present compounds 1 to 647, “α206” and “α133”
A combination of any one of the present compounds 1 to 647, “α206” and “α134”
A combination of any one of the present compounds 1 to 647, “α206” and “α132”
A combination of any one of the present compounds 1 to 647, “α206” and “α140”
A combination of any one of the present compounds 1 to 647, “α206” and “α138”
A combination of any one of the present compounds 1 to 647, “α206” and “α135”
A combination of any one of the present compounds 1 to 647, “α206” and “α136”
A combination of any one of the present compounds 1 to 647, “α206” and “α196”
A combination of any one of the present compounds 1 to 647, “α206” and “α139”
A combination of any one of the present compounds 1 to 647, “α206” and “α169”
A combination of any one of the present compounds 1 to 647, “α206” and “α168”
A combination of any one of the present compounds 1 to 647, “α206” and “α172”
A combination of any one of the present compounds 1 to 647, “α206” and “α259”
A combination of any one of the present compounds 1 to 647, “α206” and “α200”
A combination of any one of the present compounds 1 to 647, “α206” and “α204”
A combination of any one of the present compounds 1 to 647, “α206” and “α203”
A combination of any one of the present compounds 1 to 647, “α206” and “α205”
A combination of any one of the present compounds 1 to 647, “α206” and “267”
A combination of any one of the present compounds 1 to 647, “α206” and “α264”
A combination of any one of the present compounds 1 to 647, “α206” and “α208”
A combination of any one of the present compounds 1 to 647, “α206” and “α207”
A combination of any one of the present compounds 1 to 647, “α206” and “α4”
A combination of any one of the present compounds 1 to 647, “α206” and “α2”
A combination of any one of the present compounds 1 to 647, “α206” and “α3”
A combination of any one of the present compounds 1 to 647, “α206” and “α1”
A combination of any one of the present compounds 1 to 647, “α206” and “α8”
A combination of any one of the present compounds 1 to 647, “α206” and “α197”
A combination of any one of the present compounds 1 to 647, “α145” and “α169”
A combination of any one of the present compounds 1 to 647, “α145” and “α168”
A combination of any one of the present compounds 1 to 647, “α145” and “α172”
A combination of any one of the present compounds 1 to 647, “α145” and “α259”
A combination of any one of the present compounds 1 to 647, “α145” and “α200”
A combination of any one of the present compounds 1 to 647, “α145” and “α204”
A combination of any one of the present compounds 1 to 647, “α145” and “α203”
A combination of any one of the present compounds 1 to 647, “α145” and “α205”
A combination of any one of the present compounds 1 to 647, “α145” and “α9”
A combination of any one of the present compounds 1 to 647, “α145” and “α264”
A combination of any one of the present compounds 1 to 647, “α145” and “α208”
A combination of any one of the present compounds 1 to 647, “α145” and “α207”
A combination of any one of the present compounds 1 to 647, “α145” and “α4”
A combination of any one of the present compounds 1 to 647, “α145” and “α2”
A combination of any one of the present compounds 1 to 647, “α145” and “α3”
A combination of any one of the present compounds 1 to 647, “α145” and “α1”
A combination of any one of the present compounds 1 to 647, “α145” and “α8”
A combination of any one of the present compounds 1 to 647, “α133” and “α169”
A combination of any one of the present compounds 1 to 647, “α133” and “α168”
A combination of any one of the present compounds 1 to 647, “α133” and “α172”
A combination of any one of the present compounds 1 to 647, “α133” and “α259”
A combination of any one of the present compounds 1 to 647, “α133” and “α200”
A combination of any one of the present compounds 1 to 647, “α133” and “α204”
A combination of any one of the present compounds 1 to 647, “α133” and “α203”
A combination of any one of the present compounds 1 to 647, “α133” and “α205”
A combination of any one of the present compounds 1 to 647, “α133” and “α267”
A combination of any one of the present compounds 1 to 647, “α133” and “α264”
A combination of any one of the present compounds 1 to 647, “α133” and “α208”
A combination of any one of the present compounds 1 to 647, “α133” and “α207”
A combination of any one of the present compounds 1 to 647, “α133” and “α4”
A combination of any one of the present compounds 1 to 647, “α133” and “α2”
A combination of any one of the present compounds 1 to 647, “α133” and “α3”
A combination of any one of the present compounds 1 to 647, “α133” and “α1”
A combination of any one of the present compounds 1 to 647, “α133” and “α8”
A combination of any one of the present compounds 1 to 647, “α132” and “α169”
A combination of any one of the present compounds 1 to 647, “α132” and “α168”
A combination of any one of the present compounds 1 to 647, “α132” and “α172”
A combination of any one of the present compounds 1 to 647, “α132” and “α259”
A combination of any one of the present compounds 1 to 647, “α132” and “α200”
A combination of any one of the present compounds 1 to 647, “α132” and “α204”
A combination of any one of the present compounds 1 to 647, “α132” and “α203”
A combination of any one of the present compounds 1 to 647, “α132” and “α205”
A combination of any one of the present compounds 1 to 647, “α132” and “α267”
A combination of any one of the present compounds 1 to 647, “α132” and “α264”
A combination of any one of the present compounds 1 to 647, “α132” and “α208”
A combination of any one of the present compounds 1 to 647, “α132” and “α207”
A combination of any one of the present compounds 1 to 647, “α132” and “α4”
A combination of any one of the present compounds 1 to 647, “α132” and “α2”
A combination of any one of the present compounds 1 to 647, “α132” and “α3”
A combination of any one of the present compounds 1 to 647, “α132” and “α1”
A combination of any one of the present compounds 1 to 647, “α132” and “α8”
A combination of any one of the present compounds 1 to 647, “α134” and “α169”
A combination of any one of the present compounds 1 to 647, “α134” and “α168”
A combination of any one of the present compounds 1 to 647, “α134” and “α172”
A combination of any one of the present compounds 1 to 647, “α134” and “α259”
A combination of any one of the present compounds 1 to 647, “α134” and “α200”
A combination of any one of the present compounds 1 to 647, “α134” and “α204”
A combination of any one of the present compounds 1 to 647, “α134” and “α203”
A combination of any one of the present compounds 1 to 647, “α134” and “α205”
A combination of any one of the present compounds 1 to 647, “α134” and “α267”
A combination of any one of the present compounds 1 to 647, “α134” and “α264”
A combination of any one of the present compounds 1 to 647, “α134” and “α208”
A combination of any one of the present compounds 1 to 647, “α134” and “α207”
A combination of any one of the present compounds 1 to 647, “α134” and “α4”
A combination of any one of the present compounds 1 to 647, “α134” and “α2”
A combination of any one of the present compounds 1 to 647, “α134” and “3”
A combination of any one of the present compounds 1 to 647, “α134” and “α1”
A combination of any one of the present compounds 1 to 647, “α134” and “α8”
A combination of any one of the present compounds 1 to 647, “α140” and “α169”
A combination of any one of the present compounds 1 to 647, “α140” and “α168”
A combination of any one of the present compounds 1 to 647, “α140” and “α172”
A combination of any one of the present compounds 1 to 647, “α140” and “α259”
A combination of any one of the present compounds 1 to 647, “α140” and “α200”
A combination of any one of the present compounds 1 to 647, “α140” and “α204”
A combination of any one of the present compounds 1 to 647, “α140” and “α203”
A combination of any one of the present compounds 1 to 647, “α140” and “α205”
A combination of any one of the present compounds 1 to 647, “α140” and “α267”
A combination of any one of the present compounds 1 to 647, “α140” and “α264”
A combination of any one of the present compounds 1 to 647, “α140” and “α208”
A combination of any one of the present compounds 1 to 647, “α140” and “α207”
A combination of any one of the present compounds 1 to 647, “α140” and “α4”
A combination of any one of the present compounds 1 to 647, “α140” and “α2”
A combination of any one of the present compounds 1 to 647, “α140” and “α3”
A combination of any one of the present compounds 1 to 647, “α140” and “α1”
A combination of any one of the present compounds 1 to 647, “α140” and “α8”

### EXAMPLES

Hereinafter, the present invention will be described in more detail by means of Formulation Examples and Test Examples. However, the present invention is not limited to the following Examples. It should be noted that in the following Examples, the term “part(s)” represents part(s) by weight unless otherwise specified.

First, Formulation Examples will be shown.

Table 7 shows specific formulations of the inventive compositions in the following preparation examples. The inventive compositions containing the components in Table 7 are numbered and referred to, for example, as “Inventive Composition 1”. In Table 7, “*” in Component 1 represents one of the present compounds 1 to 647, and the numbers in the square brackets denote parts by weight of the components of the inventive composition (note that, the total parts by weight of the components of the inventive composition is not necessarily 100 parts by weight).

TABLE 7

| No. | Component 1 | Component 2 | Component 3 | Component 4 | Component 5 | Component 6 | Component 7 |
|---|---|---|---|---|---|---|---|
| 1 | *[5] | α10[5] | α256[10] | α1[5] | | | |
| 2 | *[5] | α10[5] | α256[10] | α169[5] | | | |
| 3 | *[5] | α10[5] | α256[10] | α168[10] | | | |
| 4 | *[5] | α10[5] | α256[10] | α172[10] | | | |
| 5 | *[5] | α10[5] | α256[10] | α133[10] | | | |
| 6 | *[5] | α10[5] | α256[10] | α140[10] | | | |
| 7 | *[5] | α10[5] | α256[10] | α135[10] | | | |
| 8 | *[5] | α10[5] | α256[10] | α132[10] | | | |
| 9 | *[5] | α10[5] | α256[10] | α134[10] | | | |
| 10 | *[5] | α10[5] | α256[10] | α145[10] | | | |
| 11 | *[5] | α10[5] | α256[10] | α213[1] | | | |
| 12 | *[5] | α10[5] | α256[10] | α206[4] | | | |
| 13 | *[5] | α10[5] | α256[10] | α208[5] | | | |
| 14 | *[5] | α10[5] | α256[10] | α259[10] | | | |
| 15 | *[5] | α10[5] | α256[10] | α209[10] | | | |
| 16 | *[5] | α10[5] | α256[10] | α199[10] | | | |
| 17 | *[5] | α10[5] | α256[10] | α219[10] | | | |
| 18 | *[5] | α10[5] | α256[10] | α214[10] | | | |
| 19 | *[5] | α10[5] | α179[10] | α1[5] | | | |
| 20 | *[5] | α10[5] | α179[10] | α169[10] | | | |
| 21 | *[5] | α10[5] | α179[10] | α168[10] | | | |
| 22 | *[5] | α10[5] | α179[10] | α172[10] | | | |
| 23 | *[5] | α10[5] | α179[10] | α133[10] | | | |
| 24 | *[5] | α10[5] | α179[10] | α140[10] | | | |
| 25 | *[5] | α10[5] | α179[10] | α135[10] | | | |
| 26 | *[5] | α10[5] | α179[10] | α132[10] | | | |
| 27 | *[5] | α10[5] | α179[10] | α134[10] | | | |
| 28 | *[5] | α10[5] | α179[10] | α145[10] | | | |
| 29 | *[5] | α10[5] | α179[10] | α213[1] | | | |
| 30 | *[5] | α10[5] | α179[10] | α206[4] | | | |
| 31 | *[5] | α10[5] | α179[10] | α209[10] | | | |
| 32 | *[5] | α10[5] | α179[10] | α199[10] | | | |
| 33 | *[5] | α10[5] | α179[10] | α214[10] | | | |
| 34 | *[5] | α10[5] | α180[0.6] | α169[0.4] | | | |
| 35 | *[5] | α10[5] | α180[0.6] | α172[0.4] | | | |
| 36 | *[10] | α10[10] | α180[0.6] | α140[10] | | | |
| 37 | *[10] | α10[10] | α180[0.6] | α135[10] | | | |
| 38 | *[10] | α10[10] | α180[0.6] | α132[10] | | | |
| 39 | *[10] | α10[10] | α180[0.6] | α134[10] | | | |
| 40 | *[10] | α10[10] | α180[0.6] | α145[10] | | | |
| 41 | *[10] | α10[10] | α180[0.6] | α213[1] | | | |
| 42 | *[10] | α10[10] | α180[0.6] | α206[4] | | | |
| 43 | *[10] | α10[10] | α180[0.6] | α206[3.2] | α168[5] | | |
| 44 | *[10] | α10[10] | α180[0.6] | α208[5] | | | |
| 45 | *[10] | α10[10] | α180[0.6] | α259[10] | | | |
| 46 | *[10] | α10[10] | α180[0.6] | α209[10] | | | |
| 47 | *[10] | α10[10] | α180[0.6] | α199[10] | | | |
| 48 | *[10] | α10[10] | α180[0.6] | α214[10] | | | |
| 49 | *[5] | α10[5] | α207[5] | α219[10] | α169[5] | α1[5] | |
| 50 | *[5] | α10[5] | α207[10] | α219[10] | α169[5] | α208[5] | |
| 51 | *[5] | α10[5] | α207[10] | α219[10] | α169[5] | α133[5] | |
| 52 | *[5] | α10[5] | α207[5] | α219[10] | α169[5] | α179[5] | |
| 53 | *[5] | α10[5] | α179[5] | α219[10] | α169[5] | α133[5] | |
| 54 | *[5] | α10[5] | α180[2] | α219[10] | α169[5] | α133[5] | |
| 55 | *[5] | α10[5] | α179[5] | α219[10] | α169[5] | α1[5] | |
| 56 | *[5] | α10[5] | α180[2] | α219[10] | α169[5] | α1[5] | |
| 57 | *[5] | α10[5] | α179[5] | α219[10] | α169[5] | α208[10] | |
| 58 | *[5] | α10[5] | α180[2] | α219[10] | α169[5] | α208[10] | |
| 59 | *[5] | α10[5] | α179[5] | α145[3] | α259[10] | | |
| 60 | *[5] | α10[5] | α179[5] | α259[10] | α172[10] | | |
| 61 | *[5] | α10[5] | α180[2] | α259[10] | α172[10] | | |
| 62 | *[5] | α10[5] | α180[2] | α133[1] | α172[10] | | |
| 63 | *[5] | α10[5] | α180[2] | α172[10] | α1[1] | | |
| 64 | *[5] | α10[5] | α180[2] | α168[10] | α1[1] | | |
| 65 | *[5] | α10[5] | α180[2] | α1[1] | α214[10] | | |
| 66 | *[5] | α10[5] | α180[2] | α208[5] | α172[10] | | |
| 67 | *[5] | α10[5] | α180[2] | α208[5] | α168[10] | | |
| 68 | *[5] | α10[5] | α180[2] | α208[5] | α214[10] | | |
| 69 | *[5] | α10[5] | α179[5] | α207[5] | α172[10] | α1[1] | |
| 70 | *[5] | α10[5] | α179[5] | α207[5] | α168[10] | α1[1] | |
| 71 | *[5] | α10[5] | α180[2] | α145[3] | α259[10] | α1[1] | |
| 72 | *[5] | α10[5] | α180[2] | α145[3] | α208[5] | | |
| 73 | *[10] | α10[20] | α179[3] | α207[0.8] | α219[2] | α169[2] | α133[2] |
| 74 | *[5] | α10[30] | α179[3] | α207[0.8] | α219[2] | α169[2] | α145[2] |
| 75 | *[5] | α10[5] | α180[2] | α207[5] | α219[10] | α169[5] | α133[5] |
| 76 | *[7] | α10[30] | α179[3] | α207[0.8] | α219[1] | α169[1] | α1[1] |
| 77 | *[5] | α10[5] | α180[2] | α207[5] | α219[10] | α169[5] | α1[5] |
| 78 | *[5] | α10[5] | α179[5] | α207[5] | α219[10] | α169[5] | α208[10] |
| 79 | *[5] | α10[5] | α180[2] | α207[5] | α219[10] | α169[5] | α208[10] |
| 80 | *[5] | α10[5] | α179[5] | α133[1] | α207[5] | α1[1] | |
| 81 | *[5] | α10[5] | α133[1] | α207[5] | α1[1] | | |
| 82 | *[5] | α10[5] | α207[5] | α133[10] | α134[10] | | |
| 83 | *[5] | α10[5] | α179[5] | α133[10] | α134[10] | | |
| 84 | *[5] | α10[5] | α180[10] | α133[10] | α134[10] | | |
| 85 | *[5] | α10[5] | α207[10] | α145[10] | α134[10] | | |
| 86 | *[5] | α10[5] | α207[10] | α135[10] | α134[10] | | |
| 87 | *[5] | α10[5] | α207[10] | α132[10] | α134[10] | | |
| 88 | *[5] | α10[5] | α207[10] | α214[10] | α134[10] | | |
| 89 | *[5] | α10[5] | α207[10] | α199[10] | α134[10] | | |
| 90 | *[5] | α10[5] | α207[10] | α203[10] | α134[10] | | |
| 91 | *[5] | α10[5] | α207[10] | α204[10] | α134[10] | | |
| 92 | *[5] | α10[5] | α207[10] | α205[10] | α134[10] | | |
| 93 | *[5] | α10[5] | α207[10] | α202[10] | α134[10] | | |
| 94 | *[5] | α10[5] | α207[5] | α259[10] | α134[10] | | |
| 95 | *[5] | α10[10] | α179[3] | α207[0.8] | α133[2] | α134[2] | |
| 96 | *[5] | α10[10] | α179[3] | α207[0.8] | α145[2] | α134[2] | |
| 97 | *[5] | α10[10] | α179[3] | α207[0.8] | α135[2] | α134[2] | |
| 98 | *[5] | α10[10] | α179[3] | α207[0.8] | α132[2] | α134[2] | |
| 99 | *[5] | α10[10] | α179[3] | α207[0.8] | α214[2] | α134[2] | |
| 100 | *[5] | α10[10] | α179[3] | α207[0.8] | α199[2] | α134[2] | |
| 101 | *[5] | α10[10] | α179[3] | α207[0.8] | α203[2] | α134[2] | |
| 102 | *[5] | α10[10] | α179[3] | α207[0.8] | α204[2] | α134[2] | |
| 103 | *[5] | α10[10] | α179[3] | α207[0.8] | α205[2] | α134[2] | |
| 104 | *[5] | α10[30] | α179[1.5] | α207[0.4] | α202[2] | α134[2] | |
| 105 | *[5] | α10[30] | α179[1.5] | α207[0.4] | α259[2] | α134[2] | |
| 106 | *[5] | α10[5] | α179[5] | α219[10] | α169[5] | α145[10] | |
| 107 | *[5] | α10[5] | α180[10] | α219[10] | α169[5] | α145[10] | |
| 108 | *[5] | α10[5] | α207[5] | α219[10] | α169[5] | α145[10] | |
| 109 | *[5] | α10[5] | α179[5] | α145[10] | α172[10] | | |
| 110 | *[5] | α10[5] | α180[10] | α145[10] | α172[10] | | |
| 111 | *[5] | α10[5] | α207[5] | α145[10] | α172[10] | | |
| 112 | *[5] | α10[5] | α179[5] | α207[10] | α145[10] | α172[10] | |
| 113 | *[5] | α10[5] | α180[10] | α145[10] | α168[10] | | |
| 114 | *[5] | α10[5] | α207[5] | α145[10] | α168[10] | | |
| 115 | *[5] | α10[5] | α179[5] | α207[5] | α145[10] | α168[10] | |
| 116 | *[5] | α10[5] | α179[1] | α133[1] | α1[1] | α199[1] | |
| 117 | *[5] | α10[5] | α179[1] | α133[1] | α1[1] | α203[1] | |
| 118 | *[5] | α10[5] | α179[1] | α133[1] | α1[1] | α204[1] | |
| 119 | *[5] | α10[5] | α179[1] | α133[1] | α1[1] | α205[1] | |
| 120 | *[5] | α10[5] | α179[1] | α133[1] | α1[1] | α202[1] | |
| 121 | *[5] | α10[5] | α179[1] | α133[1] | α1[1] | α268[1] | |
| 122 | *[5] | α10[5] | α179[1] | α133[1] | α1[1] | α218[1] | |
| 123 | *[5] | α10[5] | α179[5] | α133[1] | α1[1] | α200[20] | |
| 124 | *[5] | α10[5] | α179[5] | α133[1] | α1[1] | α196[1] | |
| 125 | *[5] | α10[5] | α179[5] | α133[1] | α1[1] | α206[0.25] | |
| 126 | *[5] | α10[5] | α180[2] | α208[1] | α1[1] | α133[1] | |
| 127 | *[5] | α10[5] | α180[2] | α208[1] | α1[1] | α132[1] | |
| 128 | *[5] | α10[5] | α180[2] | α208[1] | α1[1] | α134[4] | |
| 129 | *[5] | α10[5] | α180[2] | α208[1] | α1[1] | α135[1] | |
| 130 | *[5] | α10[5] | α180[2] | α208[1] | α1[1] | α136[5] | |
| 131 | *[5] | α10[5] | α180[2] | α208[1] | α1[1] | α137[3] | |
| 132 | *[5] | α10[5] | α180[2] | α208[1] | α1[1] | α138[5] | |
| 133 | *[5] | α10[5] | α180[2] | α208[1] | α1[1] | α139[5] | |
| 134 | *[5] | α10[5] | α180[2] | α208[1] | α1[1] | α140[2] | |
| 135 | *[5] | α10[5] | α180[2] | α208[1] | α1[1] | α141[5] | |
| 136 | *[5] | α10[5] | α180[2] | α208[1] | α1[1] | α142[5] | |
| 137 | *[5] | α10[5] | α180[2] | α208[1] | α1[1] | α145[3] | |
| 138 | *[5] | α10[5] | α180[2] | α208[1] | α1[1] | α143[3] | |
| 139 | *[5] | α10[5] | α180[2] | α208[1] | α1[1] | α144[3] | |
| 140 | *[5] | α10[5] | α180[2] | α208[1] | α1[1] | α199[10] | |
| 141 | *[5] | α10[5] | α180[2] | α208[1] | α1[1] | α203[2] | |
| 142 | *[5] | α10[5] | α180[2] | α208[1] | α1[1] | α204[2] | |
| 143 | *[5] | α10[5] | α180[2] | α208[1] | α1[1] | α205[2] | |
| 144 | *[5] | α10[5] | α180[2] | α208[1] | α1[1] | α202[2] | |
| 145 | *[5] | α10[5] | α180[2] | α208[1] | α1[1] | α268[10] | |
| 146 | *[5] | α10[5] | α180[2] | α208[1] | α1[1] | α206[1] | |
| 147 | *[5] | α10[5] | α180[2] | α208[1] | α1[1] | α259[5] | |
| 148 | *[5] | α10[5] | α180[2] | α208[1] | α1[1] | α209[10] | |
| 149 | *[5] | α10[5] | α180[2] | α208[1] | α1[1] | α213[3] | |
| 150 | *[5] | α10[5] | α180[2] | α208[1] | α1[1] | α214[10] | |
| 151 | *[5] | α10[5] | α179[5] | α208[1] | α1[1] | α133[1] | |
| 152 | *[5] | α10[5] | α179[5] | α208[1] | α1[1] | α132[1] | |
| 153 | *[5] | α10[5] | α179[5] | α208[1] | α1[1] | α134[4] | |
| 154 | *[5] | α10[5] | α179[5] | α208[1] | α1[1] | α135[1] | |
| 155 | *[5] | α10[5] | α179[5] | α208[1] | α1[1] | α136[5] | |
| 156 | *[5] | α10[5] | α179[5] | α208[1] | α1[1] | α137[3] | |
| 157 | *[5] | α10[5] | α179[5] | α208[1] | α1[1] | α138[5] | |
| 158 | *[5] | α10[5] | α179[5] | α208[1] | α1[1] | α139[5] | |
| 159 | *[5] | α10[5] | α179[5] | α208[1] | α1[1] | α140[2] | |
| 160 | *[5] | α10[5] | α179[5] | α208[1] | α1[1] | α141[5] | |
| 161 | *[5] | α10[5] | α179[5] | α208[1] | α1[1] | α142[5] | |
| 162 | *[5] | α10[5] | α179[5] | α208[1] | α1[1] | α145[3] | |
| 163 | *[5] | α10[5] | α179[5] | α208[1] | α1[1] | α143[3] | |
| 164 | *[5] | α10[5] | α179[5] | α208[1] | α1[1] | α144[3] | |
| 165 | *[5] | α10[5] | α179[5] | α208[1] | α1[1] | α199[10] | |
| 166 | *[5] | α10[5] | α179[5] | α208[1] | α1[1] | α203[2] | |
| 167 | *[5] | α10[5] | α179[5] | α208[1] | α1[1] | α204[2] | |
| 168 | *[5] | α10[5] | α179[5] | α208[1] | α1[1] | α205[2] | |
| 169 | *[5] | α10[5] | α179[5] | α208[1] | α1[1] | α202[2] | |
| 170 | *[5] | α10[5] | α179[5] | α208[1] | α1[1] | α268[10] | |
| 171 | *[5] | α10[5] | α179[5] | α208[1] | α1[1] | α206[1] | |
| 172 | *[5] | α10[5] | α179[5] | α208[1] | α1[1] | α259[5] | |
| 173 | *[5] | α10[5] | α179[5] | α208[1] | α1[1] | α209[10] | |
| 174 | *[5] | α10[5] | α179[5] | α208[1] | α1[1] | α213[3] | |
| 175 | *[5] | α10[5] | α179[5] | α208[1] | α1[1] | α214[10] | |
| 176 | *[5] | α10[5] | α180[2] | α208[1] | α1 [1] | α133[1] | α186[5] |
| 177 | *[5] | α10[5] | α180[2] | α208[1] | α1 [1] | α133[1] | α271[10] |
| 178 | *[5] | α10[5] | α180[2] | α208[1] | α1 [1] | α133[1] | α177[5] |
| 179 | *[5] | α10[5] | α180[2] | α208[1] | α1 [1] | α133[1] | α272[5] |
| 180 | *[5] | α10[5] | α180[2] | α208[1] | α1 [1] | α133[1] | α273[5] |
| 181 | *[5] | α10[5] | α179[5] | α208[1] | α1 [1] | α133[1] | α186[5] |
| 182 | *[5] | α10[5] | α179[5] | α208[1] | α1 [1] | α133[1] | α271[10] |
| 183 | *[5] | α10[5] | α179[5] | α208[1] | α1 [1] | α133[1] | α177[5] |
| 184 | *[5] | α10[5] | α179[5] | α208[1] | α1 [1] | α133[1] | α272[5] |
| 185 | *[5] | α10[5] | α179[5] | α208[1] | α1 [1] | α133[1] | α273[5] |
| 186 | *[10] | α10[10] | α179[0.5] | α145[0.5] | α208[0.5] | α199[3.5] | |
| 187 | *[10] | α10[10] | α179[0.5] | α145[0.5] | α208[0.5] | α203[2] | |
| 188 | *[10] | α10[10] | α179[0.5] | α145[0.5] | α208[0.5] | α204[2] | |
| 189 | *[10] | α10[10] | α179[0.5] | α145[0.5] | α208[0.5] | α205[2] | |
| 190 | *[10] | α10[10] | α179[0.5] | α145[0.5] | α208[0.5] | α202[2] | |
| 191 | *[5] | α10[5] | α179[5] | α133[1] | α207[5] | α208[1] | α168[0.5] |
| 192 | *[5] | α10[5] | α179[5] | α133[1] | α207[5] | α208[1] | α174[0.5] |
| 193 | *[5] | α10[5] | α179[5] | α133[1] | α207[5] | α208[1] | α172[1] |
| 194 | *[5] | α10[5] | α179[5] | α133[1] | α207[5] | α208[1] | α169[1] |
| 195 | *[5] | α10[5] | α179[5] | α133[1] | α207[5] | α208[1] | α175[2] |
| 196 | *[5] | α10[5] | α179[5] | α133[1] | α207[5] | α208[1] | α199[10] |
| 197 | *[5] | α10[5] | α179[5] | α133[1] | α207[5] | α208[1] | α203[2] |
| 198 | *[5] | α10[5] | α179[5] | α133[1] | α207[5] | α208[1] | α204[2] |
| 199 | *[5] | α10[5] | α179[5] | α133[1] | α207[5] | α208[1] | α205[2] |
| 200 | *[5] | α10[5] | α179[5] | α133[1] | α207[5] | α208[1] | α202[2] |
| 201 | *[5] | α10[5] | α179[5] | α133[1] | α207[5] | α208[1] . | α268[3] |
| 202 | *[5] | α10[5] | α179[5] | α133[1] | α207[5] | α208[1] | α206[0.5] |
| 203 | *[5] | α10[5] | α179[5] | α133[1] | α207[5] | α208[1] | α259[10] |
| 204 | *[5] | α10[5] | α179[5] | α133[1] | α207[5] | α208[1] | α209[3] |
| 205 | *[5] | α10[5] | α179[5] | α133[1] | α207[5] | α208[1] | α213[1] |
| 206 | *[5] | α10[5] | α179[5] | α133[1] | α207[5] | α208[1] | α214[2] |
| 207 | *[5] | α10[5] | α179[5] | α207[5] | α145[10] | α2[1] | |
| 208 | *[5] | α10[5] | α180[5] | α207[5] | α145[10] | α2[1] | |
| 209 | *[5] | α10[5] | α179[5] | α207[5] | α133[10] | α2[1] | |
| 210 | *[5] | α10[5] | α180[5] | α207[5] | α133[10] | α2[1] | |
| 211 | *[5] | α10[5] | α179[5] | α207[5] | α208[1] | α2[1] | |
| 212 | *[5] | α10[5] | α180[5] | α207[5] | α208[1] | α2[1] | |
| 213 | *[5] | α10[5] | α179[5] | α207[5] | α1 [1] | α2[1] | |
| 214 | *[5] | α10[5] | α180[5] | α207[5] | α1 [1] | α2[1] | |
| 215 | *[5] | α10[5] | α179[5] | α207[5] | α8[5] | α2[1] | |
| 216 | *[5] | α10[5] | α180[5] | α207[5] | α8[5] | α2[1] | |
| 217 | *[5] | α10[5] | α179[5] | α207[5] | α145[10] | α3[1] | |
| 218 | *[5] | α10[5] | α180[5] | α207[5] | α145[10] | α3[1] | |
| 219 | *[5] | α10[5] | α179[5] | α207[5] | α133[10] | α3[1] | |
| 220 | *[5] | α10[5] | α180[5] | α207[5] | α133[10] | α3[1] | |
| 221 | *[5] | α10[5] | α179[5] | α207[5] | α208[1] | α3[1] | |
| 222 | *[5] | α10[5] | α180[5] | α207[5] | α208[1] | α3[1] | |
| 223 | *[5] | α10[5] | α179[5] | α207[5] | α1 [1] | α3[1] | |
| 224 | *[5] | α10[5] | α180[5] | α207[5] | α1 [1] | α3[1] | |
| 225 | *[5] | α10[5] | α179[5] | α207[5] | α8[5] | α3[1] | |
| 226 | *[5] | α10[5] | α180[5] | α207[5] | α206[4] | α3[1] | |
| 227 | *[5] | α10[5] | α180[5] | α207[5] | α8[5] | α3[1] | |
| 228 | *[5] | α10[5] | α179[5] | α207[5] | α208[1] | α4[1] | |
| 229 | *[5] | α10[5] | α180[5] | α207[5] | α133[10] | α4[1] | |
| 230 | *[5] | α10[5] | α180[5] | α207[5] | α4[1] | α8[5] | |
| 231 | *[5] | α10[5] | α180[5] | α207[5] | α4[1] | α1[1] | |
| 232 | *[5] | α10[5] | α179[5] | α207[5] | α145[10] | α4[1] | |
| 233 | *[5] | α10[5] | α179[5] | α207[5] | α4[1] | α8[5] | |
| 234 | *[5] | α10[5] | α180[2] | α133[1] | α8[0.5] | | |
| 235 | *[5] | α10[5] | α179[5] | α133[10] | α8[5] | | |
| 236 | *[5] | α10[5] | α179[5] | α207[5] | α133[10] | α8[5] | |
| 237 | *[5] | α10[5] | α179[5] | α207[5] | α8[5] | α145[10] | |
| 238 | *[5] | α10[5] | α179[5] | α207[5] | α8[5] | α134[10] | |
| 239 | *[5] | α10[5] | α179[5] | α207[5] | α8[5] | α135[10] | |
| 240 | *[5] | α10[5] | α179[5] | α207[5] | α8[5] | α132[10] | |
| 241 | *[5] | α10[5] | α179[5] | α207[5] | α8[5] | α214[10] | |
| 242 | *[5] | α10[5] | α179[5] | α207[5] | α8[5] | α199[10] | |
| 243 | *[5] | α10[5] | α179[5] | α207[5] | α8[5] | α259[10] | |
| 244 | *[5] | α10[5] | α207[5] | α145[10] | α8[5] | | |
| 245 | *[5] | α10[5] | α207[5] | α134[10] | α8[5] | | |
| 246 | *[5] | α10[5] | α207[5] | α135[10] | α8[5] | | |
| 247 | *[5] | α10[5] | α207[5] | α132[10] | α8[5] | | |
| 248 | *[5] | α10[5] | α207[5] | α214[10] | α8[5] | | |
| 249 | *[5] | α10[5] | α207[5] | α199[10] | α8[5] | | |
| 250 | *[5] | α10[5] | α207[5] | α259[10] | α8[5] | | |
| 251 | *[5] | α10[5] | α179[10] | α206[4] | α8[5] | α168[10] | α140[10] |
| 252 | *[5] | α10[5] | α179[10] | α206[4] | α8[5] | α169[5] | α140[10] |
| 253 | *[5] | α10[5] | α179[10] | α206[4] | α8[5] | α172[10] | α140[10] |
| 254 | *[5] | α10[5] | α179[10] | α206[4] | α8[5] | α174[5] | α140[10] |
| 255 | *[5] | α10[5] | α179[10] | α206[4] | α8[5] | α168[10] | α135[10] |
| 256 | *[5] | α10[5] | α179[10] | α206[4] | α8[5] | α169[5] | α135[10] |
| 257 | *[5] | α10[5] | α179[10] | α206[4] | α8[5] | α172[10] | α135[10] |
| 258 | *[5] | α10[5] | α179[10] | α206[4] | α8[5] | α174[5] | α135[10] |
| 259 | *[5] | α10[5] | α179[10] | α206[4] | α8[5] | α168[10] | α132[10] |
| 260 | *[5] | α10[5] | α179[10] | α206[4] | α8[5] | α169[5] | α132[10] |
| 261 | *[5] | α10[5] | α179[10] | α206[4] | α8[5] | α172[10] | α132[10] |
| 262 | *[5] | α10[5] | α179[10] | α206[4] | α8[5] | α174[5] | α132[10] |
| 263 | *[5] | α10[5] | α179[10] | α206[4] | α8[5] | α168[10] | α134[10] |
| 264 | *[5] | α10[5] | α179[10] | α206[4] | α8[5] | α169[5] | α134[10] |
| 265 | *[5] | α10[5] | α179[10] | α206[4] | α8[5] | α172[10] | α134[10] |
| 266 | *[5] | α10[5] | α179[10] | α206[4] | α8[5] | α174[5] | α134[10] |
| 267 | *[10] | α10[10] | α180[0.6] | α206[3.2] | α8[5] | α168[10] | α140[10] |
| 268 | *[10] | α10[10] | α180[0.6] | α206[3.2] | α8[5] | α169[5] | α140[10] |
| 269 | *[10] | α10[10] | α180[0.6] | α206[3.2] | α8[5] | α172[10] | α140[10] |
| 270 | *[10] | α10[10] | α180[0.6] | α206[3.2] | α8[5] | α174[5] | α140[10] |
| 271 | *[10] | α10[10] | α180[0.6] | α206[3.2] | α8[5] | α168[10] | α135[10] |
| 272 | *[10] | α10[10] | α180[0.6] | α206[3.2] | α8[5] | α169[5] | α135[10] |
| 273 | *[10] | α10[10] | α180[0.6] | α206[3.2] | α8[5] | α172[10] | α135[10] |
| 274 | *[10] | α10[10] | α180[0.6] | α206[3.2] | α8[5] | α174[5] | α135[10] |
| 275 | *[10] | α10[10] | α180[0.6] | α206[3.2] | α8[5] | α168[10] | α132[10] |
| 276 | *[10] | α10[10] | α180[0.6] | α206[3.2] | α8[5] | α169[5] | α132[10] |
| 277 | *[10] | α10[10] | α180[0.6] | α206[3.2] | α8[5] | α172[10] | α132[10] |
| 278 | *[10] | α10[10] | α180[0.6] | α206[3.2] | α8[5] | α174[5] | α132[10] |
| 279 | *[10] | α10[10] | α180[0.6] | α206[3.2] | α8[5] | α168[10] | α134[10] |
| 280 | *[10] | α10[10] | α180[0.6] | α206[3.2] | α8[5] | α169[5] | α134[10] |
| 281 | *[10] | α10[10] | α180[0.6] | α206[3.2] | α8[5] | α172[10] | α134[10] |
| 282 | *[10] | α10[10] | α180[0.6] | α206[3.2] | α8[5] | α174[5] | α134[10] |
| 283 | *[1.5] | α10[1.5] | α58[3] | α197[4] | α260[3] | | |
| 284 | *[1.5] | α10[1.5] | α58[3] | α197[4] | α187[10] | | |
| 285 | *[1.5] | α10[1.5] | α58[3] | α197[4] | α193[2] | | |
| 286 | *[1.5] | α10[1.5] | α58[3] | α197[4] | α188[2] | | |
| 287 | *[1.5] | α43[1] | α197[4] | α260[3] | | | |
| 288 | *[1.5] | α10[1.5] | α175[7] | α197[4] | α260[3] | | |
| 289 | *[1.5] | α10[1.5] | α175[7] | α197[4] | α187[10] | | |
| 290 | *[1.5] | α10[1.5] | α175[7] | α197[4] | α193[2] | | |
| 291 | *[1.5] | α10[1.5] | α175[7] | α197[4] | α188[2] | | |
| 292 | *[1.5] | α58[3] | α197[4] | α260[3] | | | |
| 293 | *[1.5] | α58[3] | α197[4] | α187[10] | | | |
| 294 | *[1.5] | α58[3] | α197[4] | α193[2] | | | |
| 295 | *[1.5] | α58[3] | α197[4] | α188[2] | | | |
| 296 | *[1.5] | α98[4] | α189[4] | | | | |
| 297 | *[1.5] | α43[1] | α197[4] | α188[2] | | | |
| 298 | *[10] | α43[10] | α169[9] | α213[1] | α205[0.2] | | |
| 299 | *[10] | α199[10] | α259[10] | | | | |
| 300 | *[10] | α169[10] | α205[10] | | | | |
| 301 | *[10] | α270[10] | α206[10] | α40[10] | | | |
| 302 | *[10] | α270[10] | α206[10] | α134[2] | | | |
| 303 | *[10] | α270[10] | α206[10] | α132[10] | α238[10] | | |
| 304 | *[10] | α270[10] | α9[10] | α154[10] | | | |
| 305 | *[10] | α9[10] | α40[10] | | | | |
| 306 | *[10] | α9[10] | α132[10] | α269[10] | | | |
| 307 | *[10] | α9[10] | α132[0.65] | α179[0.48] | | | |
| 308 | *[10] | α270[10] | α139[10] | α135[10] | | | |
| 309 | *[10] | α200[10] | α256[10] | | | | |
| 310 | *[10] | α174[10] | α140[10] | α132[10] | α269[10] | | |
| 311 | *[10] | α138[2.5] | α139[0.5] | | | | |
| 312 | *[10] | α10[10] | α256[2] | α1[0.2] | | | |
| 313 | *[10] | α10[10] | α256[2] | α169[0.4] | | | |
| 314 | *[10] | α10[10] | α256[2] | α168[0.5] | | | |
| 315 | *[10] | α10[10] | α256[2] | α172[0.2] | | | |
| 316 | *[10] | α10[10] | α256[2] | α133[0.2] | | | |
| 317 | *[10] | α10[10] | α256[2] | α140[0.8] | | | |
| 318 | *[10] | α10[10] | α256[2] | α135[0.8] | | | |
| 319 | *[10] | α10[10] | α256[2] | α132[0.8] | | | |
| 320 | *[10] | α10[10] | α256[2] | α134[0.8] | | | |
| 321 | *[10] | α10[10] | α256[2] | α145[0.6] | | | |
| 322 | *[10] | α10[10] | α256[2] | α213[0.8] | | | |
| 323 | *[10] | α10[10] | α256[2] | α206[0.8] | | | |
| 324 | *[10] | α10[10] | α256[2] | α208[0.4] | | | |
| 325 | *[10] | α10[10] | α256[2] | α259[0.8] | | | |
| 326 | *[10] | α10[10] | α256[2] | α209[0.8] | | | |
| 327 | *[10] | α10[10] | α256[2] | α199[4] | | | |
| 328 | *[10] | α10[10] | α256[2] | α219[0.2] | | | |
| 329 | *[10] | α10[10] | α256[2] | α214[1] | | | |
| 330 | *[10] | α10[10] | α179[0.5] | α1[0.2] | | | |
| 331 | *[10] | α10[10] | α179[0.5] | α169[0.4] | | | |
| 332 | *[10] | α10[10] | α179[0.5] | α168[0.5] | | | |
| 333 | *[10] | α10[10] | α179[0.5] | α172[0.2] | | | |
| 334 | *[10] | α10[10] | α179[0.5] | α133[0.2] | | | |
| 335 | *[10] | α10[10] | α179[0.5] | α140[0.8] | | | |
| 336 | *[10] | α10[10] | α179[0.5] | α135[0.8] | | | |
| 337 | *[10] | α10[10] | α179[0.5] | α132[0.8] | | | |
| 338 | *[10] | α10[10] | α179[0.5] | α134[0.8] | | | |
| 339 | *[10] | α10[10] | α179[0.5] | α145[0.6] | | | |
| 340 | *[10] | α10[10] | α179[0.5] | α213[0.8] | | | |
| 341 | *[10] | α10[10] | α179[0.5] | α206[0.8] | | | |
| 342 | *[10] | α10[10] | α179[0.5] | α209[0.8] | | | |
| 343 | *[10] | α10[10] | α179[0.5] | α199[4] | | | |
| 344 | *[10] | α10[10] | α179[0.5] | α214[1] | | | |
| 345 | *[10] | α10[10] | α180[0.16] | α169[0.8] | | | |
| 346 | *[10] | α10[10] | α180[0.16] | α172[0.4] | | | |
| 347 | *[10] | α10[10] | α180[0.16] | α140[0.4] | | | |
| 348 | *[10] | α10[10] | α180[0.16] | α135[0.8] | | | |
| 349 | *[10] | α10[10] | α180[0.16] | α132[0.8] | | | |
| 350 | *[10] | α10[10] | α180[0.16] | α134[0.8] | | | |
| 351 | *[10] | α10[10] | α180[0.16] | α145[0.6] | | | |
| 352 | *[10] | α10[10] | α180[0.16] | α213[0.8] | | | |
| 353 | *[10] | α10[10] | α180[0.16] | α206[0.8] | | | |
| 354 | *[10] | α10[10] | α180[0.16] | α206[0.5] | α168[0.32] | | |
| 355 | *[10] | α10[10] | α180[0.16] | α208[0.4] | | | |
| 356 | *[10] | α10[10] | α180[0.16] | α259[0.8] | | | |
| 357 | *[10] | α10[10] | α180[0.16] | α209[0.8] | | | |
| 358 | *[10] | α10[10] | α180[0.16] | α199[4] | | | |
| 359 | *[10] | α10[10] | α180[0.16] | α214[1.6] | | | |
| 360 | *[10] | α10[10] | α207[0.4] | α219[0.2] | α169[0.4] | α1[0.2] | |
| 361 | *[10] | α10[10] | α207[0.4] | α219[0.2] | α169[0.4] | α208[0.4] | |
| 362 | *[10] | α10[10] | α207[0.4] | α219[0.2] | α169[0.4] | α133[0.2] | |
| 363 | *[10] | α10[10] | α207[0.4] | α219[0.2] | α169[0.4] | α179[0.4] | |
| 364 | *[10] | α10[10] | α179[0.4] | α219[0.2] | α169[0.4] | α133[0.2] | |
| 365 | *[10] | α10[10] | α180[0.16] | α219[0.2] | α169[0.4] | α133[0.2] | |
| 366 | *[10] | α10[10] | α179[0.4] | α219[0.2] | α169[0.4] | α1[0.2] | |
| 367 | *[10] | α10[10] | α180[0.16] | α219[0.2] | α169[0.4] | α1[0.2] | |
| 368 | *[10] | α10[10] | α179[0.4] | α219[0.2] | α169[0.4] | α208[0.4] | |
| 369 | *[10] | α10[10] | α180[0.16] | α219[0.2] | α169[0.4] | α208[0.4] | |
| 370 | *[10] | α10[10] | α179[0.8] | α145[0.5] | α259[0.4] | | |
| 371 | *[10] | α10[10] | α179[0.5] | α259[0.4] | α172[0.2] | | |
| 372 | *[10] | α10[10] | α180[0.2] | α259[0.4] | α172[0.2] | | |
| 373 | *[10] | α10[10] | α180[0.2] | α133[0.4] | α172[0.2] | | |
| 374 | *[10] | α10[10] | α180[0.2] | α172[0.2] | α1[0.4] | | |
| 375 | *[10] | α10[10] | α180[0.2] | α168[0.2] | α1[0.4] | | |
| 376 | *[10] | α10[10] | α180[0.2] | α1[0.4] | α214[1] | | |
| 377 | *[10] | α10[10] | α180[0.2] | α208[0.4] | α172[0.2] | | |
| 378 | *[10] | α10[10] | α180[0.4] | α208[0.2] | α168[1] | | |
| 379 | *[10] | α10[10] | α180[0.4] | α208[1] | α214[1] | | |
| 380 | *[10] | α10[10] | α179[1] | α207[1] | α172[1] | α1[2] | |
| 381 | *[10] | α10[10] | α179[1] | α207[1] | α168[1] | α1[2] | |
| 382 | *[10] | α10[10] | α180[0.5] | α145[1.5] | α259[1] | α1[2] | |
| 383 | *[10] | α10[10] | α180[0.5] | α145[1.5] | α208[1] | | |
| 384 | *[10] | α10[10] | α179[0.4] | α207[0.4] | α219[0.2] | α169[0.4] | α133[0.2] |
| 385 | *[10] | α10[10] | α179[0.4] | α207[0.4] | α219[0.2] | α169[0.4] | α145[0.6] |
| 386 | *[10] | α10[10] | α180[0.16] | α207[0.4] | α219[0.2] | α169[0.4] | α133[0.2] |
| 387 | *[10] | α10[10] | α179[0.4] | α207[0.4] | α219[0.2] | α169[0.4] | α1[0.2] |
| 388 | *[10] | α10[10] | α180[0.16] | α207[0.4] | α219[0.2] | α169[0.4] | α1[0.2] |
| 389 | *[10] | α10[10] | α179[0.4] | α207[0.4] | α219[0.2] | α169[0.4] | α208[0.4] |
| 390 | *[10] | α10[10] | α180[0.16] | α207[0.4] | α219[0.2] | α169[0.4] | α208[0.4] |
| 391 | *[10] | α10[10] | α179[0.2] | α133[0.1] | α207[0.2] | α1[0.4] | |
| 392 | *[10] | α10[10] | α133[0.2] | α207[0.4] | α1[0.4] | | |
| 393 | *[10] | α10[10] | α207[0.4] | α133[0.4] | α134[0.8] | | |
| 394 | *[10] | α10[10] | α179[0.4] | α133[0.4] | α134[0.8] | | |
| 395 | *[10] | α10[10] | α180[0.16] | α133[0.4] | α134[0.8] | | |
| 396 | *[10] | α10[10] | α207[0.4] | α145[0.6] | α134[0.8] | | |
| 397 | *[10] | α10[10] | α207[0.4] | α135[0.8] | α134[0.8] | | |
| 398 | *[10] | α10[10] | α207[0.4] | α132[0.8] | α134[0.8] | | |
| 399 | *[10] | α10[10] | α207[0.4] | α214[1] | α134[0.8] | | |
| 400 | *[10] | α10[10] | α207[0.4] | α199[4] | α134[0.8] | | |
| 401 | *[10] | α10[10] | α207[0.4] | α203[0.2] | α134[0.8] | | |
| 402 | *[10] | α10[10] | α207[0.4] | α204[0.2] | α134[0.8] | | |
| 403 | *[10] | α10[10] | α207[0.4] | α205[0.2] | α134[0.8] | | |
| 404 | *[10] | α10[10] | α207[0.4] | α202[0.2] | α134[0.8] | | |
| 405 | *[10] | α10[10] | α207[0.4] | α259[0.8] | α134[0.8] | | |
| 406 | *[10] | α10[10] | α179[0.4] | α207[0.4] | α133[0.4] | α134[0.8] | |
| 407 | *[10] | α10[10] | α179[0.4] | α207[0.4] | α145[0.6] | α134[0.8] | |
| 408 | *[10] | α10[10] | α179[0.4] | α207[0.4] | α135[0.8] | α134[0.8] | |
| 409 | *[10] | α10[10] | α179[0.4] | α207[0.4] | α132[0.8] | α134[0.8] | |
| 410 | *[10] | α10[10] | α179[0.4] | α207[0.4] | α214[1] | α134[0.8] | |
| 411 | *[10] | α10[10] | α179[0.4] | α207[0.4] | α199[4] | α134[0.8] | |
| 412 | *[10] | α10[10] | α179[0.4] | α207[0.4] | α203[0.2] | α134[0.8] | |
| 413 | *[10] | α10[10] | α179[0.4] | α207[0.4] | α204[0.2] | α134[0.8] | |
| 414 | *[10] | α10[10] | α179[0.4] | α207[0.4] | α205[0.2] | α134[0.8] | |
| 415 | *[10] | α10[10] | α179[0.4] | α207[0.4] | α202[0.2] | α134[0.8] | |
| 416 | *[10] | α10[10] | α179[0.4] | α207[0.4] | α259[0.8] | α134[0.8] | |
| 417 | *[10] | α10[10] | α179[0.4] | α219[0.2] | α169[0.4] | α145[0.6] | |
| 418 | *[10] | α10[10] | α180[0.16] | α219[0.2] | α169[0.4] | α145[0.6] | |
| 419 | *[10] | α10[10] | α207[0.4] | α219[0.2] | α169[0.4] | α145[0.6] | |
| 420 | *[10] | α10[10] | α179[0.8] | α145[0.5] | α172[2] | | |
| 421 | *[10] | α10[10] | α180[0.16] | α145[0.6] | α172[0.2] | | |
| 422 | *[10] | α10[10] | α207[0.4] | α145[0.6] | α172[0.2] | | |
| 423 | *[10] | α10[10] | α179[0.4] | α207[0.4] | α145[0.6] | α172[0.2] | |
| 424 | *[10] | α10[10] | α180[0.16] | α145[0.6] | α168[0.4] | | |
| 425 | *[10] | α10[10] | α207[0.4] | α145[0.6] | α168[0.4] | | |
| 426 | *[10] | α10[10] | α179[0.4] | α207[0.4] | α145[0.6] | α168[0.4] | |
| 427 | *[10] | α10[10] | α179[0.2] | α133[0.1] | α1[0.4] | α199[1.2] | |
| 428 | *[10] | α10[10] | α179[0.2] | α133[0.1] | α1[0.4] | α203[0.2] | |
| 429 | *[10] | α10[10] | α179[0.2] | α133[0.1] | α1[0.4] | α204[0.2] | |
| 430 | *[10] | α10[10] | α179[0.2] | α133[0.1] | α1[0.4] | α205[0.2] | |
| 431 | *[10] | α10[10] | α179[0.2] | α133[0.1] | α1[0.4] | α202[0.2] | |
| 432 | *[10] | α10[10] | α179[0.2] | α133[0.1] | α1[0.4] | α268[6] | |
| 433 | *[10] | α10[10] | α179[0.2] | α133[0.1] | α1[0.4] | α218[6] | |
| 434 | *[10] | α10[10] | α179[0.2] | α133[0.1] | α1[0.4] | α200[20] | |
| 435 | *[10] | α10[10] | α179[0.2] | α133[0.1] | α1[0.4] | α196[1] | |
| 436 | *[10] | α10[10] | α179[0.2] | α133[0.1] | α1[0.4] | α206[0.25] | |
| 437 | *[10] | α10[10] | α180[0.16] | α208[0.2] | α1[0.4] | α133[0.1] | |
| 438 | *[10] | α10[10] | α180[0.16] | α208[0.2] | α1[0.4] | α132[0.1] | |
| 439 | *[10] | α10[10] | α180[0.16] | α208[0.2] | α1[0.4] | α134[0.4] | |
| 440 | *[10] | α10[10] | α180[0.16] | α208[0.2] | α1[0.4] | α135[0.1] | |
| 441 | *[10] | α10[10] | α180[0.16] | α208[0.2] | α1[0.4] | α136[0.5] | |
| 442 | *[10] | α10[10] | α180[0.16] | α208[0.2] | α1[0.4] | α137[0.3] | |
| 443 | *[10] | α10[10] | α180[0.16] | α208[0.2] | α1[0.4] | α138[0.5] | |
| 444 | *[10] | α10[10] | α180[0.16] | α208[0.2] | α1[0.4] | α139[0.5] | |
| 445 | *[10] | α10[10] | α180[0.16] | α208[0.2] | α1[0.4] | α140[0.2] | |
| 446 | *[10] | α10[10] | α180[0.16] | α208[0.2] | α1[0.4] | α141[0.2] | |
| 447 | *[10] | α10[10] | α180[0.16] | α208[0.2] | α1[0.4] | α142[0.2] | |
| 448 | *[10] | α10[10] | α180[0.16] | α208[0.2] | α1[0.4] | α145[0.3] | |
| 449 | *[10] | α10[10] | α180[0.16] | α208[0.2] | α1[0.4] | α143[0.3] | |
| 450 | *[10] | α10[10] | α180[0.16] | α208[0.2] | α1[0.4] | α144[0.3] | |
| 451 | *[10] | α10[10] | α180[0.16] | α208[0.2] | α1[0.4] | α199[2] | |
| 452 | *[10] | α10[10] | α180[0.16] | α208[0.2] | α1[0.4] | α203[0.2] | |
| 453 | *[10] | α10[10] | α180[0.16] | α208[0.2] | α1[0.4] | α204[0.2] | |
| 454 | *[10] | α10[10] | α180[0.16] | α208[0.2] | α1[0.4] | α205[0.2] | |
| 455 | *[10] | α10[10] | α180[0.16] | α208[0.2] | α1[0.4] | α202[0.2] | |
| 456 | *[10] | α10[10] | α180[0.16] | α208[0.2] | α1[0.4] | α268[2] | |
| 457 | *[10] | α10[10] | α180[0.16] | α208[0.2] | α1[0.4] | α206[0.1] | |
| 458 | *[10] | α10[10] | α180[0.16] | α208[0.2] | α1[0.4] | α259[0.5] | |
| 459 | *[10] | α10[10] | α180[0.16] | α208[0.2] | α1[0.4] | α209[2] | |
| 460 | *[10] | α10[10] | α180[0.16] | α208[0.2] | α1[0.4] | α213[0.3] | |
| 461 | *[10] | α10[10] | α180[0.16] | α208[0.2] | α1[0.4] | α214[0.1] | |
| 462 | *[10] | α10[10] | α179[0.2] | α208[0.2] | α1[0.4] | α133[0.1] | |
| 463 | *[10] | α10[10] | α179[0.2] | α208[0.2] | α1[0.4] | α132[0.1] | |
| 464 | *[10] | α10[10] | α179[0.2] | α208[0.2] | α1[0.4] | α134[0.4] | |
| 465 | *[10] | α10[10] | α179[0.2] | α208[0.2] | α1[0.4] | α135[0.1] | |
| 466 | *[10] | α10[10] | α179[0.2] | α208[0.2] | α1[0.4] | α136[0.5] | |
| 467 | *[10] | α10[10] | α179[0.2] | α208[0.2] | α1[0.4] | α137[0.3] | |
| 468 | *[10] | α10[10] | α179[0.2] | α208[0.2] | α1[0.4] | α138[0.5] | |
| 469 | *[10] | α10[10] | α179[0.2] | α208[0.2] | α1[0.4] | α139[0.5] | |
| 470 | *[10] | α10[10] | α179[0.2] | α208[0.2] | α1[0.4] | α140[0.2] | |
| 471 | *[10] | α10[10] | α179[0.2] | α208[0.2] | α1[0.4] | α141[0.2] | |
| 472 | *[10] | α10[10] | α179[0.2] | α208[0.2] | α1[0.4] | α142[0.2] | |
| 473 | *[10] | α10[10] | α179[0.2] | α208[0.2] | α1[0.4] | α145[0.3] | |
| 474 | *[10] | α10[10] | α179[0.2] | α208[0.2] | α1[0.4] | α143[0.3] | |
| 475 | *[10] | α10[10] | α179[0.2] | α208[0.2] | α1[0.4] | α144[0.3] | |
| 476 | *[10] | α10[10] | α179[0.2] | α208[0.2] | α1[0.4] | α199[2] | |
| 477 | *[10] | α10[10] | α179[0.2] | α208[0.2] | α1[0.4] | α203[0.2] | |
| 478 | *[10] | α10[10] | α179[0.2] | α208[0.2] | α1[0.4] | α204[0.2] | |
| 479 | *[10] | α10[10] | α179[0.2] | α208[0.2] | α1[0.4] | α205[0.2] | |
| 480 | *[10] | α10[10] | α179[0.2] | α208[0.2] | α1[0.4] | α202[0.2] | |
| 481 | *[10] | α10[10] | α179[0.2] | α208[0.2] | α1[0.4] | α268[2] | |
| 482 | *[10] | α10[10] | α179[0.2] | α208[0.2] | α1[0.4] | α206[0.1] | |
| 483 | *[10] | α10[10] | α179[0.2] | α208[0.2] | α1[0.4] | α259[0.5] | |
| 484 | *[10] | α10[10] | α179[0.2] | α208[0.2] | α1[0.4] | α209[2] | |
| 485 | *[10] | α10[10] | α179[0.2] | α208[0.2] | α1[0.4] | α213[0.3] | |
| 486 | *[10] | α10[10] | α179[0.2] | α208[0.2] | α1[0.4] | α214[0.1] | |
| 487 | *[10] | α10[10] | α180[0.04] | α208[0.2] | α1[0.8] | α133[0.1] | α186[0.1] |
| 488 | *[10] | α10[10] | α180[0.04] | α208[0.2] | α1[0.8] | α133[0.1] | α271[0.2] |
| 489 | *[10] | α10[10] | α180[0.04] | α208[0.2] | α1[0.8] | α133[0.1] | α177[0.1] |
| 490 | *[10] | α10[10] | α180[0.04] | α208[0.2] | α1[0.8] | α133[0.1] | α272[0.1] |
| 491 | *[10] | α10[10] | α180[0.04] | α208[0.2] | α1[0.8] | α133[0.1] | α273[0.1] |
| 492 | *[10] | α10[10] | α179[0.4] | α208[0.2] | α1[0.8] | α133[0.1] | α186[0.1] |
| 493 | *[10] | α10[10] | α179[0.4] | α208[0.2] | α1[0.8] | α133[0.1] | α271[0.2] |
| 494 | *[10] | α10[10] | α179[0.4] | α208[0.2] | α1[0.8] | α133[0.1] | α177[0.1] |
| 495 | *[10] | α10[10] | α179[0.4] | α208[0.2] | α1[0.8] | α133[0.1] | α272[0.1] |
| 496 | *[10] | α10[10] | α179[0.4] | α208[0.2] | α1[0.8] | α133[0.1] | α273[0.1] |
| 497 | *[10] | α10[10] | α179[0.8] | α145[0.5] | α208[0.2] | α199[2] | |
| 498 | *[10] | α10[10] | α179[0.8] | α145[0.5] | α208[0.2] | α203[0.2] | |
| 499 | *[10] | α10[10] | α179[0.8] | α145[0.5] | α208[0.2] | α204[0.2] | |
| 500 | *[10] | α10[10] | α179[0.8] | α145[0.5] | α208[0.2] | α205[0.2] | |
| 501 | *[10] | α10[10] | α179[0.8] | α145[0.5] | α208[0.2] | α202[0.2] | |
| 502 | *[10] | α10[10] | α179[0.2] | α133[0.1] | α207[0.4] | α208[0.2] | α168[0.4] |
| 503 | *[10] | α10[10] | α179[0.2] | α133[0.1] | α207[0.4] | α208[0.2] | α174[0.4] |
| 504 | *[10] | α10[10] | α179[0.2] | α133[0.1] | α207[0.4] | α208[0.2] | α172[0.4] |
| 505 | *[10] | α10[10] | α179[0.2] | α133[0.1] | α207[0.4] | α208[0.2] | α169[0.4] |
| 506 | *[10] | α10[10] | α179[0.2] | α133[0.1] | α207[0.4] | α208[0.2] | α175[0.4] |
| 507 | *[10] | α10[10] | α179[0.2] | α133[0.1] | α207[0.4] | α208[0.2] | α199[2] |
| 508 | *[10] | α10[10] | α179[0.2] | α133[0.1] | α207[0.4] | α208[0.2] | α203[0.2] |
| 509 | *[10] | α10[10] | α179[0.2] | α133[0.1] | α207[0.4] | α208[0.2] | α204[0.2] |
| 510 | *[10] | α10[10] | α179[0.2] | α133[0.1] | α207[0.4] | α208[0.2] | α205[0.2] |
| 511 | *[10] | α10[10] | α179[0.2] | α133[0.1] | α207[0.4] | α208[0.2] | α202[0.2] |
| 512 | *[10] | α10[10] | α179[0.2] | α133[0.1] | α207[0.4] | α208[0.2] | α268[2] |
| 513 | *[10] | α10[10] | α179[0.2] | α133[0.1] | α207[0.4] | α208[0.2] | α206[0.1] |
| 514 | *[10] | α10[10] | α179[0.2] | α133[0.1] | α207[0.4] | α208[0.2] | α259[0.5] |
| 515 | *[10] | α10[10] | α179[0.2] | α133[0.1] | α207[0.4] | α208[0.2] | α209[2] |
| 516 | *[10] | α10[10] | α179[0.2] | α133[0.1] | α207[0.4] | α208[0.2] | α213[0.3] |
| 517 | *[10] | α10[10] | α179[0.2] | α133[0.1] | α207[0.4] | α208[0.2] | α214[0.1] |
| 518 | *[10] | α10[10] | α179[0.4] | α207[0.4] | α145[0.6] | α2[0.8] | |
| 519 | *[10] | α10[10] | α180[0.4] | α207[0.4] | α145[0.6] | α2[0.8] | |
| 520 | *[10] | α10[10] | α179[0.4] | α207[0.4] | α133[0.1] | α2[0.8] | |
| 521 | *[10] | α10[10] | α180[0.4] | α207[0.4] | α133[0.1] | α2[0.8] | |
| 522 | *[10] | α10[10] | α179[0.4] | α207[0.4] | α208[0.2] | α2[0.8] | |
| 523 | *[10] | α10[10] | α180[0.4] | α207[0.4] | α208[0.2] | α2[0.8] | |
| 524 | *[10] | α10[10] | α179[0.4] | α207[0.4] | α1 [0.8] | α2[0.8] | |
| 525 | *[10] | α10[10] | α180[0.4] | α207[0.4] | α1 [0.8] | α2[0.8] | |
| 526 | *[10] | α10[10] | α179[0.4] | α207[0.4] | α8[0.2] | α2[0.8] | |
| 527 | *[10] | α10[10] | α180[0.4] | α207[0.4] | α8[0.2] | α2[0.8] | |
| 528 | *[10] | α10[10] | α179[0.4] | α207[0.4] | α145[0.6] | α3[0.8] | |
| 529 | *[10] | α10[10] | α180[0.4] | α207[0.4] | α145[0.6] | α3[0.8] | |
| 530 | *[10] | α10[10] | α179[0.4] | α207[0.4] | α133[0.1] | α3[0.8] | |
| 531 | *[10] | α10[10] | α180[0.4] | α207[0.4] | α133[0.1] | α3[0.8] | |
| 532 | *[10] | α10[10] | α179[0.4] | α207[0.4] | α208[0.2] | α3[0.8] | |
| 533 | *[10] | α10[10] | α180[0.4] | α207[0.4] | α208[0.2] | α3[0.8] | |
| 534 | *[10] | α10[10] | α179[0.4] | α207[0.4] | α1 [0.8] | α3[0.8] | |
| 535 | *[10] | α10[10] | α180[0.4] | α207[0.4] | α1 [0.8] | α3[0.8] | |
| 536 | *[10] | α10[10] | α179[0.4] | α207[0.4] | α8[0.2] | α3[0.8] | |
| 537 | *[10] | α10[10] | α180[0.4] | α207[0.4] | α206[0.5] | α3[0.8] | |
| 538 | *[10] | α10[10] | α180[0.4] | α207[0.4] | α8[0.2] | α3[0.8] | |
| 539 | *[10] | α10[10] | α179[0.4] | α207[0.4] | α208[0.2] | α4[0.2] | |
| 540 | *[10] | α10[10] | α180[0.4] | α207[0.4] | α133[0.1] | α4[0.2] | |
| 541 | *[10] | α10[10] | α180[0.4] | α207[0.4] | α4[0.2] | α8[0.2] | |
| 542 | *[10] | α10[10] | α180[0.4] | α207[0.4] | α4[0.2] | α1[0.8] | |
| 543 | *[10] | α10[10] | α179[0.4] | α207[0.4] | α145[0.6] | α4[0.2] | |
| 544 | *[10] | α10[10] | α179[0.4] | α207[0.4] | α4[0.2] | α8[0.2] | |
| 545 | *[10] | α10[10] | α180[0.2] | α133[0.4] | α8[0.2] | | |
| 546 | *[10] | α10[10] | α179[0.5] | α133[0.2] | α8[0.1] | | |
| 547 | *[10] | α10[10] | α179[0.4] | α207[0.4] | α133[0.4] | α8[0.2] | |
| 548 | *[10] | α10[10] | α179[0.4] | α207[0.4] | α8[0.2] | α145[0.6] | |
| 549 | *[10] | α10[10] | α179[0.4] | α207[0.4] | α8[0.2] | α134[0.8] | |
| 550 | *[10] | α10[10] | α179[0.4] | α207[0.4] | α8[0.2] | α135[0.8] | |
| 551 | *[10] | α10[10] | α179[0.4] | α207[0.4] | α8[0.2] | α132[0.8] | |
| 552 | *[10] | α10[10] | α179[0.4] | α207[0.4] | α8[0.2] | α214[1] | |
| 553 | *[10] | α10[10] | α179[0.4] | α207[0.4] | α8[0.2] | α199[4] | |
| 554 | *[10] | α10[10] | α179[0.4] | α207[0.4] | α8[0.2] | α259[0.8] | |
| 555 | *[10] | α10[10] | α207[0.4] | α145[0.6] | α8[0.2] | | |
| 556 | *[10] | α10[10] | α207[0.4] | α134[0.8] | α8[0.2] | | |
| 557 | *[10] | α10[10] | α207[0.4] | α135[0.8] | α8[0.2] | | |
| 558 | *[10] | α10[10] | α207[0.4] | α132[0.8] | α8[0.2] | | |
| 559 | *[10] | α10[10] | α207[0.4] | α214[1] | α8[0.2] | | |
| 560 | *[10] | α10[10] | α207[0.4] | α199[4] | α8[0.2] | | |
| 561 | *[10] | α10[10] | α207[0.4] | α259[0.8] | α8[0.2] | | |
| 562 | *[10] | α10[10] | α179[0.4] | α206[0.5] | α8[0.2] | α168[0.32] | α140[0.4] |
| 563 | *[10] | α10[10] | α179[0.4] | α206[0.5] | α8[0.2] | α169[0.4] | α140[0.4] |
| 564 | *[10] | α10[10] | α179[0.4] | α206[0.5] | α8[0.2] | α172[0.2] | α140[0.4] |
| 565 | *[10] | α10[10] | α179[0.4] | α206[0.5] | α8[0.2] | α174[0.4] | α140[0.4] |
| 566 | *[10] | α10[10] | α179[0.4] | α206[0.5] | α8[0.2] | α168[0.32] | α135[0.8] |
| 567 | *[10] | α10[10] | α179[0.4] | α206[0.5] | α8[0.2] | α169[0.4] | α135[0.8] |
| 568 | *[10] | α10[10] | α179[0.4] | α206[0.5] | α8[0.2] | α172[0.2] | α135[0.8] |
| 569 | *[10] | α10[10] | α179[0.4] | α206[0.5] | α8[0.2] | α174[0.4] | α135[0.8] |
| 570 | *[10] | α10[10] | α179[0.4] | α206[0.5] | α8[0.2] | α168[0.32] | α132[0.8] |
| 571 | *[10] | α10[10] | α179[0.4] | α206[0.5] | α8[0.2] | α169[0.4] | α132[0.8] |
| 572 | *[10] | α10[10] | α179[0.4] | α206[0.5] | α8[0.2] | α172[0.2] | α132[0.8] |
| 573 | *[10] | α10[10] | α179[0.4] | α206[0.5] | α8[0.2] | α174[0.4] | α132[0.8] |
| 574 | *[10] | α10[10] | α179[0.4] | α206[0.5] | α8[0.2] | α168[0.32] | α134[0.8] |
| 575 | *[10] | α10[10] | α179[0.4] | α206[0.5] | α8[0.2] | α169[0.4] | α134[0.8] |
| 576 | *[10] | α10[10] | α179[0.4] | α206[0.5] | α8[0.2] | α172[0.2] | α134[0.8] |
| 577 | *[10] | α10[10] | α179[0.4] | α206[0.5] | α8[0.2] | α174[0.4] | α134[0.8] |
| 578 | *[10] | α10[10] | α180[0.16] | α206[0.5] | α8[0.2] | α168[0.32] | α140[0.4] |
| 579 | *[10] | α10[10] | α180[0.16] | α206[0.5] | α8[0.2] | α169[0.4] | α140[0.4] |
| 580 | *[10] | α10[10] | α180[0.16] | α206[0.5] | α8[0.2] | α172[0.2] | α140[0.4] |
| 581 | *[10] | α10[10] | α180[0.16] | α206[0.5] | α8[0.2] | α174[0.4] | α140[0.4] |
| 582 | *[10] | α10[10] | α180[0.16] | α206[0.5] | α8[0.2] | α168[0.32] | α135[0.8] |
| 583 | *[10] | α10[10] | α180[0.16] | α206[0.5] | α8[0.2] | α169[0.4] | α135[0.8] |
| 584 | *[10] | α10[10] | α180[0.16] | α206[0.5] | α8[0.2] | α172[0.2] | α135[0.8] |
| 585 | *[10] | α10[10] | α180[0.16] | α206[0.5] | α8[0.2] | α174[0.4] | α135[0.8] |
| 586 | *[10] | α10[10] | α180[0.16] | α206[0.5] | α8[0.2] | α168[0.32] | α132[0.8] |
| 587 | *[10] | α10[10] | α180[0.16] | α206[0.5] | α8[0.2] | α169[0.4] | α132[0.8] |
| 588 | *[10] | α10[10] | α180[0.16] | α206[0.5] | α8[0.2] | α172[0.2] | α132[0.8] |
| 589 | *[10] | α10[10] | α180[0.16] | α206[0.5] | α8[0.2] | α174[0.4] | α132[0.8] |
| 590 | *[10] | α10[10] | α180[0.16] | α206[0.5] | α8[0.2] | α168[0.32] | α134[0.8] |
| 591 | *[10] | α10[10] | α180[0.16] | α206[0.5] | α8[0.2] | α169[0.4] | α134[0.8] |
| 592 | *[10] | α10[10] | α180[0.16] | α206[0.5] | α8[0.2] | α172[0.2] | α134[0.8] |
| 593 | *[10] | α10[10] | α180[0.16] | α206[0.5] | α8[0.2] | α174[0.4] | α134[0.8] |
| 594 | *[5] | α10[5] | α179[5] | α133[1] | α1[1] | α201[5] | |
| 595 | *[5] | α10[5] | α180[2] | α208[1] | α1[1] | α201[5] | |
| 596 | *[5] | α10[5] | α179[5] | α208[1] | α1[1] | α201[5] | |
| 597 | *[10] | α10[10] | α179[0.5] | α145[0.5] | α208[0.5] | α201[10] | |
| 598 | *[5] | α10[5] | α179[5] | α133[1] | α170[1] | α201[5] | |
| 599 | *[5] | α10[5] | α180[2] | α208[1] | α170[1] | α201[5] | |
| 600 | *[5] | α10[5] | α179[5] | α208[1] | α170[1] | α201[5] | |
| 601 | *[10] | α10[10] | α179[0.5] | α145[0.5] | α170[0.5] | α201[10] | |
| 602 | *[30] | α207[3.7] | α179[1] | | | | |
| 603 | *[10] | α207[3.7] | α179[1] | | | | |
| 604 | *[5] | α10[5] | α207[1] | α208[1] | | | |

### Formulation Example 1

Twenty parts of one composition among the inventive compositions 1 to 604, 35 parts of a mixture (ratio by weight=1:1) of white carbon and polyoxyethylene alkyl ether sulfate ammonium salt, and water are mixed so that the entire amount is 100 parts and are pulverized by a wet grinding method to give a formulation of each composition.

### Formulation Example 2

Forty parts of one composition among the inventive compositions 1 to 604, 1.5 parts of sorbitan trioleate, and 28 parts of an aqueous solution containing 2 parts of polyvinyl alcohol are mixed and pulverized by a wet grinding method. Then, an aqueous solution containing 0.05 part of xanthan gum and 0.1 part of aluminium magnesium silicate is added to the mixture so that the entire amount is 90 parts, and 10 parts of propylene glycol is further added thereto and stirred to give a formulation of each composition.

### Formulation Example 3

Ten parts of one composition among the inventive compositions 1 to 604, 3 parts of calcium lignin sulfonate, 2 parts of sodium lauryl sulfate, and the remaining parts of synthetic hydrated silicone oxide are well pulverized and mixed to give 100 parts of a wettable powder of each composition.

### Formulation Example 4

One part of one composition among the inventive compositions 1 to 604, 1 part of synthetic hydrated silicone oxide powder, 2 parts of calcium lignin sulfonate, 30 parts of bentonite, and the remaining parts of kaolin clay are added and mixed. Then, an appropriate amount of water is added to the mixture and further stirred, granulated with a granulator, and draft-dried to give granules of each compound.

### Formulation Example 5

One part of one composition among the inventive compositions 283 to 297, 1 part of synthetic hydrated silicone oxide powder, 2 parts of calcium lignin sulfonate, 30 parts of bentonite, and the remaining parts of kaolin clay are added and mixed. Then, an appropriate amount of water is added to the mixture and further stirred, granulated with a granulator, and draft-dried to give granules of each compound.

### Formulation Example 6

Twenty parts of one composition among the inventive compositions 283 to 297, 35 parts of a mixture (ratio by weight=1:1) of white carbon and polyoxyethylene alkyl ether sulfate ammonium salt, and water are mixed so that the entire amount is 100 parts and are pulverized by a wet grinding method to give a formulation of each composition.

### Formulation Example 7

One part of one compound among the present compounds 1 to 647, 0.5 part of isotianil, 1 part of synthetic hydrated silicone oxide powder, 2 parts of calcium lignin sulfonate, 30 parts of bentonite, and the remaining parts of kaolin clay are added and mixed. Then, an appropriate amount of water is added to the mixture and further stirred, granulated with a granulator, and draft-dried to give granules of each compound.

### Formulation Example 8

One part of one compound among the present compounds 1 to 647, 0.5 part of isotianil, 1 part of clothianidin, 1 part of synthetic hydrated silicone oxide powder, 2 parts of calcium lignin sulfonate, 29 parts of bentonite, and the remaining parts of kaolin clay are added and mixed. Then, an appropriate amount of water is added to the mixture and further stirred, granulated with a granulator, and draft-dried to give granules of each compound.

Next, Application Examples of the inventive compositions to plant seeds will be shown.

### Application Example 1

One hundred kg of dried Sorghum seeds are smeared with 200 ml of each flowable formulation produced in Formulation Example 1 or 2 using a rotary seed treatment machine (a seed dresser, manufactured by Hans-Ulrich Hege GmbH) to give treated seeds. In addition, 180 g of the chemical injury reducing agent, oxabetrinil, described in Group D can be further added and smearing treatment can be conducted to give treated seeds.

### Application Example 2

One hundred kg of dried Sorghum seeds are smeared with 200 ml of each flowable formulation produced in Formulation Example 1 or 2 using a rotary seed treatment machine (a seed dresser, manufactured by Hans-Ulrich Hege GmbH) to give treated seeds. In addition, 40 g of the chemical injury reducing agent, fluxofenim, described in Group D can be further added and smearing treatment can be conducted to give treated seeds.

### Application Example 3

Ten kg of dried corn seeds are smeared with 10 ml of each flowable formulation produced in Formulation Example 1 or 2 using a rotary seed treatment machine (a seed dresser, manufactured by Hans-Ulrich Hege GmbH) to give treated seeds.

### Application Example 4

Ten kg of dried corn seeds are smeared with 40 ml of each flowable formulation produced in Formulation Example 1 or 2 using a rotary seed treatment machine (a seed dresser, manufactured by Hans-Ulrich Hege GmbH) to give treated seeds.

### Application Example 5

Ten kg of dried corn seeds are smeared with 100 ml of each flowable formulation produced in Formulation Example 1 or 2 using a rotary seed treatment machine (a seed dresser, manufactured by Hans-Ulrich Hege GmbH) to give treated seeds.

### Application Example 6

Ten kg of dried corn seeds are coated with 50 g of each wettable powder produced in Formulation Example 3 to give treated seeds.

### Application Example 7

Ten kg of dried soybean seeds are smeared with 20 ml of each flowable formulation produced in Formulation Example 1 or 2 using a rotary seed treatment machine (a seed dresser, manufactured by Hans-Ulrich Hege GmbH) to give treated seeds.

### Application Example 8

Ten kg of dried soybean seeds are smeared with 100 ml of each flowable formulation produced in Formulation Example 1 or 2 using a rotary seed treatment machine (a seed dresser, manufactured by Hans-Ulrich Hege GmbH) to give treated seeds.

### Application Example 9

Ten kg of dried cotton seeds are smeared with 50 ml of each flowable formulation produced in Formulation Example 1 or 2 using a rotary seed treatment machine (a seed dresser, manufactured by Hans-Ulrich Hege GmbH) to give treated seeds.

### Application Example 10

Ten kg of dried rapeseed seeds are smeared with 50 ml of each flowable formulation produced in Formulation Example 1 or 2 using a rotary seed treatment machine (a seed dresser, manufactured by Hans-Ulrich Hege GmbH) to give treated seeds.

### Application Example 11

Ten kg of dried rapeseed seeds are smeared with 10 ml of each flowable formulation produced in Formulation Example 1 or 2 using a rotary seed treatment machine (a seed dresser, manufactured by Hans-Ulrich Hege GmbH) to give treated seeds.

Next, the advantageous effects of the present invention will be shown in Test Example.

### Test Example 1

The inventive composition is dissolved in acetone (manufactured by Wako Pure Chemical Industries, Ltd.) containing 5% (W/V) of Sorgen TW-20 (manufactured by Dai-ichi Kogyo Seiyaku Co., Ltd.) so as to achieve a predetermined concentration of the inventive composition, to prepare a test chemical solution.

Nine pieces (total weight: about 0.16 g) of Japanese radish seeds (Raphanus sativas var. longipinnatus) are put into a 2-ml micro tube made of polypropylene (manufactured by AS ONE Corporation), and 18 μL of the above test chemical solution is added therein. Then, the seeds within the micro tube are vibrated and stirred using a stirring machine (trade name: VORTEX-GENIE2, manufactured by Scientific industries, Inc.) After the chemical solution is spread uniformly and entirely across the seeds, the seeds are air-dried.

To a 90-ml plastic cup in which 10 g of a soil (trade name: Aisai No. 1, manufactured by Katakura Chikkarin Co., Ltd.) has been put, 5 ml of water is added, and three pieces of the above seeds are sowed therein.

At 4 days after the sowing, 10 third-instar larvae of Plutella xylostella were released per one cup, and the cup was covered with nylon gauze. This is referred to as treated section.

Meanwhile, similarly to the treated section, seeds of Japanese radish were sowed, larvae were released, and the cup was covered, except that the inventive composition was not dissolved in acetone (manufactured by Wako Pure Chemical Industries, Ltd.) containing 5% (W/V) of Sorgen TW-20 (manufactured by Dai-ichi Kogyo Seiyaku Co., Ltd.). This is referred to as non-treated section.

At 2 days from the release, survival or death of the larvae is observed, and a death rate is calculated from the observation result according to the following equation 1).

Death rate (%)=(Number of tested insects−Number of surviving insects)/Number of tested insects×100 Equation 1):

1. A pest controlling composition comprising:
a fused heterocyclic compound represented by the formula (1): 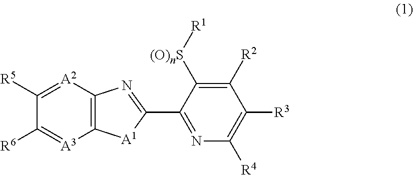
wherein
A¹ represents —NR⁷—, an oxygen atom or a sulfur atom,
A² represents a nitrogen atom or ═CR⁸—,
A³ represents a nitrogen atom or ═CR⁹—,
R¹ represents a C1-C6 chain hydrocarbon group optionally substituted by one or more atoms or groups selected from Group X or a C3-C6 alicyclic hydrocarbon group optionally substituted by one or more atoms or groups selected from Group Y,
R², R³ and R⁴ are the same or different and each represents a C1-C6 chain hydrocarbon group optionally substituted by one or more atoms or groups selected from Group X, a phenyl group optionally substituted by one or more atoms or groups selected from Group Z, a 5- or 6-membered heterocyclic group optionally substituted by one or more atoms or groups selected from Group Z, —OR¹⁰, —S(O)ₘR¹⁰, —S(O)₂NR¹⁰R¹¹, —NR¹⁰R¹¹, —NR¹⁰CO₂R¹¹, —NR¹⁰C(O)R¹¹, —CO₂R¹⁰, —C(O)R¹⁰, —C(O)NR¹⁰R¹¹, —SF₅, a cyano group, a nitro group, a halogen atom or a hydrogen atom,
R⁵ and R⁶ are the same or different and each represents a C1-C6 chain hydrocarbon group optionally substituted by one or more atoms or groups selected from Group X, a phenyl group optionally substituted by one or more atoms or groups selected from Group Z, a 5- or 6-membered heterocyclic group optionally substituted by one or more atoms or groups selected from Group Z, —OR¹⁰, —S(O)ₘR¹⁰, —S(O)₂NR¹⁰R¹¹, —NR¹⁰R¹¹, —NR¹⁰CO₂R¹¹, —NR¹⁰C(O)R¹¹, —CO₂R¹⁰, —C(O)R¹⁰, —C(O)NR¹⁰R¹¹, —SF₅, a cyano group, a nitro group, a halogen atom or a hydrogen atom (wherein R⁵ and R⁶ do not represents a hydrogen atom at the same time),
R⁷ represents a C1-C6 chain hydrocarbon group optionally substituted by one or more atoms or groups selected from Group W, a C1-C6 chain hydrocarbon group substituted by one phenyl group (wherein the phenyl group is optionally substituted by one or more atoms or groups selected from Group Z), a C1-C6 chain hydrocarbon group substituted by one 5- or 6-membered heterocyclic group (wherein the 5- or 6-membered heterocyclic group is optionally substituted by one or more atoms or groups selected from Group Z), —CO₂R¹⁰, —C(O)R¹⁰, a C3-C6 alicyclic hydrocarbon group optionally substituted by one or more atoms or groups selected from Group Y or a hydrogen atom,
R⁸ and R⁹ are the same or different and each represents a C1-C6 chain hydrocarbon group optionally substituted by one or more halogen atoms, —OR¹⁰, —S(O)ₘR¹⁰, —NR¹⁰R¹¹, —CO₂R¹⁰, —C(O)R¹⁰, a cyano group, a nitro group, a halogen atom or a hydrogen atom,
R¹⁰ and R¹¹ are the same or different and each represents a C1-C6 chain hydrocarbon group optionally substituted by one or more atoms or groups selected from Group X, a phenyl group optionally substituted by one or more atoms or groups selected from Group Z or a hydrogen atom,
each m independently represents 0, 1 or 2, and
n represents 0, 1 or 2,
wherein the —S(O)ₘR¹⁰, R¹⁰ does not a hydrogen atom when m is 1 or 2,
Group X: the group consisting of a C1-C6 alkoxy group optionally substituted by one or more halogen atoms, a C2-C6 alkenyloxy group optionally substituted by one or more halogen atoms, a C2-C6 alkynyloxy group optionally substituted by one or more halogen atoms, a C1-C6 alkylsulfanyl group optionally substituted by one or more halogen atoms, a C1-C6 alkylsulfinyl group optionally substituted by one or more halogen atoms, a C1-C6 alkylsulfonyl group optionally substituted by one or more halogen atoms, a C2-C6 alkylcarbonyl group optionally substituted by one or more halogen atoms, a C2-C6 alkoxycarbonyl group optionally substituted by one or more halogen atoms, a C3-C6 cycloalkyl group optionally substituted by one or more halogen atoms or one or more C1-C3 alkyl groups, a cyano group, a hydroxy group and a halogen atom,
Group Y: the group consisting of a C1-C6 chain hydrocarbon group optionally substituted by one or more halogen atoms, a C1-C6 alkoxy group optionally substituted by one or more halogen atoms, a C2-C6 alkenyloxy group optionally substituted by one or more halogen atoms, a C2-C6 alkynyloxy group optionally substituted by one or more halogen atoms and a halogen atom,
Group Z: the group consisting of a C1-C6 chain hydrocarbon group optionally substituted by one or more halogen atoms, a C1-C6 alkoxy group optionally substituted by one or more halogen atoms, a C1-C6 alkylsulfanyl group optionally substituted by one or more halogen atoms, a C1-C6 alkylsulfinyl group optionally substituted by one or more halogen atoms, a C1-C6 alkylsulfonyl group optionally substituted by one or more halogen atoms, a C2-C6 alkylcarbonyl group optionally substituted by one or more halogen atoms, a C2-C6 alkoxycarbonyl group optionally substituted by one or more halogen atoms, a C1-C6 alkylamino group optionally substituted by one or more halogen atoms, a C2-C8 dialkylamino group optionally substituted by one or more halogen atoms, a halogen atom, a cyano group and a nitro group,
Group W: the group consisting of a C1-C6 alkoxy group optionally substituted by one or more halogen atoms, a C2-C6 alkenyloxy group optionally substituted by one or more halogen atoms, a C2-C6 alkynyloxy group optionally substituted by one or more halogen atoms, a C1-C6 alkylsulfanyl group optionally substituted by one or more halogen atoms, a C2-C6 alkylcarbonyl group optionally substituted by one or more halogen atoms, a C2-C6 alkoxycarbonyl group optionally substituted by one or more halogen atoms, a C3-C6 cycloalkyl group optionally substituted by one or more halogen atoms, a C1-C6 alkylsulfinyl group optionally substituted by one or more halogen atoms, a C1-C6 alkylsulfonyl group optionally substituted by one or more halogen atoms, hydroxy group, a halogen atom and a cyano group,
or an N-oxide thereof; and
one or more compounds selected from Group A to Group E:
Group A; fungicides,
Group B; insecticides,
Group C; acaricides,
Group D; chemical injury reducing agents, and
Group E; plant growth regulators.

2. A method of controlling pests which comprises applying the effective amount of the pest controlling composition of claim 1 to a plant or a soil where the plant is cultivated.

3. A plant seed to which an effective amount of the pest controlling composition of claim 1 is attached.
